(19) United States
(12) Patent Application Publication
(10) Pub. No.: US 2004/0125402 A1
(43) Pub. Date: Jul. 1, 2004

(54) Document printing program, document protecting program, document protecting system, document printing apparatus for printing out a document based on security policy

(76) Inventors: Yoichi Kanai, Kanagawa (JP); Atsuhisa Saitoh, Kanagawa (JP); Masuyoshi Yachida, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/661,650

(22) Filed: Sep. 15, 2003

(30) Foreign Application Priority Data
Sep. 13, 2002 (JP) 2002-269102
Oct. 11, 2002 (JP) 2002-299658
Oct. 11, 2002 (JP) 2002-299712
Oct. 11, 2002 (JP) 2002-299714
Oct. 11, 2002 (JP) 2002-299721
Sep. 5, 2003 (JP) 2003-314466
Sep. 5, 2003 (JP) 2003-314467
Sep. 5, 2003 (JP) 2003-314468
Sep. 10, 2003 (JP) 2003-318475

(51) Int. Cl. G06F 15/00; G06F 3/12

(52) U.S. Cl. 358/1.15; 358/1.1

(57) ABSTRACT

In a document protecting system, a distributor terminal implementing a document protecting program obtains an encryption key to encrypt a document file, associates a print request to the document file, and encrypts the document file by the encryption key. And a user terminal implementing a document printing program obtains a decryption key of document file being encrypted, decrypts the document file based on the obtained decryption key, obtains a print requirement associated with the document file, and executes a printing process so as to satisfy the print requirement.

### BACKGROUND OF THE INVENTION

1. Field of the Invention

The present invention generally relates to a document printing program, a document protecting program, a document protecting system, a document printing apparatus for printing out a document based on a security policy, an access control server, and an electronic data issuance workflow processing method.

2. Description of the Related Art

Recently, techniques for electronically recording a document on an information recording medium as a document file are mainly used instead of printing the document on paper in an office which deals with information (henceforth a document), such as a document and an image.

If the document is electronically recorded, the document can be recorded without using paper resources. Thus, it is possible to reduce paper resource wastes. In addition, since it is not needed to store papers on which the document is printed, it can be realized to reduce a storage space for the papers.

Moreover, if the document is electronically recorded, it is possible to simultaneously distribute the same document to many people, and to distribute the document to many people being at a remote place through a network. Accordingly, an efficiency of business can be promoted.

Advantages of recording electronically the document, in which the document can be simultaneously distributed to many people and to many people in the remote place through the network, cause a problem of easily leaking the document.

However, some documents handled in an office may be confidential. Thus, it is necessary to take measures to prevent the leak of those documents.

As a conventional technology for preventing the document from being leaked, in “Method for Encrypting Information for Remote Access While Maintaining Access Control” (see a patent reference 1), “Information Security Architecture for Encrypting Documents for Remote Access While Maintaining Access Control” (see a patent reference 2), and “Documentation Management System” (see a patent reference 3, only a valid user can be allowed to refer to contents of the document after the user is authenticated when the user attempts to open the document file, and only an authorized user can be allowed to print the document of the document file opened by the user after the user is checked whether or not the user is authorized to print out the document when the user attempts to printout the document.

Moreover, in “Print Restricting Method of Electronically Transmitted Information and Document with Print Restriction” (see a patent reference 4), the document file is controlled so as to allow to print out only when a payment is finished.

Furthermore, as conventional technology to print out the document based on a security policy, an access control system including a policy corresponding to an access with respect to a data file is proposed to evaluate by conducting an enforcing part, when the enforcing part clears a condition described in the policy (see a patent reference 5).

Also, a security management system is proposed to control a system to meet a policy by retrieving information of a control part from a database, which registers each combination of policies, systems, and control parts, and to monitor a state of the system (see a patent reference 6).

Moreover, based on an access control list recording a user authorization for each user, an access control is conducted to an issued electronic document (see a patent reference 7).

In the above-mentioned patent references 1-4, it can be realized to set the document not to be printed out by a non-authorized user. However, there is no security with respect to printed matter (hardcopy).

Accordingly, once the non-authorized user, who behaves as a user having an authorization of printing out the document, prints out the document, unauthorized copies of the document can be distributed to others without any restriction.

Furthermore, if the user who attempts to leak the document is the valid user having the authorization of printing out the document, a printed document can not be prevented from being leaking by the user.

As described above, the document file is not user-friendly, and security for protecting the printed document from being leaked is insufficient.

In the above-mentioned patent references 5-6, an office system generally includes various apparatuses. Thus, it is required to set a security for each apparatus. Since it is required to have knowledge about the security related to each apparatus, it is difficult to understand the entire security state. Even if the security is set to each apparatus, it is difficult to feel that the security of the document is maintained.

In a technology disclosed in the reference 5, the access control system is used for the data file. The reference 5 does not disclose any means with respect to a data process, especially means against a print of the data file after the data file is accessed.

Moreover, in a technology disclosed in the reference 6, the system is just controlled by the control part registered for the system. Accordingly, this technology is not flexible to practice.

Furthermore, in a technology disclosed in the reference 7, it is required to input information showing a user authorization of a file for each user every time new electronic data file is created. Accordingly, in a state in that a large number of users may access the electronic data file, a large amount of time is required.

[Reference List]

[Patent Reference 1]

U.S. Pat. No. 6,339,825 specification

[Patent Reference 2]

U.S. Pat. No. 6,289,450 specification

[Patent Reference 3]

Japanese Laid-open Patent Application No. 2001-142874

[Patent Reference 4]

Japanese Laid-open Patent Application No. 2002-024097

[Patent Reference 5]

Japanese Laid-open Patent Application No. 2001-184264

[Patent Reference 6]

Japanese Laid-open Patent Application No. 2001-273388

[Patent Reference 7]

Japanese Laid-open Patent Application No. 2001-195295

### SUMMARY OF THE INVENTION

It is a general object of the present invention to provide a document printing program, a document protecting program, a document protecting system, a document printing apparatus for printing out a document based on a security policy, an access control server, and an electronic data issuance workflow processing method in which the above-mentioned problems are eliminated.

A more specific object of the present invention is to provide a document printing program comprising the codes of: obtaining a print requirement associated with a document file; and compulsory executing the print requirement when the document file is printed out.

According to the present invention, it is possible to effectively enforce a security for the document when the document is printed out.

The above objects of the present invention are achieved by a document protecting system comprising: a distributor terminal implementing a document protecting program comprising the codes of: part obtaining an encryption key to encrypt a document file; a part associating a print request to the document file; and a part encrypting the document file by the encryption key, and a user terminal implementing a document printing program comprising the codes of: a part obtaining a decryption key of document file being encrypted; a part decrypting the document file based on the obtained decryption key; a part obtaining a print requirement associated with the document file; and a part executing a printing process so as to satisfy the print requirement.

The above objects of the present invention are achieved by a document protecting system comprising: a distributor terminal implementing a document protecting program comprising the codes of: a part obtaining an encryption key to encrypt a document file; a part associating a print request to the document file; and a part encrypting the document file by the encryption key, and a user terminal implementing a document printing program comprising the codes of: a part obtaining a decryption key of document file being encrypted; a part decrypting the document file based on the obtained decryption key; a part obtaining a print requirement associated with the document file; and a part executing a printing process so as to satisfy the print requirement.

The above objects of the present invention are achieved by a document printing program comprising the codes of: obtaining decryption key of a document file being encrypted; decrypting the document based on the decryption key; obtaining a print requirement associated with the document file from a server through a network; and executing a printing process satisfying the print requirement.

The above objects of the present invention are achieved by a document printing apparatus comprising: a part obtaining a user attribute of a user who prints out a document file; a part obtaining a document attribute of the document file; a part obtaining a print requirement by searching for a security policy ruling a print allowed/denied and a print requirement based on the user attribute and the document attribute; and a part enforcing the print requirement when the document file is printed out.

The above objects of the present invention are achieved by an electronic file management apparatus comprising: an electronic file storage area storing an electronic file; an electronic file managing part additionally providing access authorization information to the electronic file and storing the electronic file in the electronic file storage area; and a secured electronic file outputting part outputting a secured electronic file in that the electronic file is encrypted and secured, in response to an access request of the electronic file.

The above objects of the present invention are achieved by a file access controlling method comprising: managing an electronic so as to provide a secured electronic file in that an electronic file is secured by encrypting based on access authorization information, in response to an access request; obtaining the secured electronic file in response to a process request for the electronic file; and controlling a process with respect to the secured electronic file that is decrypted in accordance with the access authorization information when the secured electronic file is decrypted.

The above objects of the present invention can be achieved by a program code for causing a computer to conduct processes described above in the document processing apparatus or by a computer-readable recording medium recorded with the program code.

### BRIEF DESCRIPTION OF THE DRAWINGS

In the following, embodiments of the present invention will be described with reference to the accompanying drawings.

FIG. 1 is a diagram showing a document protecting/printing system according to the present invention;

FIG. 2 is a diagram showing a configuration example of the document protecting program according to the first embodiment of the present invention;

FIG. 3 is a diagram showing a configuration example of the document printing program according to the first embodiment of the present invention;

FIG. 4 is a diagram showing a configuration example of the print processing part according to the first embodiment of the present invention;

FIG. 5 is a diagram showing a screen requiring of setting the password and the print requirement according to the first embodiment of the present invention;

FIG. 6 is a diagram showing a configuration example of an ACL according to the first embodiment of the present invention;

FIG. 7 is a diagram showing a screen for requiring of inputting the password according to the first embodiment of the present invention;

FIG. 8 is a diagram showing a confirmation screen displayed at the display unit of the user terminal according to the first embodiment of the present invention;

FIG. 9 is a diagram showing the operation of the document protecting program according to the first embodiment of the present invention;

FIG. 10 is a diagram showing the document printing program according to the first embodiment of the present invention;

FIG. 11 is a diagram showing a configuration of the document protecting/printing system according to the second embodiment of the present invention;

FIG. 12 is a diagram showing a configuration example of the document protecting program according to the first embodiment of the present invention;

FIG. 13 is a diagram showing a configuration example of the document printing program according to the second embodiment of the present invention;

FIG. 14 is a diagram showing a configuration example of the print processing part shown in FIG. 13, according to the second embodiment of the present invention;

FIG. 15 is a diagram showing a configuration example of the access control server according to the second embodiment of the present invention;

FIG. 16 is a diagram showing a structure example of the ACL according to the second embodiment of the present invention;

FIG. 17 is a diagram showing a structure of information recorded in the ACL database according to the second embodiment of the present invention;

FIG. 18 is a diagram showing a screen requiring of setting the ACL according to the second embodiment of the present invention;

FIG. 19 is a diagram showing a screen for requiring of inputting the user name and the password according to the second embodiment of the present invention;

FIG. 20 is a diagram showing operations when the document protecting program generates the secured document according to the second embodiment of the present invention;

FIG. 21 is a diagram showing the operations of the document printing program and the access control server when the secure document is printed out, according to the second embodiment of the present invention;

FIG. 22 is a diagram showing an enquiry example by the SOAP to the access control server 204 according to the second embodiment of the present invention;

FIG. 23 is a diagram showing a configuration example of the document protecting program according to the second embodiment of the present invention;

FIG. 24 is a diagram showing a portion related to a decryption in the configuration example of the document printing program according to the second embodiment of the present invention;

FIG. 25 is a diagram showing a configuration example of the document printing program in a case in that the entire print requirements are separated into a first print requirement to include in the secured document and a second print requirement to store in the access control server, according to the second embodiment of the present invention;

FIG. 26 is a diagram showing a portion of a security function implemented in the printer applied in the second embodiment of the present invention;

FIG. 27 is a diagram showing the operation of the document printing program in the case in that the PAC is set as the print requirement according to the second embodiment of the present invention;

FIG. 28 is a diagram showing a dialog for inputting PIN according to the second embodiment of the present invention;

FIG. 29 is a diagram showing a process in a case in that the document is divided into a plurality of segments and secured, according to the second embodiment of the present invention;

FIG. 30 is a diagram showing a state in that the document protecting program is arranged in a remote server, according to the second embodiment of the present invention;

FIG. 31 is a diagram showing the document protecting/printing system according to the third embodiment of the present invention;

FIG. 32 is a diagram showing a configuration example of the document protecting program according to the third embodiment of the present invention;

FIG. 33 is a diagram showing a configuration example of the document printing program according to the third embodiment of the present invention;

FIG. 34 is a diagram showing a configuration example of the print processing part shown in FIG. 33, according to the third embodiment of the present invention;

FIG. 35 is a diagram showing a configuration example of the access control server according to the third embodiment of the present invention;

FIG. 36 is a diagram showing a screen example for requiring setting the security attribute according to the third embodiment of the present invention;

FIG. 37 is a diagram showing operations when the document protecting program generates the secured document according to the third embodiment of the present invention;

FIG. 38 is a diagram showing operations of the document printing program according to the third embodiment of the present invention;

FIG. 39 is a diagram showing the operations of the document printing program and the access control server according to the third embodiment of the present invention;

FIG. 40 is a diagram showing a configuration example of the document protecting program according to the third embodiment of the present invention;

FIG. 41 is a diagram showing a portion related to a decryption in the configuration example of the document printing program according to the third embodiment of the present invention;

FIG. 42 is a diagram showing a configuration example of the document printing program in a case in that the entire print requirements are separated into a first print requirement to include in the secured document and a second print requirement to store in the access control server, according to the second embodiment of the present invention;

FIG. 43 is a diagram showing an example of the security policy according to a fourth embodiment of the present invention;

FIG. 44 is a diagram showing a document protecting/printing system according to the fourth embodiment of the present invention;

FIG. 45 is a diagram showing a configuration example of the access control server according to the fourth embodiment of the present invention;

FIG. 46 is a diagram showing an example of the security policy registered in the access control server according to the fourth embodiment of the present invention;

FIG. 47 is a diagram showing an example of electronically describing the security policy according to the fourth embodiment of the present invention;

FIG. 48 is a diagram showing an example of information registered in the user database according to fourth embodiment of the present invention;

FIG. 49 is a diagram showing a process when the document protecting program generates the secured document, according to the fourth embodiment of the present invention;

FIG. 50 is a diagram showing operations of the document protecting program and the access control server according to the fourth embodiment of the present invention;

FIG. 51 is a diagram showing the operations of the document printing program and the access control server when the secure document is printed out, according to the fourth embodiment of the present invention;

FIG. 52 is a diagram showing a configuration of a printer according to a fifth embodiment of the present invention;

FIG. 53 is a diagram showing an example of a script describing the security policy in the XML according to the fifth embodiment of the present invention;

FIG. 54 is a diagram showing a document protecting/printing system according to a sixth embodiment of the present invention;

FIG. 55 is a diagram showing a configuration example of the document program protecting program according to the sixth embodiment of the present invention;

FIG. 56 is a diagram showing a configuration example of the document printing program according to the sixth embodiment of the present invention;

FIG. 57 is a diagram showing a configuration example of the print processing part according to the sixth embodiment of the present invention;

FIG. 58 is a diagram showing a configuration example of the access control server according to the sixth embodiment of the present invention;

FIG. 59 is a diagram showing a process when the document protecting program generates the secured document, according to the sixth embodiment of the present invention;

FIG. 60 is a diagram showing operations of the document protecting program and the access control server according to the sixth embodiment of the present invention;

FIG. 61 is a diagram showing the operations of the document printing program and the access control server when the secure document is printed out, according to the sixth embodiment of the present invention.

FIG. 62 is a diagram showing a configuration example of the document protecting program according to the sixth embodiment of the present invention;

FIG. 63 is a diagram showing a portion related to a decryption in the configuration example of the document printing program according to the sixth embodiment of the present invention;

FIG. 64 is a diagram showing a configuration example of the document printing program in a case in that the entire print requirements are separated into a first print requirement to include in the secured document and a second print requirement to store in the access control server, according to the sixth embodiment of the present invention;

FIG. 65 is a diagram showing the operation of the document printing program in the case in that the PAC is set as the print requirement, according to the sixth embodiment of the present invention;

FIG. 66A and FIG. 66B are diagram showing the electronic file management apparatus according to the seventh embodiment of the present invention;

FIG. 67 is a diagram showing a configuration example of the document protecting/printing system according to the seventh embodiment of the present invention;

FIG. 68 is a diagram showing the functional configuration realized by the document management program according to the seventh embodiment of the present invention;

FIG. 69 is a diagram showing operation of the document protecting program according to the seventh embodiment of the present invention;

FIG. 70 is a diagram showing the operations of the document printing program and the access control server when the secure document is printed out, according to the seventh embodiment of the present invention;

FIG. 71A and FIG. 71B are diagrams showing the modification of the electronic file management apparatus according to the seventh embodiment of the present invention;

FIG. 72A and FIG. 72B are diagrams showing the electronic file management apparatus according to the eighth embodiment of the present invention;

FIG. 73A and FIG. 73B are diagrams showing the modification of the electronic file management apparatus according to the seventh embodiment of the present invention;

FIG. 74 is a diagram showing the functional configuration realized by the document management program according to the eighth embodiment of the present invention;

FIG. 75A and FIG. 75B are diagram showing the electronic file management apparatus according to the ninth embodiment of the present invention;

FIG. 76A and FIG. 76B are diagrams showing the modification of the electronic file management apparatus according to the seventh embodiment of the present invention;

FIG. 77 is a diagram showing the functional configuration realized by the document management program according to the ninth embodiment of the present invention;

FIG. 78A and FIG. 78B are diagrams showing the electronic file management apparatus according to the tenth embodiment of the present invention;

FIG. 79A and FIG. 79B are diagrams showing the modification of the electronic file management apparatus according to the tenth embodiment of the present invention;

FIG. 80 is a diagram showing the functional configuration realized by the document management program according to the tenth embodiment of the present invention;

FIG. 81 is a diagram showing a screen to display when the user accesses the electronic file management apparatus;

FIG. 82 is a diagram showing a screen to display the list of the documents managed in the electronic file management apparatus;

FIG. 83 is a diagram showing a screen on which only the secured document is displayed;

FIG. 84 is a diagram showing a state in that the secured document is opened;

FIG. 85 is a diagram showing a screen in a case in that the user does not have an original reference authorization;

FIG. 86 is a diagram showing the document issuance workflow system according to the eleventh embodiment of the present invention;

FIG. 87 is a diagram showing a screen displayed when the workflow information 812 is generated at the author terminal 801, according to the eleventh embodiment of the present invention;

FIG. 88 is a diagram showing an example of the workflow information according to the eleventh embodiment of the present invention;

FIG. 89 is a diagram showing the workflow information where a document ID is provided;

FIG. 90 is a diagram showing a modification of the document issuance workflow system according to the eleventh embodiment of the present invention;

FIG. 91 is a diagram showing the ACL template according to the eleventh embodiment of the present invention;

FIG. 92 is a diagram showing an example of the ACL according to the eleventh embodiment of the present invention; and

FIG. 93 is a diagram showing an example of a mapping table according to a twelfth embodiment of the present invention.

### DESCRIPTION OF THE PREFERRED EMBODIMENTS

### First Embodiment

In the following, a first embodiment of the present invention to will be described with reference to the accompanying drawings.

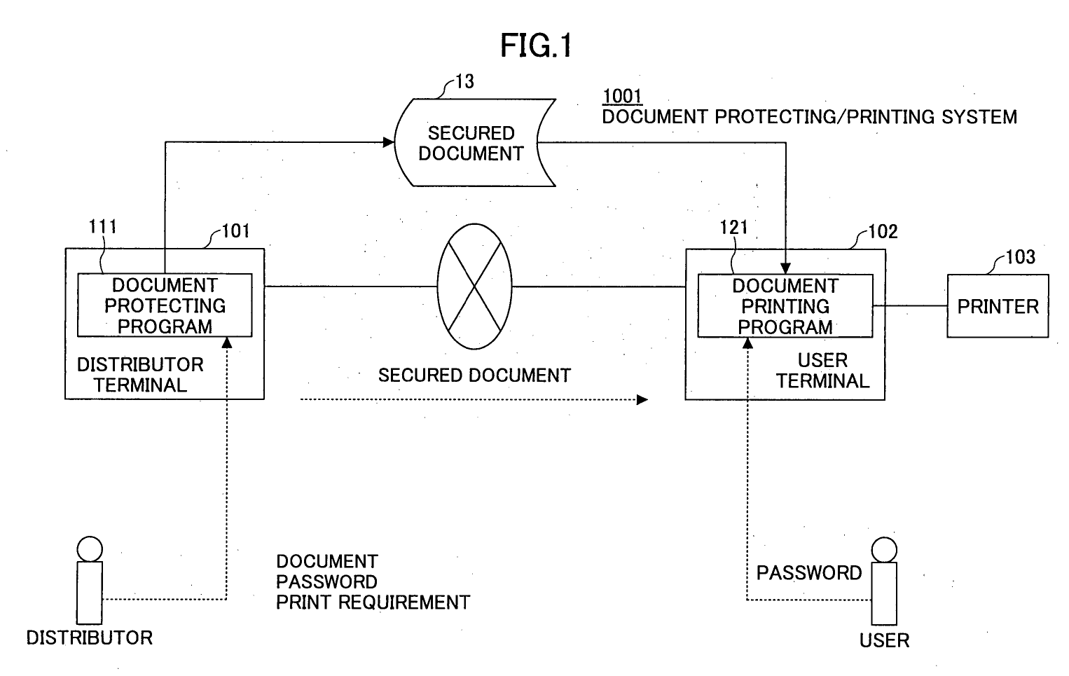

FIG. 1 is a diagram showing a document protecting/printing system according to the present invention.

A document protecting/printing system 1001 according to the present invention includes a distributor terminal 101, a user terminal 102, and a printer 103. Each of the distributor terminal 101 and the user terminal 102 can be applied to a computer terminal including a display unit (for example, an LCD (Liquid Crystal Display), an input unit (for example, a keyboard), an external storage unit (for example, an FDD (Floppy Disk Device), an HDD (Hard Disk Device), or a like). It should be noted that the distributor terminal 101 implements a document protecting program 111 and the user terminal 102 implements a document printing program 121.

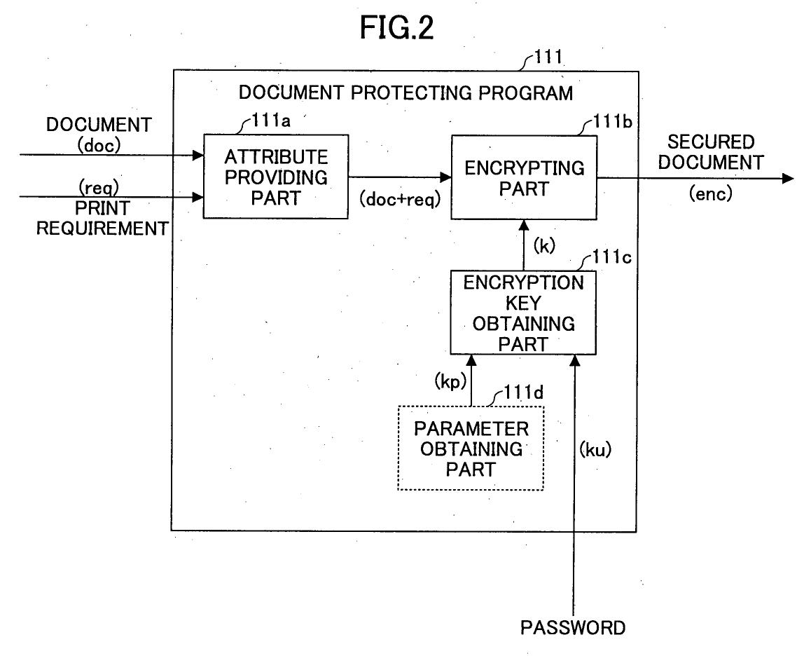

The document protecting program 111 is a program to set a print requirement to a document file (hereinafter, simply called a document) in response to an input operation by a distributor using the distributor terminal 101, encrypt the document using an encryption algorithm (for example, an RC4, Triple DES, IDEA), and generate a secured document 13. FIG. 2 is a diagram showing a configuration example of the document protecting program according to the first embodiment of the present invention. In FIG. 2, the document protecting program 111 includes an attribute providing part 111a, an encrypting part 111b, an encryption key obtaining part 111c, and a parameter obtaining part 111d. It should be noted that the parameter obtaining part 111d is an optional element and can be eliminated. Each function will be described later.

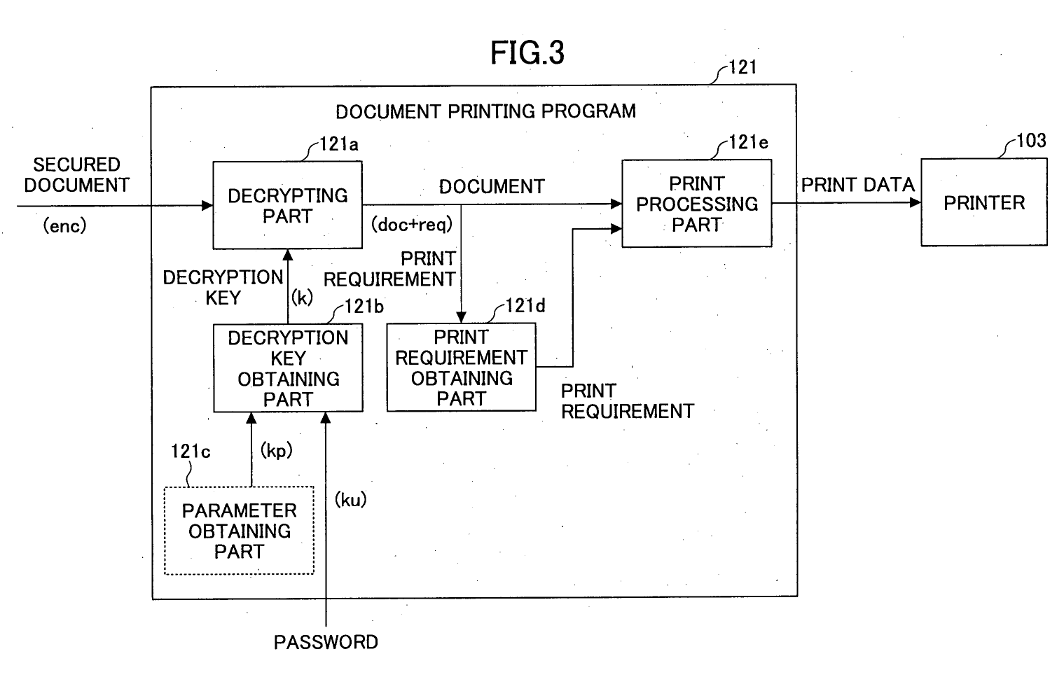

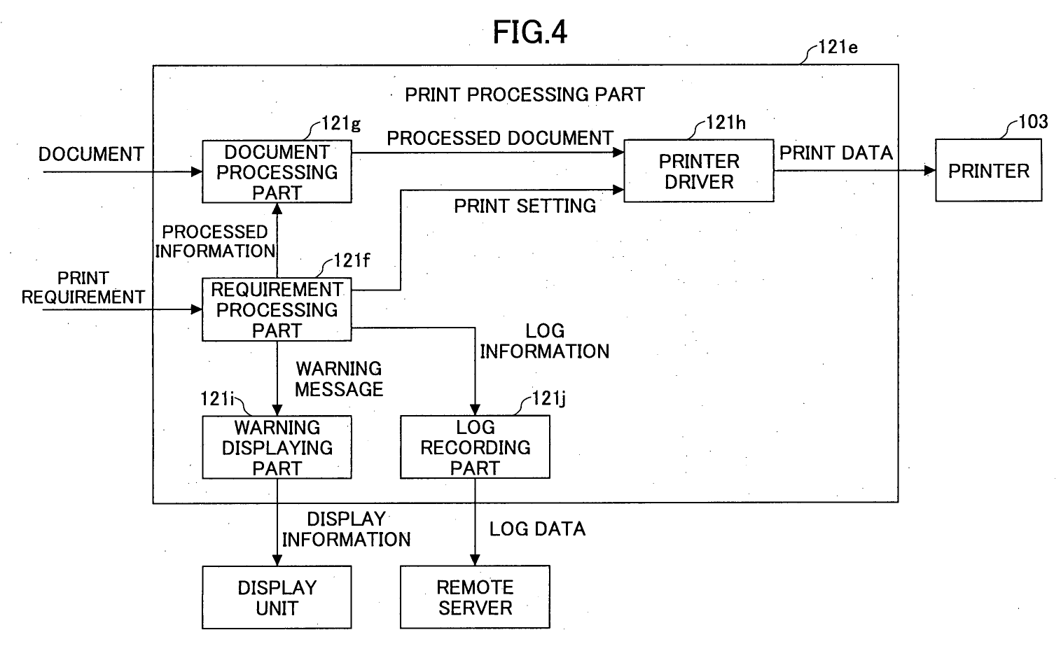

Referring to FIG. 1, the document printing program 121 is a program to decrypt the secured document 13 in response to an input operation by a user using the user terminal 102, and to have the printer 103 executed a process in accordance with the print requirement. FIG. 3 is a diagram showing a configuration example of the document printing program according to the first embodiment of the present invention. In FIG. 3, the document printing program 121 includes a decrypting part 121a, a decryption key obtaining part 121b, a parameter obtaining part 121c, a print processing part 121e, and a print requirement obtaining part 121d. It should be noted that the parameter obtaining part 121c is an optional element and can be eliminated. FIG. 4 is a diagram showing a configuration example of the print processing part according to the first embodiment of the present invention. In FIG. 4, the print processing part 121e includes a requirement processing part 121f, a document processing part 121g, a printer driver 121h, a warning displaying part 121i, and a log recording part 121j. Each function will be described later.

As a print requirement which the document protecting program 111 sets to the document in response to the input operation of the distributor, for example, a BDP (Background Dot Pattern), a PAC (Private Access), a DWM (Digital Watermark), an EBC (Embedding Barcode), or an SLS (Security Label Stamp) may be required.

Operations of the document protecting/printing system 1001 will be described. First, an operation of the entire document protecting/printing system 1001 will be described.

Referring to FIG. 1, the distributor stores the document to the distributor terminal 101. For example, the distributor may create the document by operating the input unit or has the distributor terminal 101 read the document from an information recording medium by operating the external recording unit.

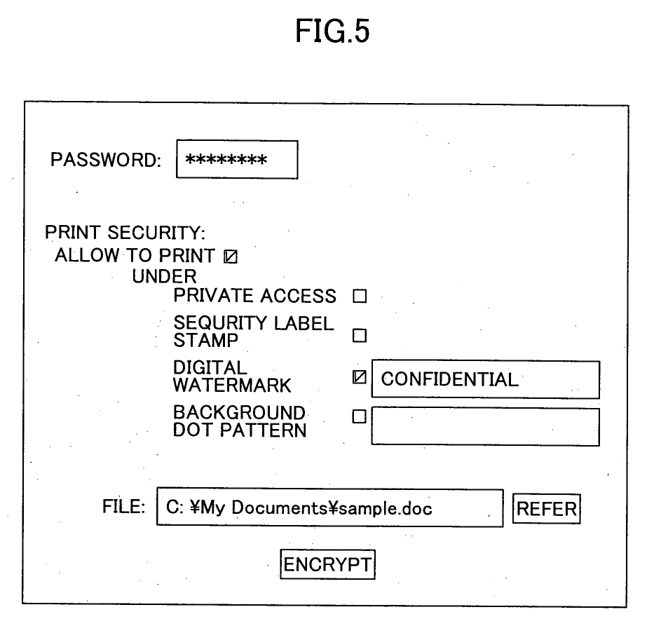

In case of securing the document, the distributor provides the document to the document protecting program 111 by operating the input unit. The document protecting program 111 that obtained the document requires the distributor to set a password necessary to access the document after the document is encrypted, and a setting of a security process (that is, the print requirement) which the distributor enforces with respect to the document. For example, the document protecting program 111 displays a message at the display unit of the distributor terminal 101 and requires the distributor of setting the password and the print requirement. FIG. 5 is a diagram showing a screen requiring of setting the password and the print requirement according to the first embodiment of the present invention. It should be noted that the document can be selectively indicated to be secured in the screen shown in FIG. 5.

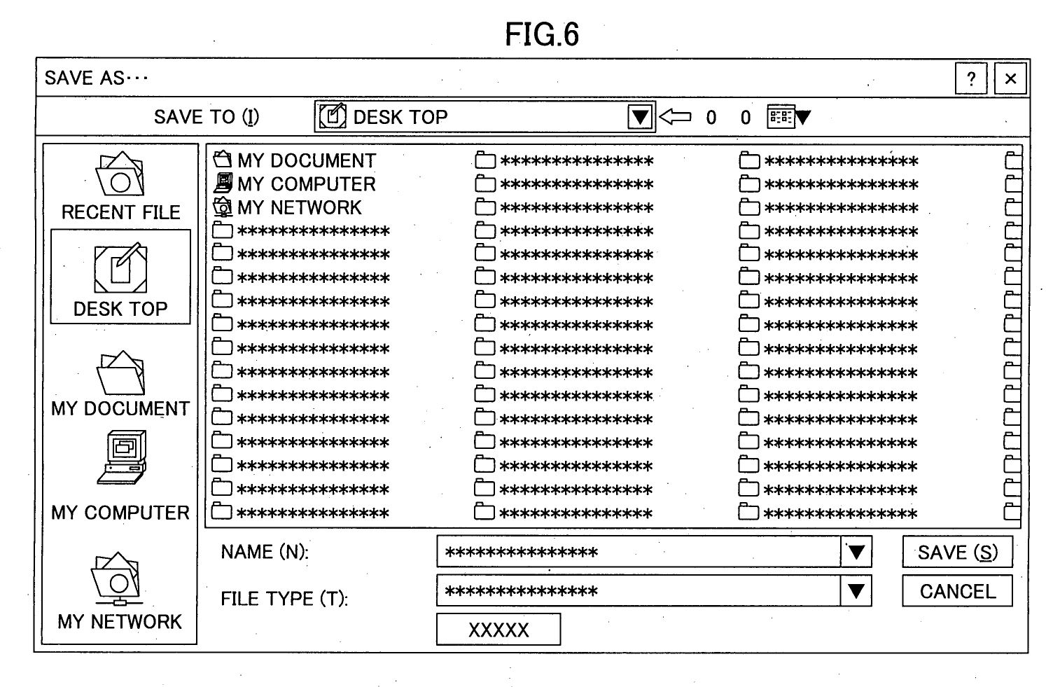

When the distributor inputs the password and the print requirement by using the input unit of the distributor terminal 101, the document protecting program 111 obtains information input by the distributor. In order to enquire a storage place for the secured document 13, for example, the document protecting program 111 displays a screen as shown in FIG. 6 at the display unit.

The document protecting program 111 generates the secured document 13 from the document by using the password and the print requirement obtained from the distributor.

The distributor provides the secured document 13 generated by the document protecting program 111 to the user and notifies the user of the password necessary to access the document.

In a case in that the user attempts to print out the document, the secured document 13 is implemented to the user terminal 102. For example, the user terminal 102 may read out the secured document 13 stored in the information recording medium set in the external storage unit. Alternatively, in a case in that the user terminal 102 connects with the distributor terminal 101 through a network, the user terminal 102 may obtain the secured document 13 through the network.

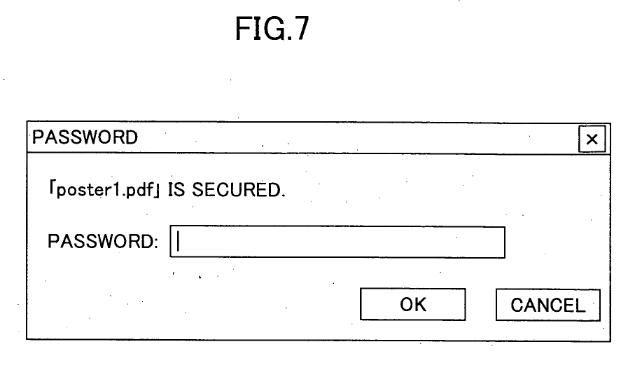

When the user indicates the document printing program 121 to print out the document by using the input unit of the user terminal 102,the document printing program 121 requires the user to input the password necessary to access the document. For example, the document printing program 121 displays a message at the display unit of the user terminal 102 to require the user to input the password. FIG. 7 is a diagram showing a screen for requiring of inputting the password according to the first embodiment of the present invention.

When the user inputs the password notified from the distributor to the user terminal 102 by using the input unit, the document printing program 121 decrypts the secured document 13 by the password input by the user, and controls the printer 103 to conduct a printing process so as to satisfy the print requirement set by the distributor. For example, in a case in that the BDP is set to the document as the print requirement, the printer 103 prints out contents of the document while printing out the background dot pattern.

As described above, when the document is printed out, it is possible to enforce the print requirement set by the distributor.

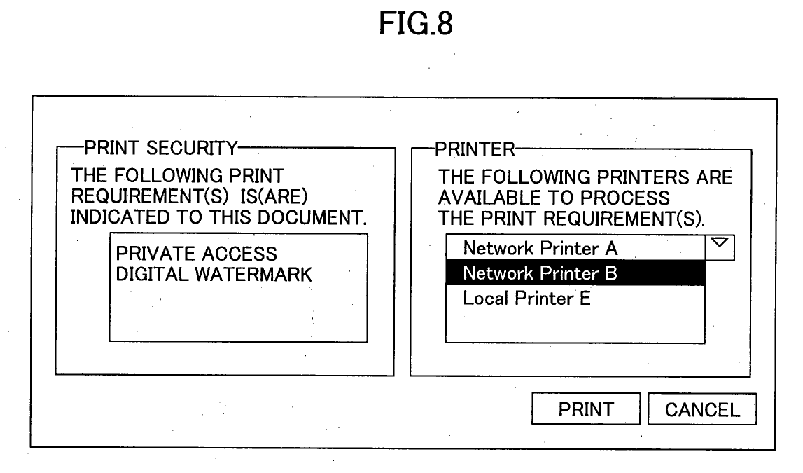

In a case in that the user is not aware of the print requirement or only a special printer can process the print requirement, information showing that may be provided to the user before executing the printing process. FIG. 8 is a diagram showing a confirmation screen displayed at the display unit of the user terminal according to the first embodiment of the present invention. In the confirmation screen shown in FIG. 8, the print requirements and available printers are displayed and the user can select one of the available printers to use.

Next, an operation of the document protecting program 111 (a secured document generating process) and an operation of the document printing program 121 (a secured document printing process) will be described in detail.

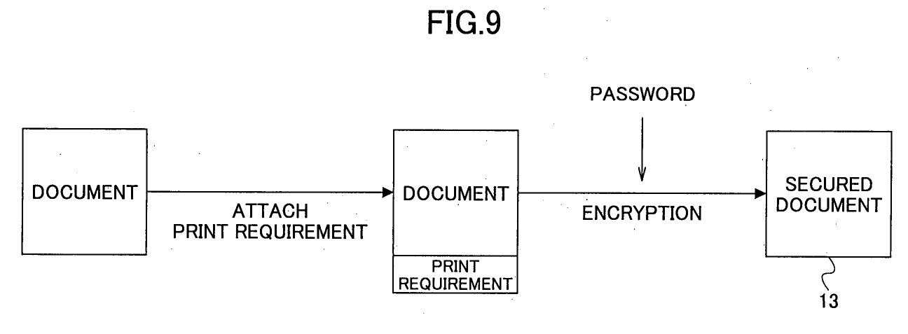

FIG. 9 is a diagram showing the operation of the document protecting program according to the first embodiment of the present invention.

First, the document protecting program 111 attaches the print requirement which the distributor set using the input unit of the distributor terminal 101, with the document.

Next, the document protecting program 111 encrypts the document attached with the print requirement by using the password input by the distributor and generates the secured document.

The operation of the document protecting program 111 will be described in detail with reference to FIG. 2.

First, the attribute providing part 111a of the document protecting program 111 provides the print requirement (req) set by the distributor to the document (doc) provided by the distributor as an attribute, and then sends the document attached with the print requirement to the encrypting part 111b.

On the other hand, the encryption key obtaining part 111c generates an encryption key (k) based on the password input by the distributor and a parameter (kp) that is set as necessity and is obtained from the parameter obtaining part 111d, and then sends the encryption key to the encrypting part 111b. It should be noted that the parameter (kp) of the parameter obtaining part 111d should be maintained within the document protecting program 111 or should be generated when requested. As an encryption key (k) generating algorithm, for example, k=H{ku,kp} or k=D{ku,kp} can be used. H{data 1, data 2, . . . } denotes to calculate hash values of the data 1, data 2, . . . , and D{data, key} denotes to decrypt the data by the key.

Then, the encrypting part 111b encrypts the document attached with the print requirement based on the encryption key (k), and outputs the document as the secured document 13 (enc). enc=E{(doc+req), k} can be an expression for this process. E{data, key} denotes to encrypt the data by the key.

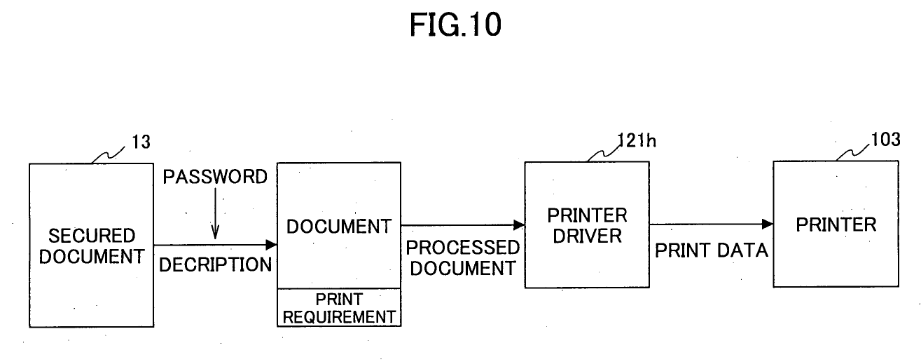

FIG. 10 is a diagram showing the document printing program according to the first embodiment of the present invention.

First, the document printing program 121 decrypts the secured document 13 by using the password input by the user using the input unit of the user terminal 102, and restores the document attached with the print requirement. Next, the document printing program 121 sets the printer driver so as to satisfy the print requirement set to the document. For example, if the PAC is indicated as the print requirement, the document printing program 121 sets the private access mode. Then, the document printing program 121 prints out the document. If necessary, a message may be displayed at the display unit to require the user to set a print parameter.

If the printer 103 can not satisfy the print requirement attached to the document, that is, if the printer 103 does not implement a function satisfying the print requirement set to the document, the document printing program 121 displays a message at the display unit of the user terminal 102 to inform the user, and terminates the operation without the printing process.

For example, if the PAC is set as the print requirement, the document printing program 121 requires the user to input a PIN (Personal Identification Number) before executing the printing process. In this case, after the printing process, a printout of the document is not output from the printer 103 until the same PIN is input to an operation panel of the printer 103. Accordingly, the printout of the document is not carelessly left at the printer 103. Thus, it is possible to prevent the document from being leaked by the printout.

The operation described above will be described in detail with reference to FIG. 3 and FIG. 4.

First, in FIG. 3, the decrypting part 121a of the document printing program 121 decrypts the secured document by using the decryption key (k) provided from the decryption key obtaining part 121b. The decryption key (k) generated based on the password and the parameter (kp). The parameter (kp) is obtained from the parameter obtaining part 121c if necessary. It should be noted that the parameter (kp) of the parameter obtaining part 121c should be maintained within the document printing program 121 or should be generated if required. As a decryption key (k) generating algorithm in the decryption key obtaining part 121b, for example, similar to the case of the encryption, k=H{ku, kp} or k=D{ku, kp} can be used. H{data 1, data2, . . . } denotes the hash values of the data 1, the data 2, . . . , and D{data, key} denotes to decrypt the data by the key.

Subsequently, the decrypting part 121a decrypts the secure document 13 (enc) by the decryption key (k), obtains the document attached with the print requirement (doc+req), and then sends the document (doc+req) to the print processing part 121e. The decryption can be expressed by (doc+req)=D{end, k}. D{data, key} denotes to decrypt the data by the key. On the other hand, the print requirement obtaining part 121d obtains the print requirement from the document (doc+req) that is decrypted, and sends to the print processing part 121e.

Referring to FIG. 4, the requirement processing part 121f of the print processing part 121e conducts a plurality of processes in response to contents of the print requirement received from the print requirement obtaining part 121d. That is, if the document itself is required to be process as described the BDP, the EBC, and the SLS, the requirement processing part 121f sends process information to the document processing part 121g to process the document, and then a processed document is sent to the printer driver 121h. Then, print data is provided to the printer 103 and the printer 103 executes to print out the document. In a case in that a special setting is required to the printer driver 121h such as the PAC, a print setting is conducted to the printer driver 121h. In a case in that a warning message to the user is required, the warning message is sent to the warning displaying part 121i and then is displayed at the display unit. In a case in that a print log is required, log information is sent to the log recording part 121j and then log data is registered to a remote server or a like.

In the first embodiment, the parameter obtaining part 111d in FIG. 2 and the parameter obtaining part 121c in FIG. 3 are optional elements. However, if the parameter obtaining part 111d and the parameter obtaining part 121c are eliminated, a person, who knows how to decrypt the secured document 13 by only the password, can decrypt the secured document 13 by using the password without executing the document printing program 121.

If the secured document 13 is decrypted without the document printing program 121, since the print requirement set by the distributor is not enforced, the document will be free to be printed.

To prevent this case, instead of encrypting the document by only the password, for example, by providing the parameter obtaining part 111d as shown in FIG. 2, the document may be encrypted by using a combination (a result of exclusive OR) of the password and a secret key (parameter) embedded in the document protecting program 111.

In this case, the parameter obtaining part 121c is provided to the document printing program 121 as shown in FIG. 3, and the same secret key (parameter) is embedded in the document printing program 121. Accordingly, only the document printing program 121, which enforces the print requirement set by the distributor, can decrypt the secured document 13 and print out the document.

Moreover, if key data itself are stored in the programs 111 and 121, an attacker can obtain the key data. Accordingly, instead of maintaining the key data itself, an algorithm for calculating and generating the key data may be embedded in the programs 111 and 121. In order not to specify that algorithm for calculating and generating the key data, an anti-tamper technology of software, which is a technology for protecting a system from being illegally analyzed by the attacker by creating a program that is difficult to analyze, can be utilized so as to improve the security of the document.

### Second Embodiment

In the first embodiment, the document protecting/printing system 1001 that protects the document by using the password is described above. Whether or not the document can be printed out depends on whether or not the user knows the password.

However, in practice, such as a situation of “a user A is permitted to print out the document but a user B is not permitted. Moreover, when a user C attempts to print out the document, a background dot pattern is to be conducted at the printing process”, a different print requirement is required to be set corresponding to each user. In a second embodiment of the present invention, a document protecting/printing system 2001, which can correspond to such this request, will be described.

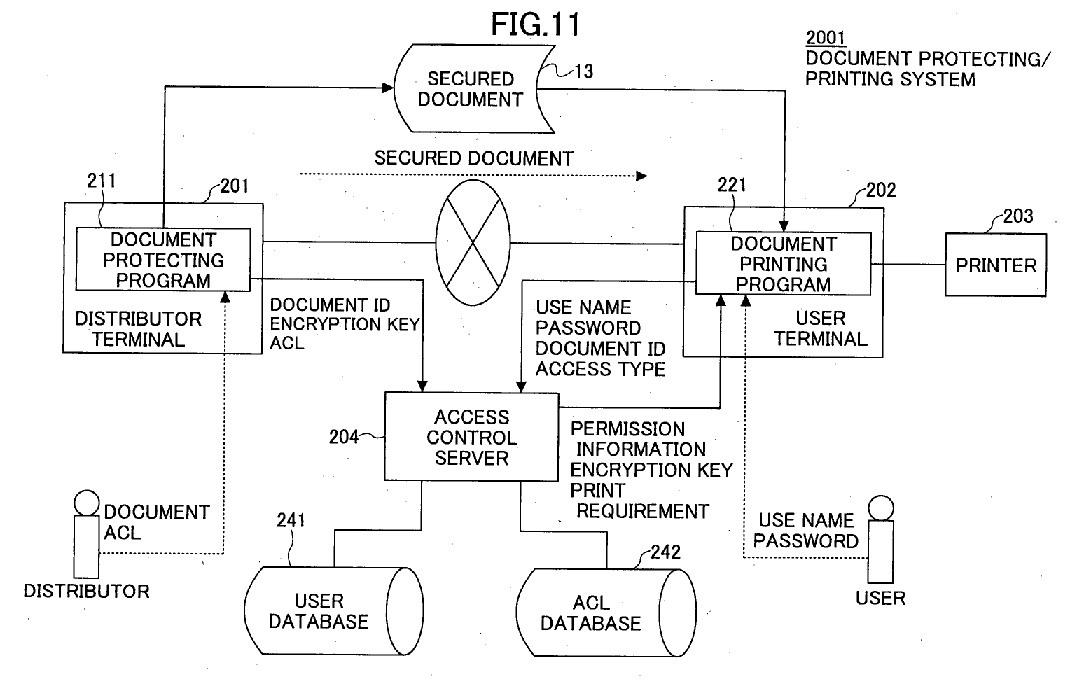

FIG. 11 is a diagram showing a configuration of the document protecting/printing system according to the second embodiment of the present invention.

The document protecting/printing system 2001 according to the second embodiment includes a distributor terminal 201, a user terminal 202, a printer 203, and an access control server 204.

Similar to the first embodiment, each of the distributor terminal 201 and the user terminal 202 can be applied to a computer terminal including a display unit (for example, an LCD (Liquid Crystal Printer), an input unit (for example, a keyboard), an external storage unit (for example, an FDD (Floppy Disk Device), an HDD (Hard Disk Device), or a like). It should be noted that the distributor terminal 201 implements a document protecting program 211 and the user terminal 202 implements a document printing program 221.

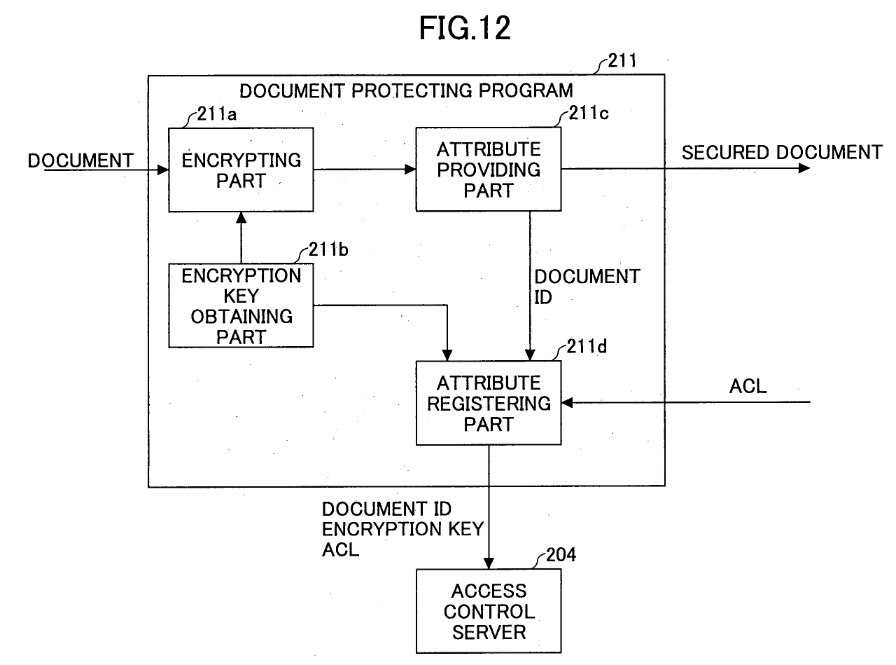

The document protecting program 211 is a program to set a print requirement to a document file (hereinafter, simply called a document) in response to an input operation by a distributor using the distributor terminal 201, encrypt the document using an encryption algorithm (for example, an RC4, Triple DES, IDEA), and generate a secured document 13. FIG. 12 is a diagram showing a configuration example of the document protecting program according to the first embodiment of the present invention. In FIG. 12, the document protecting program 211 includes an encrypting part 211a, an encryption key obtaining part 211b, an attribute providing part 211c, and an attribute registering part 211d. Each function will be described later.

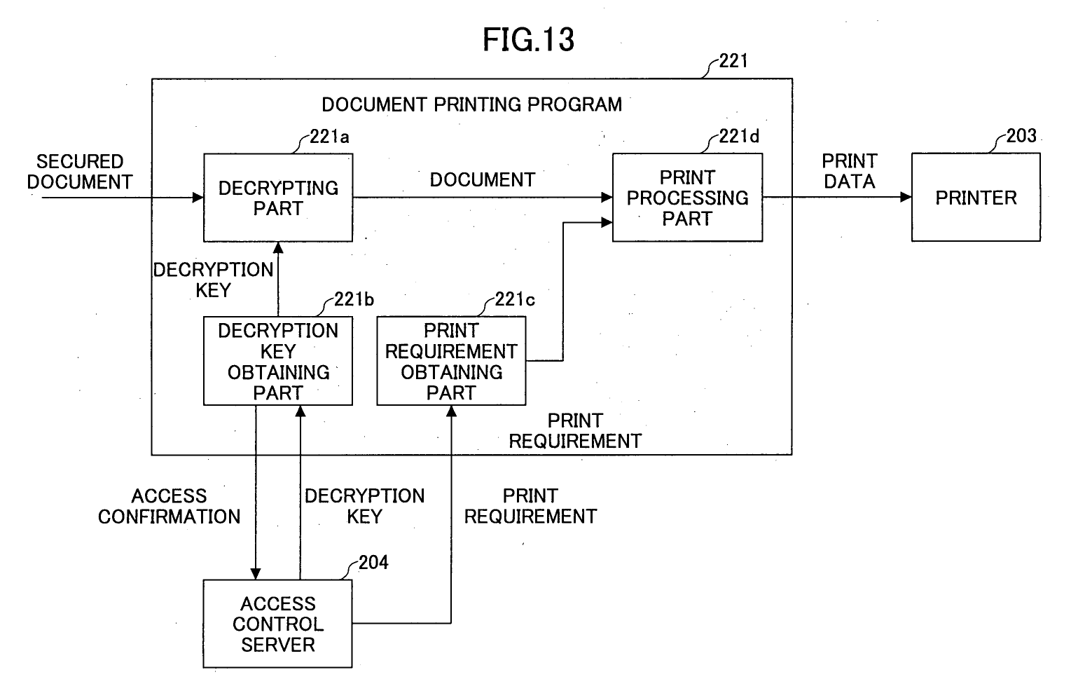

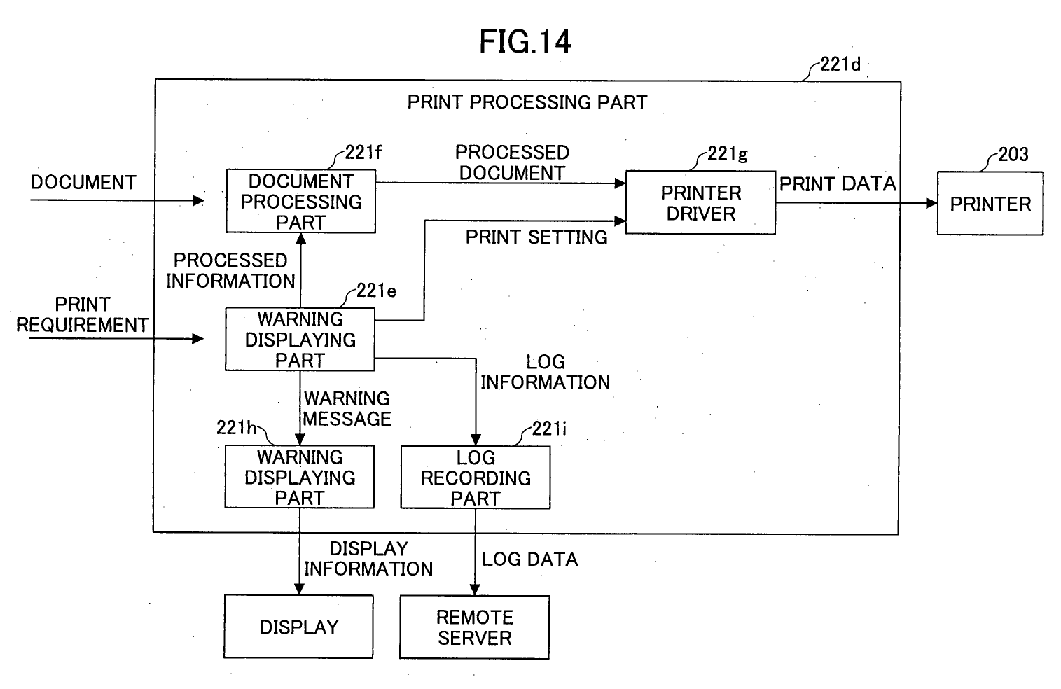

Referring to FIG. 11, the document printing program 221 is a program to decrypt the secured document 13 in response to an input operation by a user using the user terminal 202, and to indicate the printer 203 to execute a process in accordance with the print requirement set as a part of a process requirement. FIG. 13 is a diagram showing a configuration example of the document printing program according to the second embodiment of the present invention. In FIG. 13, the document printing program 221 includes a decrypting part 221a, a decryption key obtaining part 221b, a print requirement obtaining part 221c, and a print processing part 221d. FIG. 14 is a diagram showing a configuration example of the print processing part shown in FIG. 13, according to the second embodiment of the present invention. In FIG. 14, the print processing part 221d includes a requirement processing part 221e, a document processing part 221f, a printer driver 221g, a warning displaying part 221h, and a log recording part 221i. Each function will be described later.

Referring to FIG. 11, when the user attempts to access the document (for example, to print the document), the access control server 204 refers to an access control list (ACL) in response to a request from the document printing program 221, determines whether or not the user is authorized to access the document, and obtains the process requirement.

The access control server 204 is connected to a user database 241 for storing information (a combination of user name and password) for authenticating each user and an ACL database 242 for registering the ACL including a process requirement defined to each user. It should be noted that a requirement for the printing process is especially called print requirement.

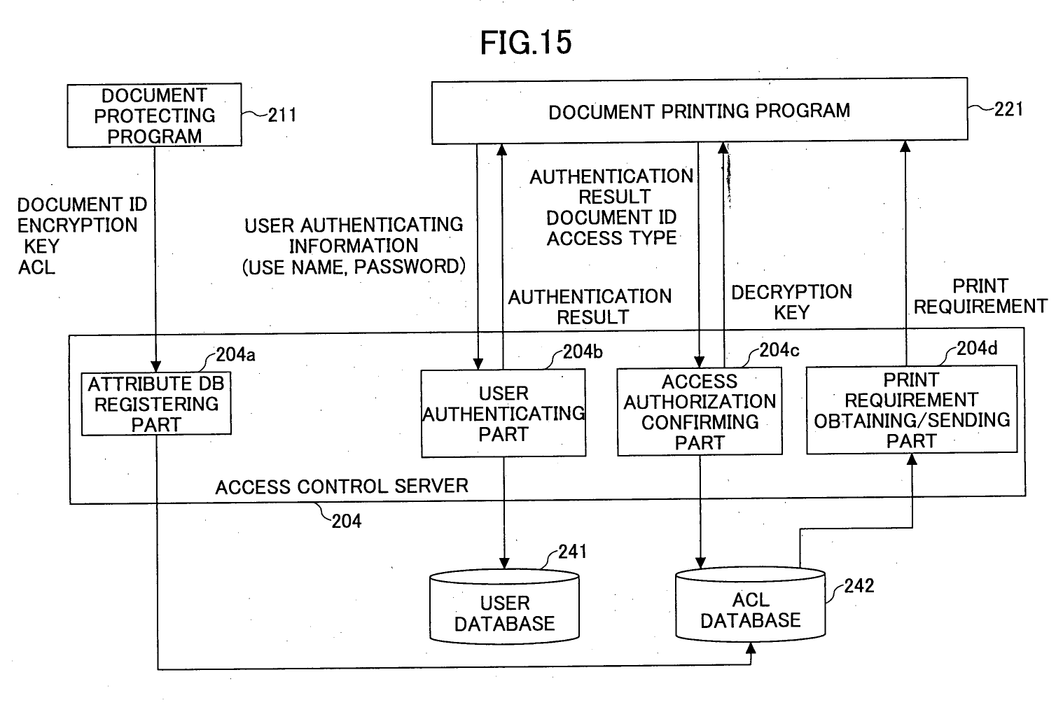

FIG. 15 is a diagram showing a configuration example of the access control server according to the second embodiment of the present invention. In FIG. 15, the access control server 204 includes an attribute DB registering part 204a, a user authenticating part 204b, an access authorization confirming part 204c, and a print requirement obtaining/sending part 204d. Each function will be described later.

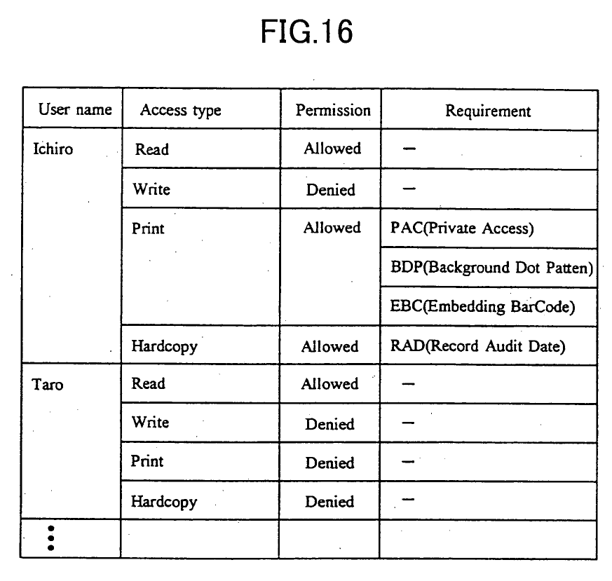

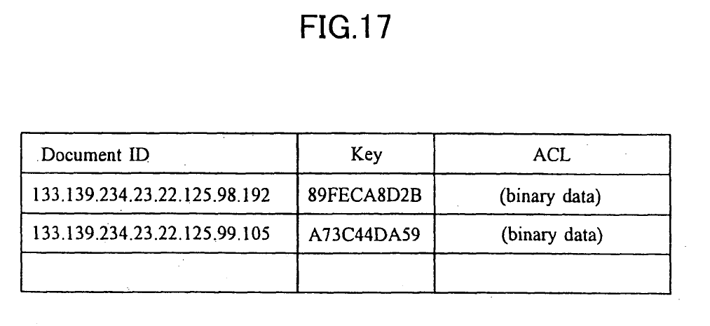

FIG. 16 is a diagram showing a structure example of the ACL according to the second embodiment of the present invention. In FIG. 16, the ACL includes parameters of “User name” as a user name, “Access type” as an access type, “Permission” as permission information, and “Requirement” as the process requirement. And as shown in FIG. 17, the ACL is recorded and maintained as one record by associating with “Document ID” as a document ID and “Key” as the encryption key in the ACL database 242.

Operations of the document protecting/printing system 2001 will be described. First, an operation of the entire document protecting/printing system 2001 will be described.

Referring to FIG. 11, the distributor stores the document to the distributor terminal 201. For example, the distributor may create the document by operating the input unit or has the distributor terminal 201 read the document from an information recording medium by operating the external recording unit.

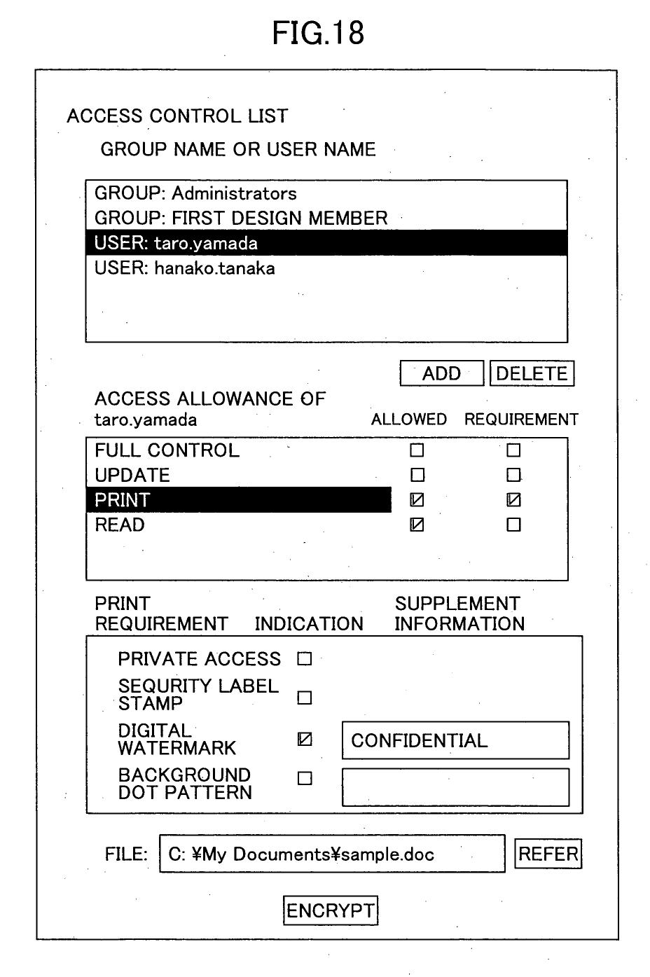

In case of securing the document, the distributor provides the document to the document protecting program 211 by operating the input unit. When the document protecting program 211 obtains the document, the document protecting program 211 requires the distributor to set the ACL. For example, the document protecting program 211 displays a message at the display unit of the distributor terminal 201 and requires the distributor of setting the ACL. FIG. 18 is a diagram showing a screen requiring of setting the ACL according to the second embodiment of the present invention. The screen allows the user to set the user name, access permission, and the print requirement. That is, the user adds a group or a user as an entry of the ACL, and indicates an access authentication with respect to the group or the user. In this case, if necessary, the user can indicate the print requirement, that is, the user selects (checks) one or more from available print requirements, and further inputs supplement information if necessary. In FIG. 18, “CONFIDENTIAL” is indicated as a character string of a watermark. Then, when a “ENCRYPT” button is clicked, settings in the screen are taken into the document protecting program 211. In this screen, the document to be secured can be indicated.

When the distributor sets the ACL by using the input unit of the distributor terminal 201, the document protecting program 211 obtains the ACL.

When the document protecting program 211 obtains the ACL, the document protecting program 211 generates the document ID (Document ID) identical for each document and the encryption key (Key) used to encrypt and decrypt the document, associates the document ID and Key with the ACL, and sends to the access control server 204 to register to the ACL database 242.

Also, the document protecting program 211 provides the document ID to the document which is encrypted by using the encryption key and then generates the secured document 13.

The distributor provides the secured document 13 generated by the document protecting program 211 to the user.

In a case in that the user attempts to print out the document, the secured document 13 is implemented to the user terminal 102. For example, the user terminal 202 may read out the secured document 13 stored in the information recording medium set in the external storage unit. Alternatively, in a case in that the user terminal 202 connects with the distributor terminal 201 through a network, the user terminal 202 may obtain the secured document 13 through the network.

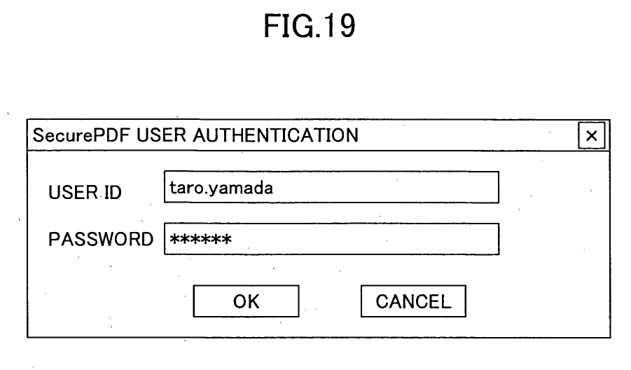

When the user indicates the document printing program 221 to print out the document by using the input unit of the user terminal 202, the document printing program 221 requires the user to input the password necessary to authenticate the user. For example, the document printing program 221 displays a message at the display unit of the user terminal 202 to require the user to input the password. FIG. 19 is a diagram showing a screen for requiring of inputting the user name and the password according to the second embodiment of the present invention. In FIG. 19, the screen allows the user to input the user name and the password by using a keyboard or a like.

The document printing program 221 requires the access control server 204 to authenticate the user by sending the user name and the password.

The access control server 204 authenticates the user by using the user name and the password received from the document printing program 221 and then specifies the user.

When the access control server 204 specifies the user, the access control server 204 refers to the ACL database 242, determines whether or not the user is authorized to print out the document, and obtains the print requirement when the user prints out the document.

When it is determined that the user is authorized to print out the document, the access control server 204 sends authentication information showing an authentication result, the encryption key to decrypt the secured document 13, and an the print requirement when the user prints out the document, to document printing program 221 the through the user terminal 202.

When the document printing program 221 receives the authentication information, the encryption key, and the print requirement from the access control server 204, the document printing program 221 decrypts the secured document by using the encryption key and then restores the document.

Then, the document printing program 221 controls the printer 203 to conduct the printing process so as to satisfy the print requirement. For example, in a case in that the BDP is set to the document as the print requirement, the printer 203 prints out contents of the document while printing out the background dot pattern.

As described above, when the document is printed out, it is possible for the distributor to enforce the print requirement set by the distributor with respect to each user.

Next, operations of the document protecting program 211 and the access control server 204 when the document is secured, and operations of the document printing program 221 and the access control server 204 when the secured document is restored and printed out will be described in detail.

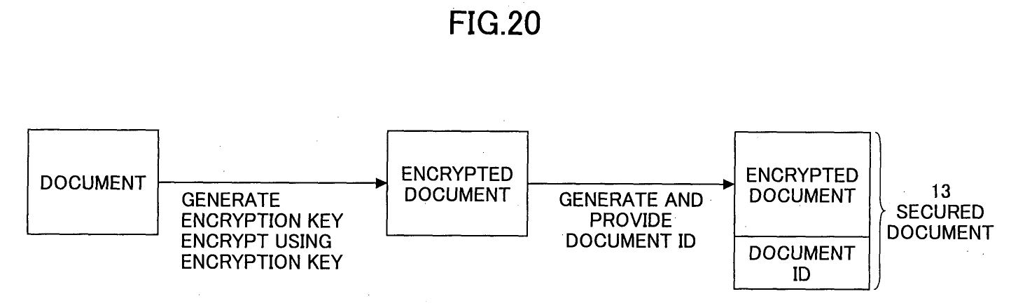

FIG. 20 is a diagram showing operations when the document protecting program generates the secured document according to the second embodiment of the present invention. When the document protecting program 211 obtains the document and the ACL by the input operation of the distributor at the input unit of the distributor terminal 201, the document protecting program 211 encrypts the document and generates the encryption key to encrypt and decrypt. Then, the document protecting program 211 encrypts the document by using the encryption key and generates an encrypted document.

After the secured document is generated, the document protecting program 211 sends the encryption key, the ACL, and the document ID to the access control server 204, and then requires the access control server 204 to register the encryption key, the ACL, and the document ID.

When the access control server 204 receives the encryption key, the ACL, and the document ID from the document protecting program 211, the access control server 204 associates the encryption key, the ACL, and the document ID as one record and record and maintain in the ACL database 242 as shown in FIG. 17.

The operations will be further described with reference to FIG. 12 and FIG. 15 in detail.

First, in FIG. 12, the encrypting part 211a of the document protecting program 211 encrypts the document received from the distributor by using the encryption key generated by the encryption key obtaining part 211b, and then sends an encrypted document to the attribute providing part 211c.

The attribute providing part 211c generates the document ID, provides the document ID to the encrypted document received from the encrypting part 211a, and outputs the secured document.

The attribute registering part 211d receives the ACL from the distributor and also receives the encryption key from the encryption key obtaining part 211b and the document ID from the attribute providing part 211c. Then, the attribute registering part 211d sends the ACL, the encryption key, and the document ID to the access control server 204 to register.

Next, in FIG. 15, the attribute DB registering part 204a of the access control server 204 registers the ACL, the encryption key, and the document ID to the ACL database 242.

In the second embodiment, the document protecting program 211 generates the document ID and the encryption key. Alternatively, the access control server 204 or another server (not shown) may generate the document ID and the encryption key.

If the distributor terminal 201 is not connected to the access control server 204 by a dedicated line but connected through a network and if it is concerned that the encryption key is intercepted while being sent to the access control server 204, a communication should be conducted by using a SSL (Secure Socket Layer).

A protocol for the document protecting program 211 to communicate with the access control server 204 can be any protocol. For example, a distribute object environment can be installed and information may be sent and received on a bases of Java® RMI (Remote Method invocation) and a SOAP (Simple Object Access Protocol). In this case, for example, the access control server 204 may implement a method such as “register(String docId, byte[ ] key, byte[ ] acl)”. If the SOAP is implemented, a message is exchanged by the SOAP on an HTTPS. If the RMI is implemented, by executing the RMI using a SocketFactory of an SSL base, the security on the network can be maintained.

Next, the operation in a case in that the document printing program 221 prints out the secured document 13 will be described.

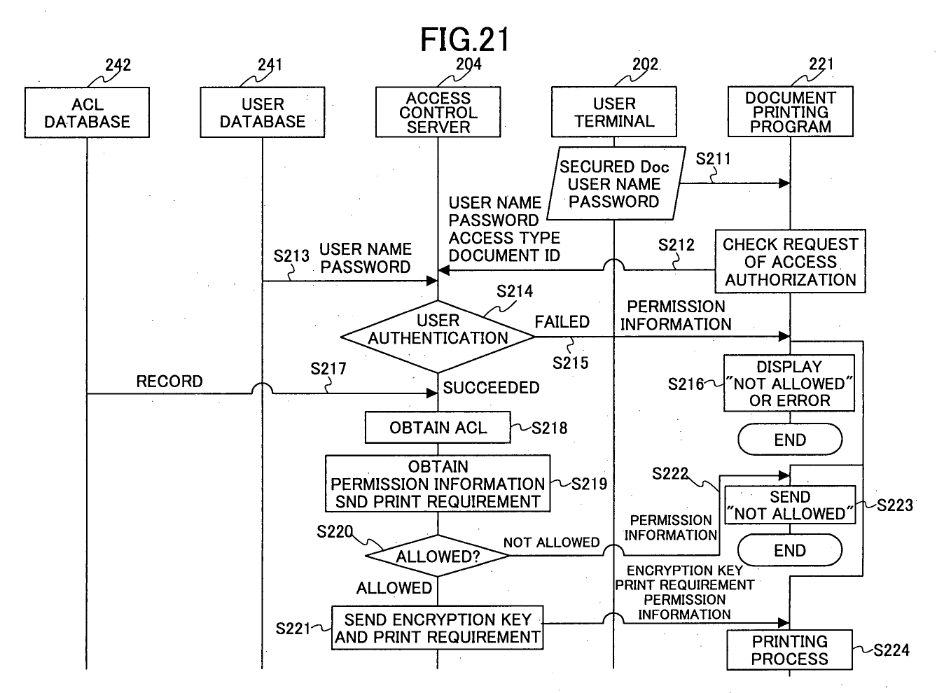

FIG. 21 is a diagram showing the operations of the document printing program and the access control server when the secure document is printed out, according to the second embodiment of the present invention.

When the document printing program 221 obtains the user name and password by the input operation of the user at the input unit of the user terminal 202, the document printing program 221 obtains the document ID attached with the secured document (step S211).

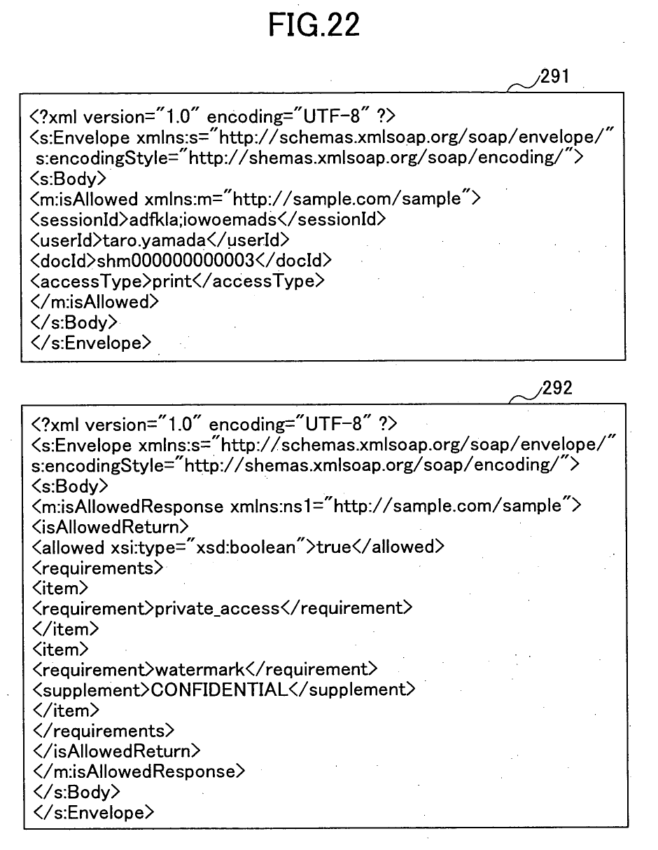

Subsequently, the document printing program 221 sends the user name, the password, the document ID, the access type and requests the access control server 204 to check whether or not the user has the access authorization (step S212). The access type is information showing a process requested by the user. In this case, the access type shows “print” since the user attempts to print out the secured document. FIG. 22 is a diagram showing an enquiry example by the SOAP to the access control server according to the second embodiment of the present invention. In FIG. 22, a SOAP 291 including the user name (userId), the document ID (docId), and the access type (accessType) is sent to enquire whether or not the access is allowed to the user. And a SOAP 292 showing a result (isAllowedReponse) is received. The result shows that the user is allowed (“allowed” indicates “true”) and the result includes a requirement (“requirement”).

When the access control server 204 receives the user name, the password, the document ID, and the access type, the access control server 204 refers to information registered in the user database 241 (step S213) and conducts the user authentication (step S214).

That is to say, the access control server 204 refers to the information registered in the user database 241 and determines whether or not the combination of the user name and the password included in the information obtained from the document printing program 221 is registered in the user database 241.

When the user authentication is failed (that is to say, the combination of the user name and the password included in the information received from the document printing program 221 is registered), the access control server 204 sends the permission information (information showing whether or not the process requested by the user is allowed) as “NOT ALLOWED” to the user terminal 202, and sends to the document printing program 221 (step S215). In this case, the permission information showing “ERROR” may be sent to the document printing program 221. The document printing program 211 displays “NOT ALLOWED” or “ERROR” at the display unit of the user terminal 202 (step S216).

On the other hand, when the user authentication is succeeded, the access control server 204 reads out a record concerning the document ID included in the information obtained from the document printing program 221 from records stored in the ACL database 242 (step S217).

The access control server 204 obtains the ACL included in the record read out from the ACL database 242 (step S218), and obtains the permission information and the print requirement from the ACL based on the user name and the access type obtained from the document printing program 221 (step S219).

That is to say, the access control server 204 obtains the permission information and the print requirement that are set beforehand, based on the user name and the access type. Then, the access control server 204 determines whether or not the user is allowed (step S220).

When the permission information obtained from the ACL shows “ALLOWED”, the access control server 204 sends the encryption key and the print requirement stored in the record with the permission information to the user terminal 202 to provide to the document printing program 221 (step S221).

On the other hand, when the permission information obtained from the ACL shows “NOT ALLOWED”, the access control server 204 send only the permission information to the user terminal 202 to provide to the document printing program 221 (step S222).

When the document printing program 221 receives the permission information received from the access control server 204, the document printing program 221 refers to the permission information. When the permission information shows “NOT ALLOWED”, the document printing program 221 displays a message at the display unit of the user terminal 202 to notify the user that the process requested by the user can not be conducted (step S223).

On the other hand, when the permission information shows “ALLOWED”, the document printing program 221 decrypts the encrypted document being a portion of the secured document 13 so as to restore the document.

Next, the document printing program 221 sets the printer driver so as to satisfy the print requirement set to the document and controls the printer 203 to conduct the printing process with respect to the document (step S224). For example, if the PAC is indicated as the print requirement, the document printing program 221 sets the private access mode.

If necessary, the document printing program 221 displays a message at the display unit of the user terminal 202 to require the user to set print parameters.

If the printer 203 can not conduct the printing process so as to satisfy the print requirement, that is, if the printer 203 does not implement a function satisfying the print requirement set to the ACL, the document printing program 221 displays a message at the display unit of the user terminal 202 to inform the user, and terminates the operation without the printing process.

The operations will be described with reference to FIG. 13 through FIG. 15 in detail.

First, in FIG. 13, the decryption key obtaining part 221b of the document printing program 221 enquires the access control server 204 to confirm the access authorization.

In FIG. 15, when the access control server 204 receives an enquiry of confirming the access authorization, the user authenticating part 204b conducts the user authentication by referring to the user database 241, and sends an authentication result to the document printing program 221. When the user authentication is succeeded, the access authorization confirming part 204c obtains the permission information and the decryption key by referring to the ACL database 242. Then, the print requirement obtaining/sending part 204d obtains the print requirement and sends to the document printing program 221. In FIG. 15, the authentication result is sent to the document printing program 221 and then is received from the document printing program 221 again. Alternatively, this process may be conducted at one time. Also, the permission information, the decryption key, and the print requirement are sent to the document printing program 221, respectively. Alternatively, the decryption key, and the print requirement can be simultaneously sent to the document printing program 221.

In FIG. 13, when the decryption key obtaining part 221b confirms the access authorization, the decryption key obtaining part 221b obtains the decryption key from the access control server 204, and sends to the decrypting part 221a. The print requirement obtaining part 221c obtains the print requirement from the access control server 204, and provides to the print processing part 221d.

The decrypting part 221a decrypts the secured document 13 by using the decryption key obtained from the decryption key obtaining part 221b, obtains the document, and then provides to the print processing part 221d.

Next, in FIG. 14, the requirement processing part 221e of the print processing part 221d conducts a plurality of processes in response to contents of the print requirement. That is, if the document itself is required to be process as described the BDP, the EBC, and the SLS, the document processing part 221f processes the document by the process information and sends a processed document to the printer driver 221g. Then, the printer driver 221g provides print data to the printer 203 and the printer 203 prints out the document. In a case in that a special setting is required to the printer driver 221g such as the PAC, a print setting is conducted to the printer driver 221g. In a case in that a warning message to the user is required, the warning message is provided to the warning displaying part 221h to display at the display unit. Also, in a case in that a print log is required, log information is sent to the log recording part 221i and then log data is registered to a remote server or a like.

By the above described operations, it is possible to set the access authorization and the print requirement for each user. Moreover, as described above, in a system configuration in that the access authorization with respect to the document is determined at a server side, contents of the ACL registered in the ACL database 242 can be updated by the input operation at the distributor terminal 201 or the access control server 204. In this case, after the secured document is distributed, the print requirement can be updated.

For example, it is possible to set the access authorization with respect to the secured document 13, which has been already distributed, to a new user, and it is possible to add the print requirement to a specific user.

If a person, who knows that the document protecting/printing system 2001 according to the second embodiment secures the document by the above described technology, may execute a program behaving like the document printing program 221 at a computer terminal and may illegally obtain the encryption key. Then, the person can decrypt the secured document 13. In this case, the print requirement set as the ACL will not be enforced, and the secured document 13 can be unlimitedly printed out.

Therefore, instead of simply encrypting the document by using only the encryption key, it is preferred to encrypt the document by using a combination of the secret key embedded in the document protecting program 211 and the encryption key. In this case, by embedding the same secret key in the document printing program 221, it is possible to limit only the document printing program 221 that enforces the print requirement set by the distributor, to decrypt and print out the secured document 13.

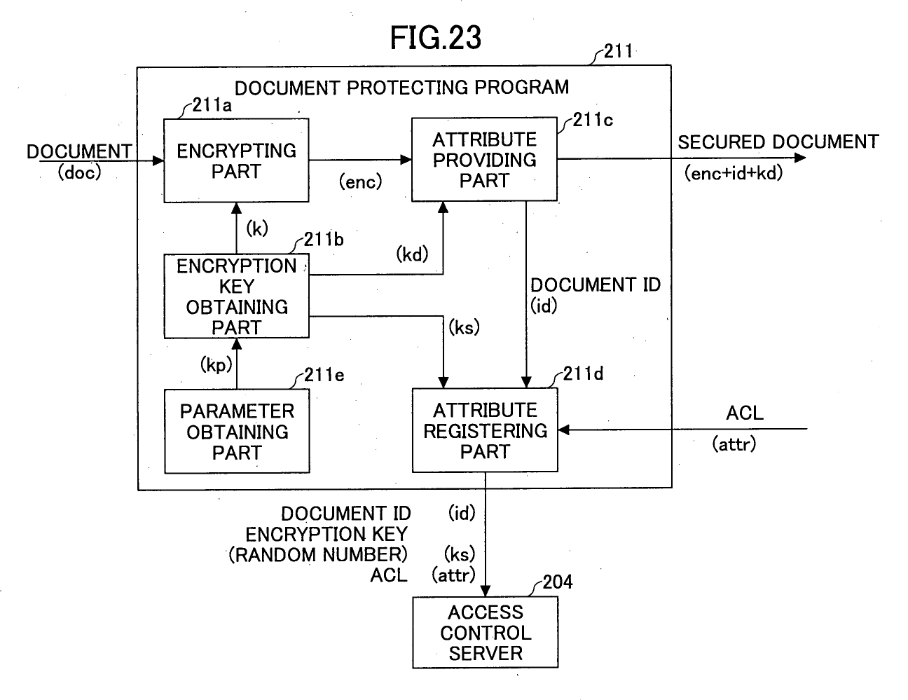

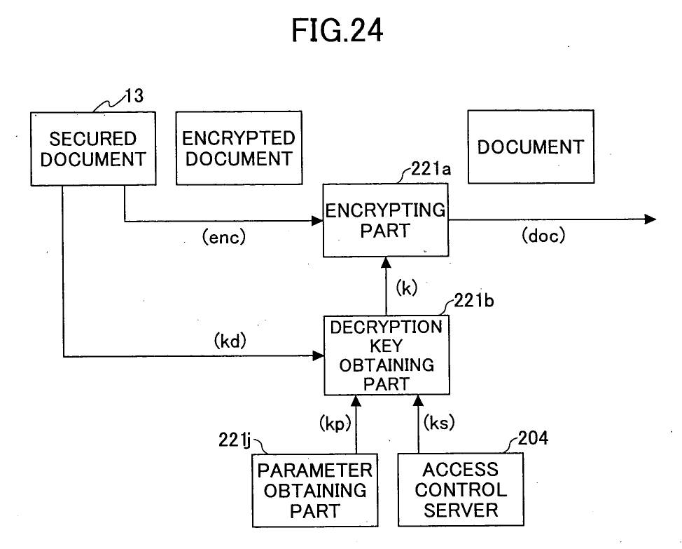

A type in a case of embedding the secret key in the document protecting program 211 will be described with reference to FIG. 23 and FIG. 24. FIG. 23 is a diagram showing a configuration example of the document protecting program according to the second embodiment of the present invention. FIG. 24 is a diagram showing a portion related to a decryption in the configuration example of the document printing program according to the second embodiment of the present invention. In FIG. 23 and FIG. 24, not only the secret key is simply embedded but also a random number is installed to reinforce more against an illegal access.

In FIG. 23, the document protecting program 211 includes an encrypting part 211a, an encryption key obtaining part 211b, an attribute providing part 211c, an attribute registering part 211d, and a parameter obtaining part 211e.

In operations, the parameter obtaining part 211e generates a parameter (kp), and provides to the encryption key obtaining part 211b. It should be noted that the parameter (kp) should be maintained within the document protecting program 211 and be generated when required.

After the encryption key obtaining part 211b receives the parameter (kp) from the parameter obtaining part 211e, the encryption key obtaining part 211b generates two random numbers (kd) and (ks), and generates the encryption key (k) by calculating k=H{ks, kp, kd} or k=D{kd, D[ks, kp]}. Subsequently, the encryption key obtaining part 211b provides the encryption key (k) to the encrypting part 211a, the random number (kd) to the attribute providing part 211c, and the random number (ks) to the attribute generating part 211d, respectively. H{data 1, data 2, . . . } denotes to calculate the hash values of the data 1, the data 2, . . . , and D{data, key} denotes to decrypt the data by the key.

The encrypting part 211a encrypts the document (doc) received form the distributor by using the encryption key (k) obtained from the encryption key obtaining part 211b, and provides the encrypted document (enc) to the attribute providing part 211c. This expression is shown as enc=E{doc, k}. E{data, key} denotes to encrypt the data by the key.

Next, the attribute providing part 211c generates the document ID (id), provides the document ID (id) and the random number (kd) provided from the encryption key obtaining part 211b to the encrypted document, and then outputs the secured document (enc+id+kd). In addition, the attribute providing part 211c provides the document ID (id) to the attribute registering part 211d.

The attribute registering part 211d sends the document ID (id) received from the attribute providing part 211c, the random number (ks) received from the encryption key obtaining part 211b, and the ACL (attr) obtained from the distributor to the access control server 204 to register.

Referring to FIG. 24, in order to decrypt, the decryption key obtaining part 221b obtains the random number (kd) from the secured document 13, and a parameter (kp), that is maintained in the document printing program 221 or generated in response to a request, from the parameter obtaining part 221j. The decryption key obtaining part further obtains the random number (ks) from the access control server 204, and obtains the decryption key (encryption key) (k) by calculating k=H{ks, kp, kd} or k=D{kd, D {ks, kp}} similar to the encryption.

Then, the decrypting part 221a decrypts the encrypted document (enc) by using the decryption key (k) and then obtains the document (doc).

FIG. 23 and FIG. 24 show a method for generating the encryption key (decryption key) (k) based the random number (ks) registered in the access control server 204, the random number (kd) in the secured document 13, and the parameter (kp) from the document protecting program 211 or the document printing program 211. By the method, even if the access control server 204 is illegally accessed by a hacker as a user and the random number (ks) is known to the viper, the secured document 13 can not be decrypted without the random number (kd) and the parameter (kp). However, in a circumstance in that the access control server 204 is sufficiently guarded not to be illegally accessed, the random number (ks) can be used as the encryption key (decryption key) (k) itself.

On the other hand, in the second embodiment, the print requirement is stored in only the access control server 204. Alternatively, the print requirement can be included in the secured document 13. For example, if the print requirement is always indicated to the document regardless of the user, the print requirement can be included in the secured document 13.

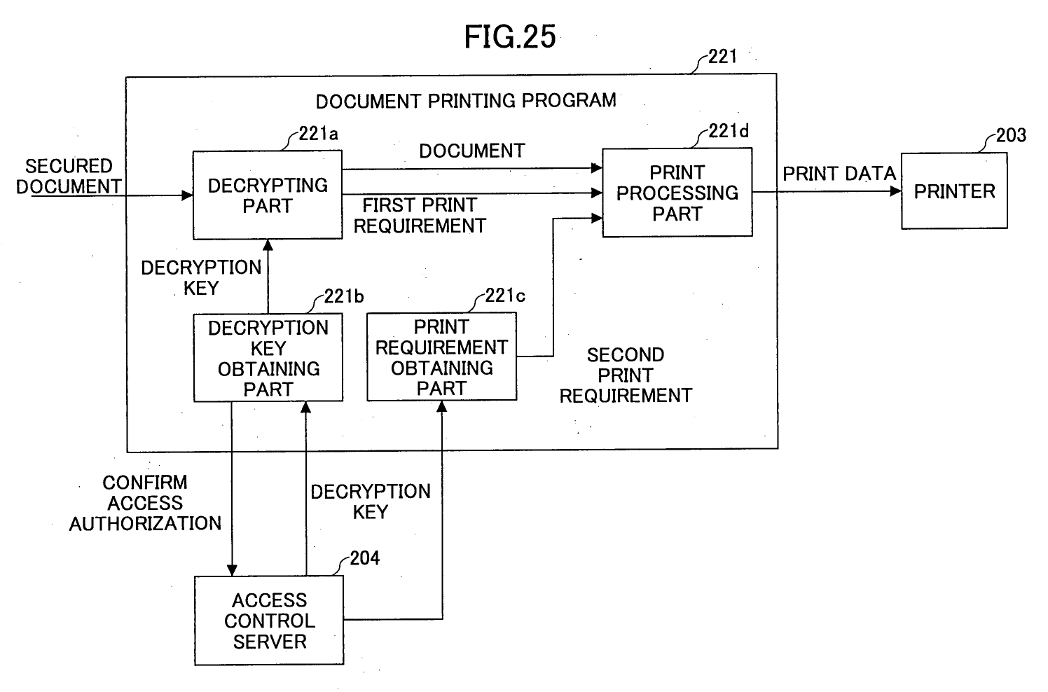

FIG. 25 is a diagram showing a configuration example of the document printing program in a case in that the entire print requirements are separated into a first print requirement to include in the secured document and a second print requirement to store in the access control server, according to the second embodiment of the present invention. In FIG. 25, the print requirement obtaining part 221c obtains the second print requirement from the access control server 204 and the decrypting part 221a obtains the first print requirement from the secured document 13. Accordingly, the print processing part 221d conducts the printing process based on the first print requirement and the second print requirement. The other operations are conducted similar to the operations of the document printing program 221 shown in FIG. 25.

Moreover, in the second embodiment, the document printing program 221 only conducts the process related to printing the document. In addition, the document printing program 221 may provides contents of the document to the user, and may implement a function of editing the document. For example, the document printing program 221 can realize a function of displaying, editing, and printing a PDA file (portable document format) as a plug-in of Adobe acrobat®.

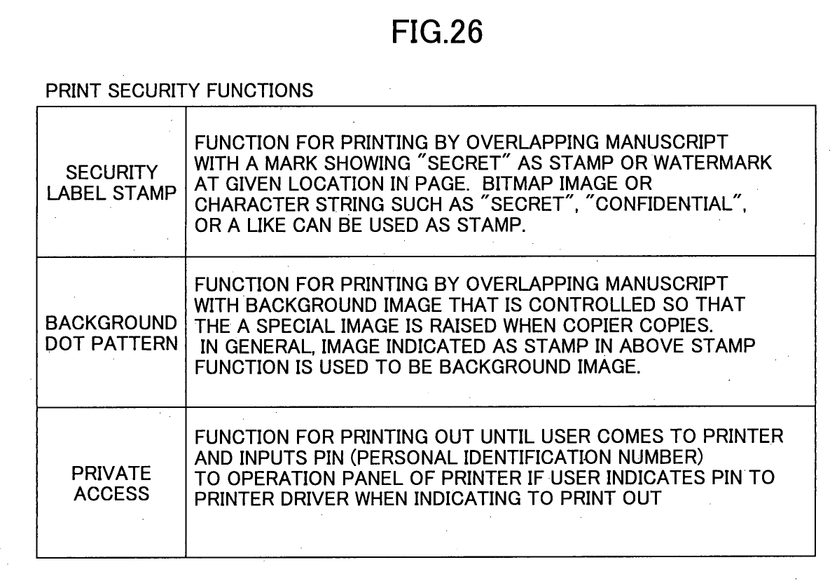

FIG. 26 is a diagram showing a portion of a security function implemented in the printer applied in the second embodiment of the present invention. A system configuration example according to the second embodiment of the present invention will be concretely described.

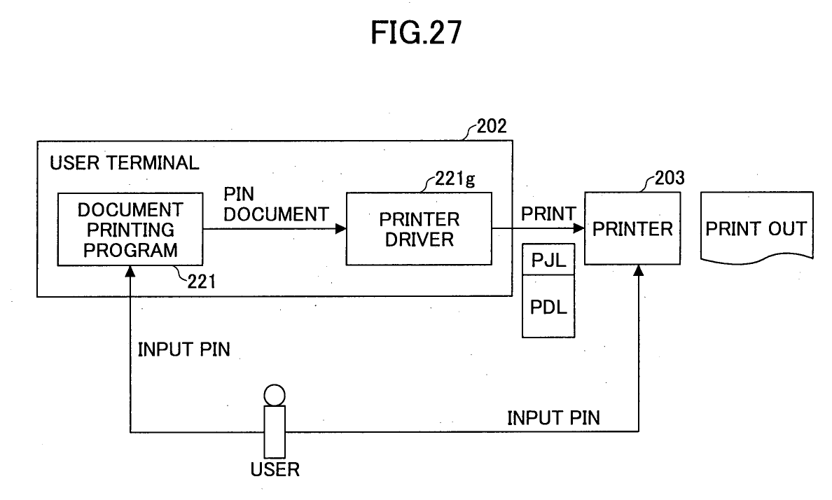

First, operations of the document printing program 221 will be described in a case in that the PAC is set as the print requirement. FIG. 27 is a diagram showing the operation of the document printing program in the case in that the PAC is set as the print requirement according to the second embodiment of the present invention.

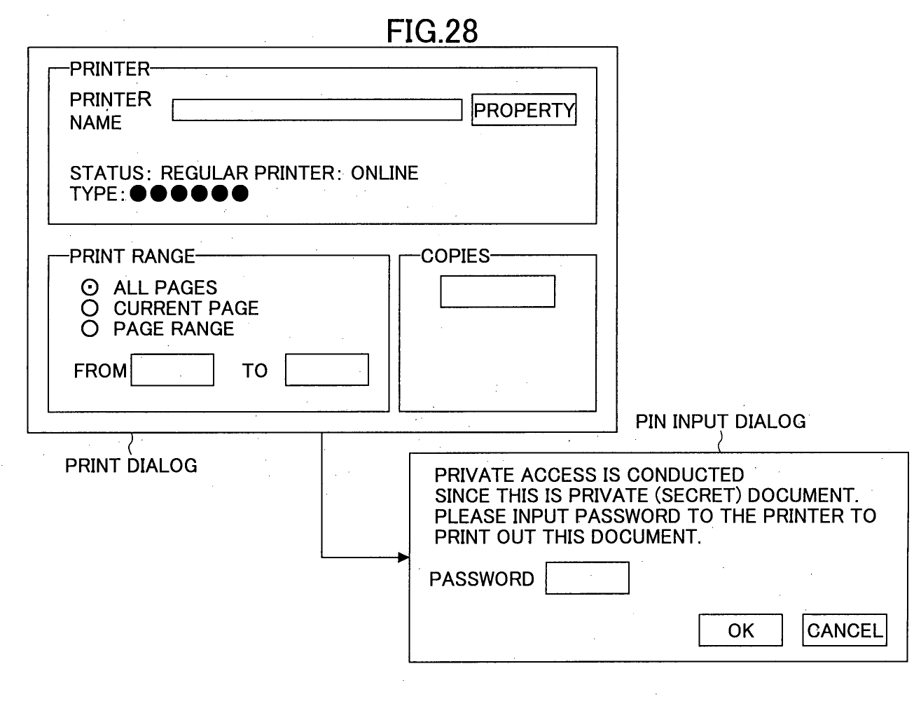

(1) when the document printing program 221 prints out the document where the PAC is set, the document printing program 221 displays a dialog for inputting a PIN (personal identification number) at the display unit of the user terminal 202 after displaying a print dialog, as shown in FIG. 28.

(2) When the user inputs the PIN by using the input unit of the user terminal 202, the document printing program 221 sets the PIN to the printer driver 221g and indicates to print out.

The printer driver 221g generates print data (PDL data described in a PDL (Page Description Language) such as a Postscript from the document, additionally provides PJL (Print Job Language) data describing print job information showing the number of copies and an output tray to a header of the PDL data. The printer driver 221g further additionally provides the PIN as a portion of the PJL data and sends the PDL data with the PJL data to the printer 203.

The printer 203 refers to contents of the PJL data when receiving the PDL data with PJL data, and stores the PDL data with the PJL data in a storage unit (a hard disk device) if the PIN for the private access is included. When the user inputs the PIN through the operation panel of the printer 203, the printer 203 checks the PIN input by the user with the PIN included in the PJL data. When both PINs are identified, the document is printed out in accordance with the PDL data applying a print job condition (the number of copies, the output tray, or the like) included in the PJL data.

(3) When the PIN can not be set to the printer driver 221g, that is, when the printer 203 does not support the private access, the user is informed to select another printer supporting the private access, and the process is terminated without printing out the document.

As described above, after the printing process is executed, the printout of the document can not be output from the printer 203 until a PIN identical to the PIN input by the user prior to the printing process is input by the user at the operation panel of the printer 203. Accordingly, the printout of the document is not carelessly left at the printer 203. Thus, it is possible to prevent the document from being leaked by the printout. Furthermore, a communication with the printer 203 should be secured by the SSL so that the print data transmitting through the network can not be intercepted.

Alternatively, the document printing program 221 may be associated with a user management of Windows® Domain, so that the user is not required to input the PIN. For example, the PIN is not input by the user but the user ID being currently logged on is obtained from Windows® Domain, and the user ID is sent to the printer 203 with the print data. The printer 203 receives the password input by the user at the operation panel, conducts the user authentication with the user ID and the password by using a user authentication organization of Window® Domain. When the user authentication is succeeded, the printer 203 prints out the document. However, it is not limited to Window® Domain. By associating with the user management installed beforehand, it is possible to eliminate an input of the PIN which is a problem for the user.

Next, operations of the document printing program 221 will be described in a case in that the EBC is set as the print requirement.

(1) The document printing program 221 generates data for a barcode image data (or a two dimensional code) showing the document ID when the document where the EBC is set is printed out.

(2) The document printing program 221 sets a generated barcode image data to the printer driver 221g as a stamp image, and indicates the printer 203 to print out the document.

(3) When the EBC can not be set to the printer driver 221g, that is, when the printer 203 does not support a stamp function, the user is informed to select another printer supporting the stamp function and the process is terminated without the printing process.

As described above, a barcode is printed on each page of the printout of the document. Thus, only a copier, a facsimile, or a scanner that can identify this barcode can obtain the document ID by decoding the barcode, and can determine based on the document ID by accessing the access control server 204 whether or not a hardcopy, an image reader, a facsimile transmission, or a like is allowed. Therefore, it is possible to maintain a consistent security including a paper document.

Next, operations of the document printing program 221 will be described in a case in that the BDP is set as the print requirement.

(1) The document printing program 221 obtains the user name of the user who requests to print out the document, and a print date as a character string (for example, Ichiro, Aug. 4, 2002 23:47:10) when printing out the document where the BDP is set.

(2) The document printing program 221 generates the background dot pattern so that a generated character string seems to be a relief character string when copying the printout of the document by a copier.

(3) The document printing program 221 sets the generated background dot pattern as a stamp and indicates the printer 203 to print out the document.

(4) When the BDP can not be set to the printer driver 221g, that is when the printer 203 does not support the background dot pattern, the user is informed to select another printer supporting the background dot pattern, and the process is terminated without printing out the document.

Accordingly, the background dot pattern where the user name and the date are shown as relief characters is printed on each page of the printout of the documents, so that the relief characters are formed if the printout is processed by the copier, the scanner, or the facsimile. This is effective in a case of using the copier that does not support the EBC. In addition, it can be suppressed to leak information by copying the printout of the document.

Next, operations of the document printing program 221 will be described in a case in that the SLS is set as the print requirement.

(1) The document printing program 221 selects an image (mark of “Top Secret”) corresponding a confidential level of the document from images prepared beforehand when printing out the document where the SLS is set as the print requirement.

(2) Data of a selected image are set to the printer driver 221g as a stamp, the document printing program 221 indicates the printer 203 to print out the document.

(3) When the SLS can not be set to the printer driver 221g, that is when the printer 203 does not support the SLS, and the process is terminated without printing out the document.

Accordingly, since the mark of “Top Secret” is automatically printed out as the stamp when the document is printed out, it can be clearly seen that the document is a private (confidential) document. That is, it is possible to warn a person possessing the printout in order to manage the private (confidential) document.

Each example described above is just an example of the print requirement. Alternatively, the digital watermark providing a tamper-proof may be printed, or the document to be secured may be printed on a special paper sheet (a tray is limited a tray for a special paper sheet).

That is to say, the print requirement can include a requirement for limiting or canceling a function, or a requirement for compulsory using a function, and additionally a print condition indication for a normal print. As an example of limiting or canceling the function, there is a print requirement for allowing only a special user to print out in color to distinguish over an original private (confidential) document and restricting other user so as to allow printing the original private (confidential) document in grayscale. As examples of enforcing to user the function, there are a print requirement for enforcing to user the private access mode, a print requirement for enforcing to print the user name of the user who prints out, a print requirement for enforcing to print the watermark, a print requirement for enforcing to print the background dot pattern, and a like. As example of indicating a general print condition, there are a print requirement for indicating an A4 size as a regular sheet, a print requirement for using a tray for a recycled paper, and a print requirement for indicating a both sides print.

As an description format of the print requirement, it is not limited to use keywords such as the RAD and the PAC as described above. For example, the print requirement can be described and regulated by using data themselves of a setting file to set to the printer driver 221g, a character string itself to display at a screen, data describing contents of a requirement to be processed in a script language. That is, it is not limited to the keywords such as the RAD or the PAC to describe the print requirement.

As described above, by setting the print requirement in accordance with a security policy by using various security function supported by the printer 203, the security function can be fully utilized, and a consistent security can be maintain. The security can be realized similarly in other embodiments.

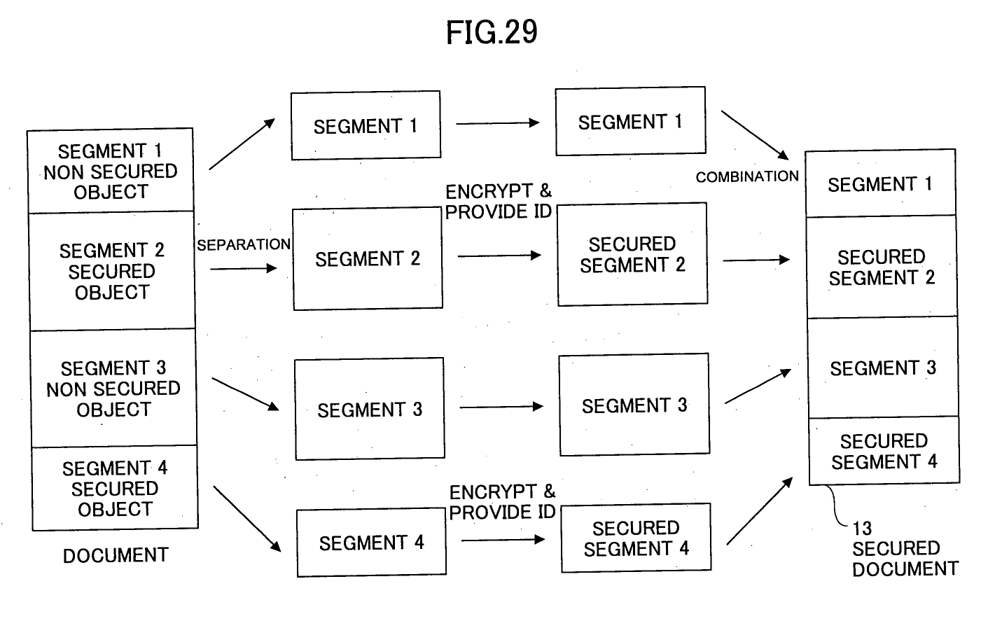

In the first and second embodiments, the present invention is applied to the entire document as a secured object. Alternatively, portions (called segments) to be secured objects and portions not to be secured objects can be mixed. For example, as shown in FIG. 29, secured segments may exist within a plurality of secured documents. In this case, a different segment ID is assigned to each secured segment. The document ID described above can be read the segment ID. In a similar manner, it is possible to conduct the access control including the printing process for each secured segment. In practice, a start marker showing a start of the secured segment and an end marker showing an end of the secured segment are needed to provide at the beginning and the ending of the secured segment. A conventional technology such as a multi-part separator of a MIME can be used to provide those markers.

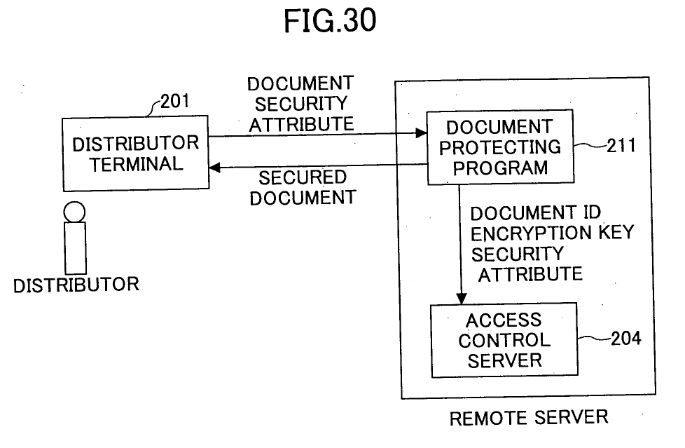

In the first and second embodiments, the document protecting program is arranged in the distributor terminal. Alternatively, a main part of the document protecting program may be arranged in a remote server. For example, the distributor terminal 201, relationships among the document protecting program 211, and the access control server 204 in FIG. 11 can be modified as shown in FIG. 30. By arranging as shown in FIG. 30, even if the document protecting program is not installed into a terminal, it is possible for the terminal to obtain the secured document 13 by sending the document and necessary parameters to the remote server.

The present invention is not limited to each of the embodiments.

For example, in each of embodiments, the distributor terminal and the user terminal are illustrated as separate terminals. Alternatively, the distributor terminal and the user terminal can be the same terminal.

Moreover, it is not limited to a case in that the user directly operates the user terminal where the document printing program is implemented. For example, the document printing program can be implemented in a server, and the user may execute the document printing program through the network by operating the user terminal.

Furthermore, a method for the user authentication is not limited to a method using the user name and the password. Alternatively, an authenticating method in a base of a PKI using a smart card.

The present invention can be modified.

In the embodiments, it is not limited to a word “printer” to use. The word “printer” is not to strictly limit to a dedicated printer but is applied to a copier, a facsimile, and an apparatus composing or fusing these functions together. That is, the word “printer” is applied to any apparatus including a print function.

### Third Embodiment

A third embodiment will be described according to the present invention.

In the above-described embodiments, the distributor set an ACL (Access Control List) for each document file. In a case in which the document can be distributed to a plurality of users, to set a print requirement for each user gives the distributor extra workload when the distributor creates the ACL.

On the other hand, in a case that contents of the document is a business document, how to secure the document should not be decided by a individual distributor but should be decided based on a security policy (secret management policy) by an organization (business organization or institution) which the distributor belongs to. That is, if a document protecting/printing system can secure the document in accordance with the security policy of the organization which the distributor belongs to, the distributor is not required to set the ACL.

In the third embodiment of the present invention, the document protecting/printing system, which protect the document in accordance with the security policy of the organization which the distributor belongs to, will be described.

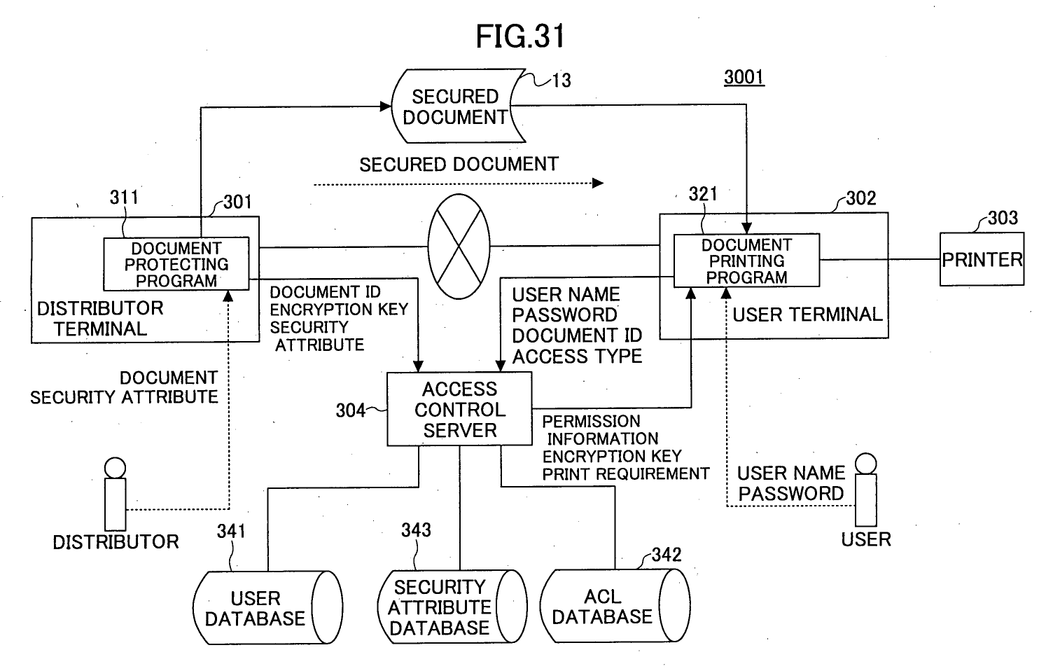

FIG. 31 is a diagram showing the document protecting/printing system according to the third embodiment of the present invention.

The document protecting/printing system 3001 includes a distributor terminal 301, a user terminal 302, a printer 303, and an access control server 304.

Each of the distributor terminal 301 and the user terminal 302 can be applied to a computer terminal including a display unit (for example, an LCD (Liquid Crystal Printer), an input unit (for example, a keyboard), an external storage unit (for example, an FDD (Floppy Disk Device), an HDD (Hard Disk Device), or a like). It should be noted that the distributor terminal 301 implements a document protecting program 311 and the user terminal 302 implements a document printing program 321.

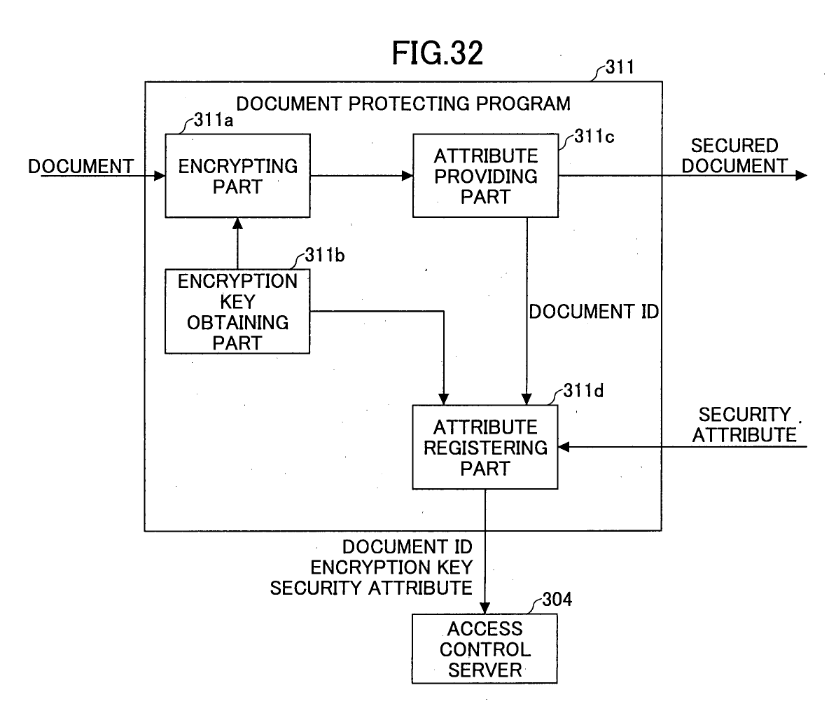

The document protecting program 311 is a program to set a print requirement to a document file (hereinafter, simply called a document) in response to an input operation by a distributor using the distributor terminal 301, encrypt the document using an encryption algorithm (for example, an RC4, Triple DES, IDEA), and generate a secured document 13. FIG. 32 is a diagram showing a configuration example of the document protecting program according to the third embodiment of the present invention. In FIG. 32, the document protecting program 311 includes an encrypting part 311a, an encryption key obtaining part 311b, an attribute providing part 311c, and an attribute registering part 311d. Each function will be described later.

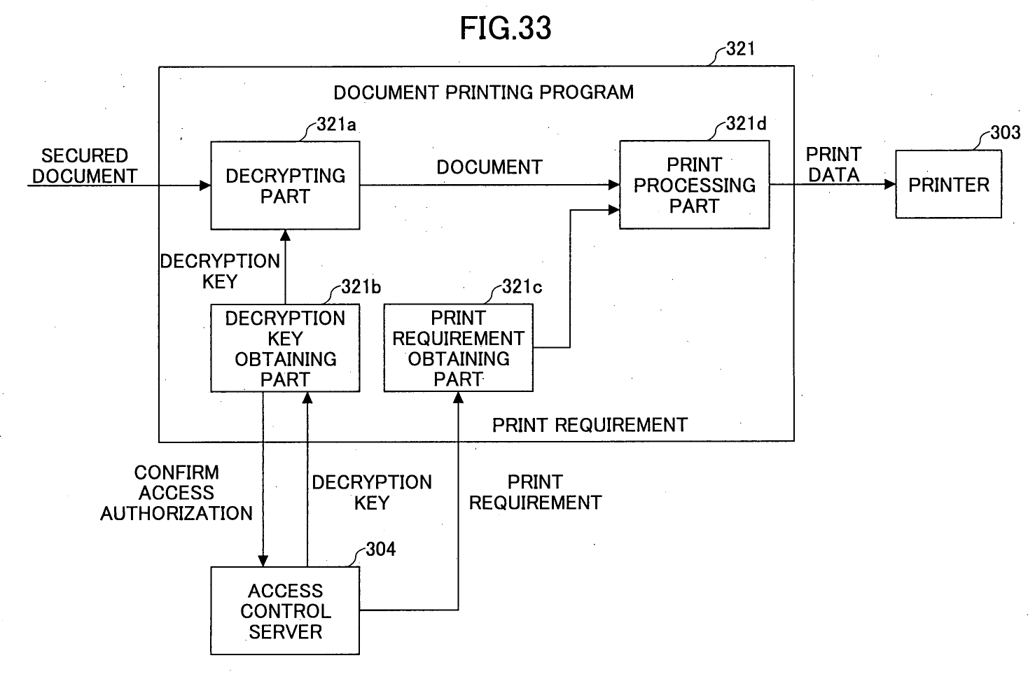

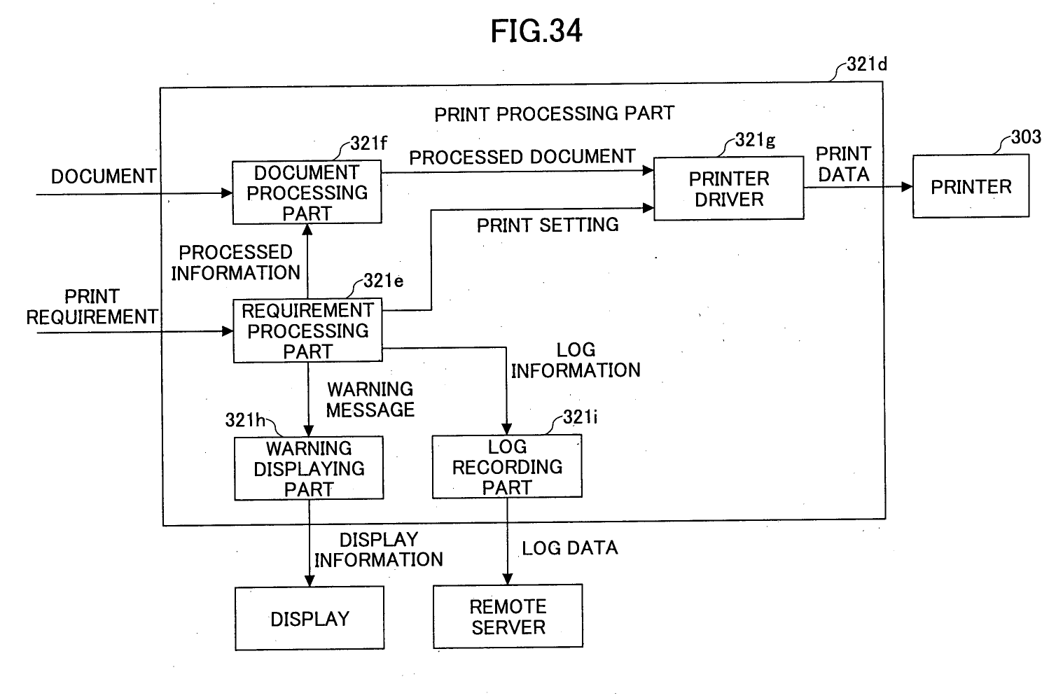

Referring to FIG. 31, the document printing program 321 is a program to decrypt the secured document 13 in response to an input operation by a user using the user terminal 302, and to indicate the printer 303 to execute a process in accordance with the print requirement. FIG. 33 is a diagram showing a configuration example of the document printing program according to the third embodiment of the present invention. In FIG. 33, the document printing program 321 includes a decrypting part 321a, a decryption key obtaining part 321b, a print requirement obtaining part 321c, and a print processing part 321d. FIG. 34 is a diagram showing a configuration example of the print processing part shown in FIG. 33, according to the third embodiment of the present invention. In FIG. 14, the print processing part 321d includes a requirement processing part 321e, a document processing part 321f, a printer driver 321g, a warning displaying part 321h, and a log recording part 321i. Each function will be described later.

Referring to FIG. 31, when the user attempts to access the document (for example, to print the document), the access control server 304 refers to the ACL in response to a request from the document printing program 321, determines whether or not the user is authorized to access the document, and obtains the process requirement.

The access control server 304 is connected to a user database 341 for storing information (a combination of user name and password) for authenticating each user and information showing a level of the user, an ACL database 342 for registering the ACL including a process requirement defined to each user, and a security attribute database 343 in which information showing what security attribute is set to each secured document 13 and an encryption key for encrypting and decrypting the secured document 13 are associated with together and registered.

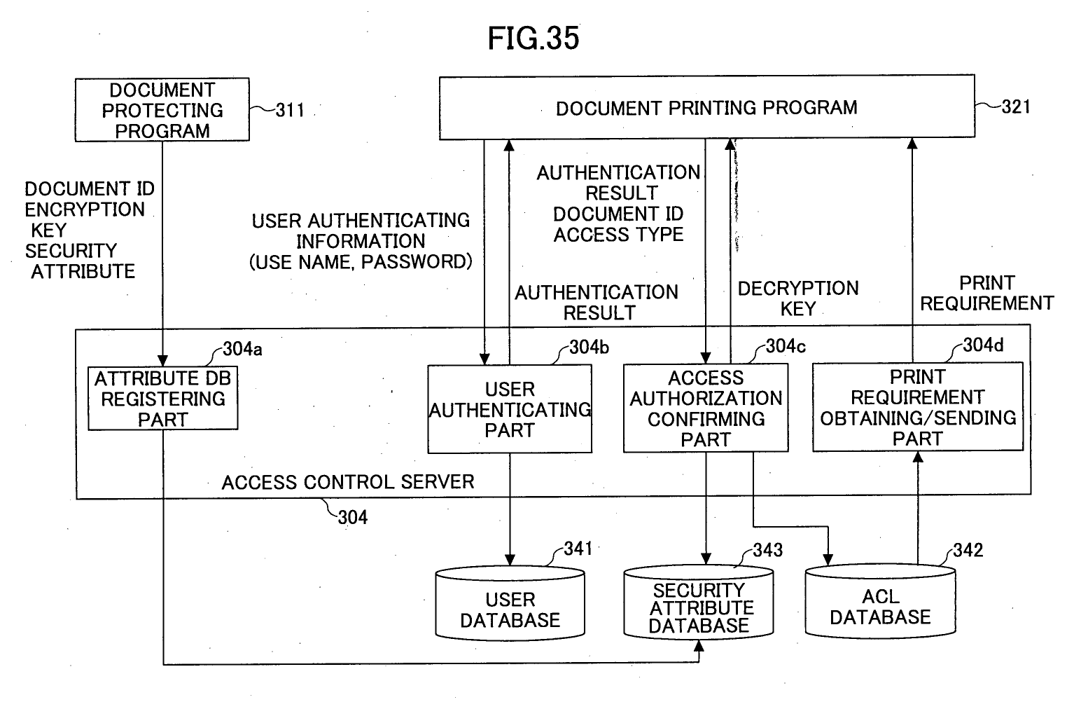

FIG. 35 is a diagram showing a configuration example of the access control server according to the third embodiment of the present invention. In FIG. 35, the access control server 304 includes an attribute DB registering part 304a, a user authenticating part 304b, an access authorization confirming part 304c, and a print requirement obtaining/sending part 304d. Each function will be described later.

As an example of the ACL corresponding to the security attribute, the ACL corresponds to a small organization such as an “ACL for the first design room”, an “ACL for the second design room ACL, or a like. The ACL in the third embodiment is similar to the ACL shown in FIG. 6 in the second embodiment, in that parameters of “User name” as a user name, “Access type” as an access type, “Permission” as permission information, and “Requirement” as the process requirement are included. In addition, this ACL is registered for each security attribute in the ACL database 342.

As the print requirement which the document protecting program 311 sets to the document in response to the input operation of the distributor; for example, a BDP (Background Dot Pattern), a PAC (Private Access), a DWM (Digital Watermark), an EBC (Embedding Barcode), or an SLS (Security Label Stamp) may be required.

Operations of the document protecting/printing system 3001 will be described. First, an operation of the entire document protecting/printing system 3001 will be described.

Referring to FIG. 31, the distributor stores the document to the distributor terminal 301. For example, the distributor may create the document by operating the input unit or has the distributor terminal 301 read the document from an information recording medium by operating the external recording unit.

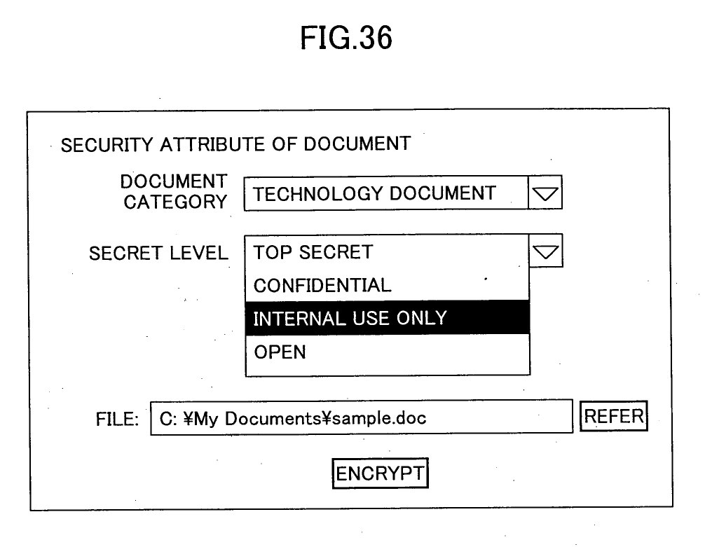

In case of securing the document, the distributor provides the document to the document protecting program 311 by operating the input unit. When the document protecting program 311 obtains the document, the document protecting program 311 requires the distributor to set the security attribute. For example, the document protecting program 311 displays a message at the display unit of the distributor terminal 301 and requires the distributor of setting the security attribute. FIG. 36 is a diagram showing a screen example for requiring of setting the security attribute according to the third embodiment of the present invention. In FIG. 36, the distributor can select from pull-down menus to set a document category (a technical document, a human resource, or a like) and a sensitivity as a secret level (for example, “Top Secret”, “Confidential”, “Internal Use Only”, “Open”, or a like). In the screen shown in FIG. 36, the distributor can indicate the document to secure.

When the distributor sets the security attribute to the document by using the input unit of the distributor terminal 301, the document protecting program 311 obtains the security attribute.

When the document protecting program 311 obtains the security attribute, the document protecting program 311 generates the document ID (Document ID) identical for each document and the encryption key (Key) used to encrypt and decrypt the document, associates the document ID and Key with the secret attribute, and sends to the access control server 304 to register to the security attribute database 343.

Also, the document protecting program 311 provides the document ID to the document which is encrypted by using the encryption key and then generates the secured document 13.

The distributor provides the secured document 13 generated by the document protecting program 311 to the user.

In a case in that the user attempts to print out the document, the secured document 13 is implemented to the user terminal 302. For example, the user terminal 302 may read out the secured document 13 stored in the information recording medium set in the external storage unit. Alternatively, in a case in that the user terminal 302 connects with the distributor terminal 301 through a network, the user terminal 302 may obtain the secured document 13 through the network.

When the user indicates the document printing program 321 to print out the document by using the input unit of the user terminal 302, the document printing program 321 requires the user to input the password necessary to authenticate the user. For example, the document printing program 321 displays a message at the display unit of the user terminal 302 to require the user to input the password. A similar screen shown in FIG. 19 in the second embodiment is displayed at the user terminal 302. The screen allows the user to input the user name and the password by using a keyboard or a like.

The document printing program 321 requires the access control server 304 to authenticate the user by sending the user name and the password.

The access control server 304 authenticates the user by using the user name and the password received from the document printing program 321 and then specifies the user.

When the access control server 304 specifies the user, the access control server 304 refers to the security attribute database 343. After that, the access control server 304 refers to the ACL corresponding to the security attribute set to the secured document 13 in the ACLs recorded in the ACL database 342. And the access control server 304 determines whether or not the user is authorized to print out the document, and obtains the print requirement when the user is authorized to print out the document.

When it is determined that the user is authorized to print out the document, the access control server 304 sends permission information showing that the user is allowed to print out the document, the encryption key to decrypt the secured document 13, and an the print requirement when the user prints out the document, to the document printing program 321 through the user terminal 302.

When the document printing program 321 receives the permission information, the encryption key, and the print requirement from the access control server 304, the document printing program 321 decrypts the secured document 13 by using the encryption key and then restores the document.

Then, the document printing program 321 controls the printer 303 to conduct the printing process so as to satisfy the print requirement. For example, in a case in that the BDP is set to the document as the print requirement, the printer 303 prints out contents of the document while printing out a background image.

As described above, when the document is printed out, it is possible to enforce the print requirement corresponding to the security attribute that is set beforehand.

In a case in that the user is not aware of the print requirement or only a special printer can process the print requirement, information showing that may be provided to the user before executing the printing process. Similar to the first embodiment, the confirmation screen shown in FIG. 8 displayed at the display unit of the user terminal 302. In the confirmation screen the print requirements and available printers are displayed and the user can select one of the available printers to use.

Next, operations of the document protecting program 311 and the access control server 304 when the document is secured, and operations of the document printing program 321 and the access control server 304 when the secured document is restored and printed out will be described in detail.

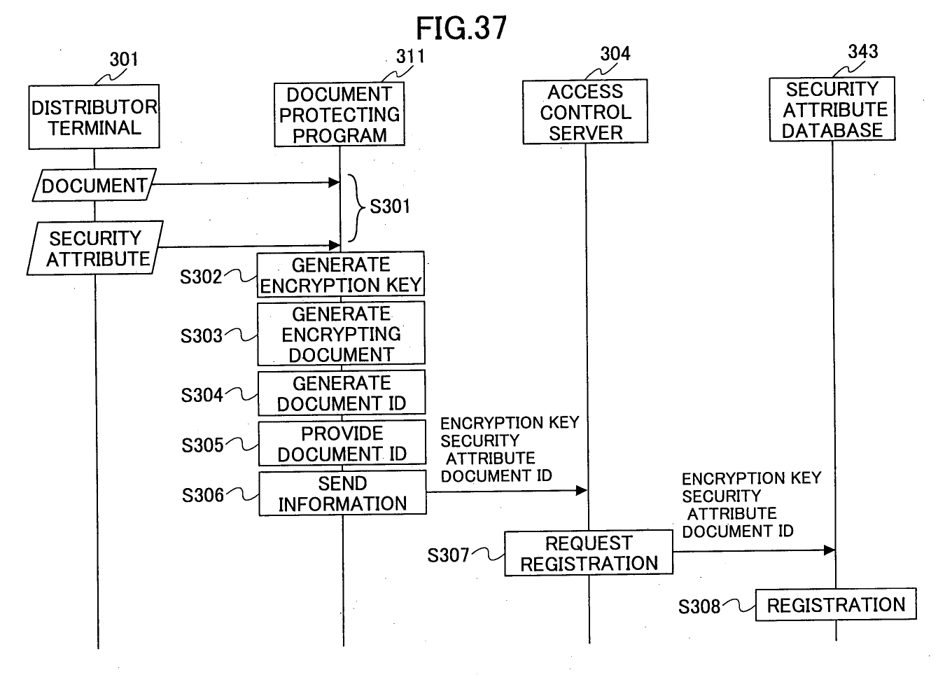

FIG. 37 is a diagram showing operations when the document protecting program generates the secured document according to the third embodiment of the present invention. When the document protecting program 311 obtains the document and the secret attribute by the input operation of the distributor at the input unit of the distributor terminal 301 (step S301), the document protecting program 311 encrypts the document and generates the encryption key to encrypt and decrypt (step S302). Then, the document protecting program 311 encrypts the document by using the encryption key and generates an encrypted document (step S303).

Moreover, the document protecting program 311 generates a document ID identical for each document (step S304), and generates the secured document 13 by attaching the document ID with the encrypted document (step S305).

After the secured document 13 is generated, the document protecting program 311 sends the encryption key, the security attribute, and the document ID to the access control server 304 (step S306), and then requires the access control server 304 to register the encryption key, the security attribute, and the document ID (step S307).

When the access control server 304 receives the encryption key, the security attribute, and the document ID from the document protecting program 311, the access control server 304 associates the encryption key, the security attribute, and the document ID as one record and records and maintains the record in the security attribute database 343 (step S308).

The operations will be further described with reference to FIG. 32 and FIG. 35 in detail.

First, in FIG. 32, the encrypting part 311a of the document protecting program 311 encrypts the document received from the distributor by using the encryption key generated by the encryption key obtaining part 311b, and then sends an encrypted document to the attribute providing part 311c.

The attribute providing part 311c generates the document ID, provides the document ID to the encrypted document received from the encrypting part 311a, and outputs the secured document 13.

The attribute registering part 311d receives the security attribute from the distributor and also receives the encryption key from the encryption key obtaining part 311b and the document ID from the attribute providing part 311c. Then, the attribute registering part 311d sends the security attribute, the encryption key, and the document ID to the access control server 304 to register.

Next, in FIG. 35, the attribute DB registering part 304a of the access control server 304 registers the security attribute, the encryption key, and the document ID to the security attribute database 343.

In the third embodiment, the document protecting program 311 generates the document ID and the encryption key. Alternatively, the access control server 304 or another server (not shown) may generate the document ID and the encryption key.

If the distributor terminal 301 is not connected to the access control server 304 by a dedicated line but connected through a network and if it is concerned that the encryption key is intercepted while being sent to the access control server 304, a communication should be conducted by using a SSL (Secure Socket Layer).

A protocol for the document protecting program 311 to communicate with the access control server 304 can be any protocol. For example, a distribute object environment can be installed and information may be sent and received on a bases of Java® RMI (Remote Method invocation) and a SOAP (Simple Object Access Protocol). In this case, for example, the access control server 304 may implement a method such as “register(String docId, byte[ ] key, byte[ ] acl)”. If the SOAP is implemented, a message is exchanged by the SOAP on an HTTPS. If the RMI is implemented, by executing the RMI using a SocketFactory of an SSL base, the security on the network can be maintained.

Next, the operation in a case in that the document printing program 321 prints out the secured document 13 will be described.

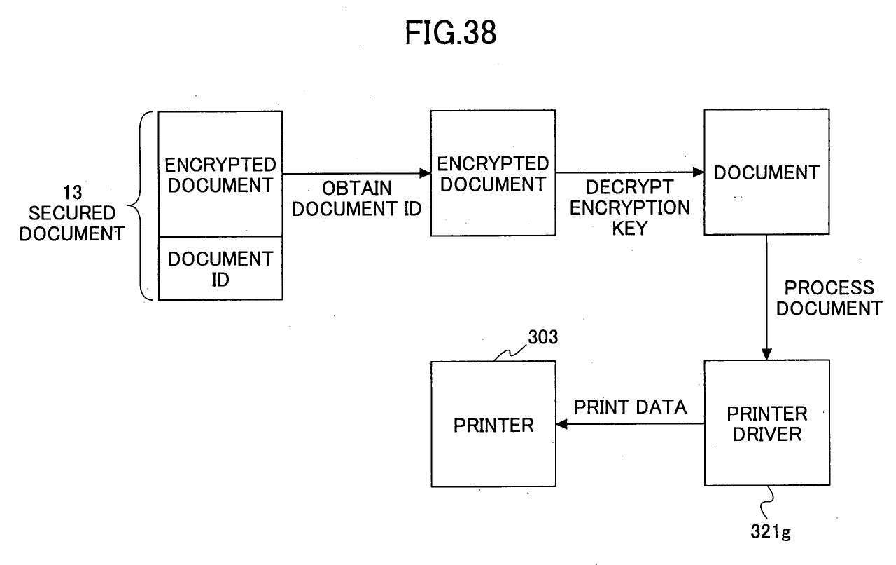

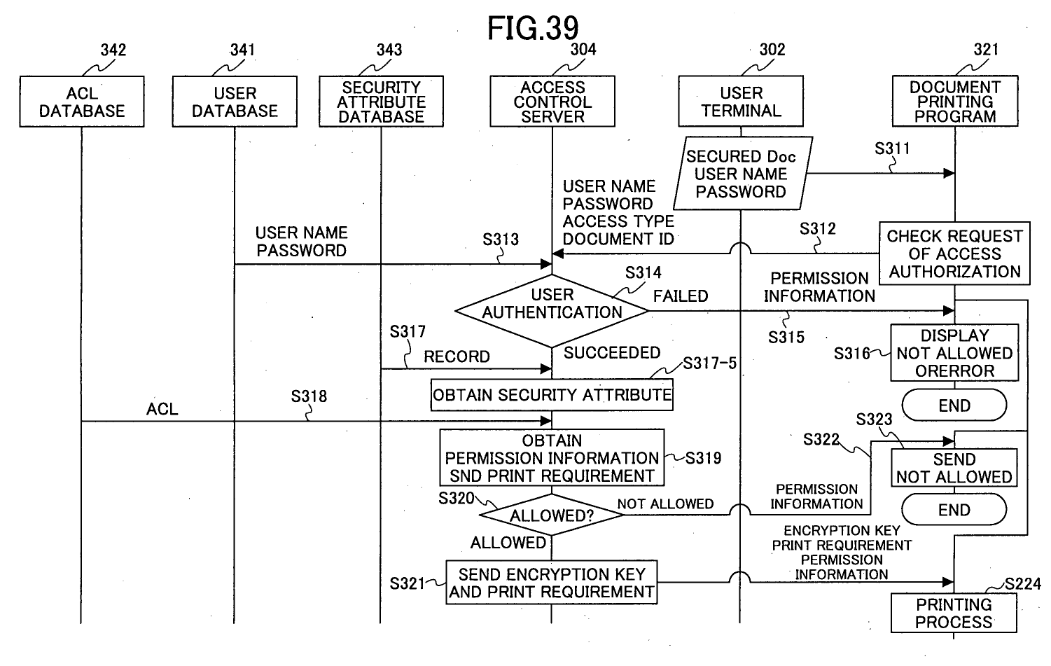

FIG. 38 is a diagram showing operations of the document printing program according to the third embodiment of the present invention. FIG. 39 is a diagram showing the operations of the document printing program and the access control server according to the third embodiment of the present invention.

When the document printing program 321 obtains the user name and password by the input operation of the user at the input unit of the user terminal 302, the document printing program 321 obtains the document ID attached with the secured document 13 (step S311).

Subsequently, the document printing program 321 sends the user name, the password, the document ID, the access type and requests the access control server 304 to check whether or not the user has the access authorization (step S312). The access type is information showing a process requested by the user. In this case, the access type shows “print” since the user attempts to print out the secured document. Similar to the second embodiment, as shown in FIG. 22, the SOAP 291 including the user name (userId), the document ID (docId), and the access type (accessType) is sent to enquire whether or not the access is allowed to the user. And the SOAP 292 showing a result (isAllowedReponse) is received. The result shows that the user is allowed (“allowed” indicates “true”) and the result includes a requirement (“requirement”).

When the access control server 304 receives the user name, the password, the document ID, and the access type, the access control server 304 refers to information registered in the user database 341 (step S313) and conducts the user authentication (step S314). That is to say, the access control server 304 refers to the information registered in the user database 341 and determines whether or not the combination of the user name and the password included in the information obtained from the document printing program 321 is registered in the user database 341.

When the user authentication is failed (that is to say, the combination of the user name and the password included in the information received from the document printing program 321 is registered), the access control server 304 sends the permission information (information showing whether or not the process requested by the user is allowed) as “NOT ALLOWED” to the user terminal 302, and sends to the document printing program 321 (step S315). In this case, the permission information showing “ERROR” may be sent to the document printing program 321. The document printing program 311 displays “NOT ALLOWED” or “ERROR” at the display unit of the user terminal 302 (step S316).

On the other hand, when the user authentication is succeeded, the access control server 304 reads out a record concerning the document ID included in the information obtained from the document printing program 321 from records stored in the security attribute database 343 (step S317).

The access control server 304 obtains the security attribute included in the record read out from the security attribute database 343 (step S317-5). Subsequently, the access control server 304 obtains reads out the ACL corresponding to the security attributed obtained from the record from the ACLs registered in the ACL database 342 (step S318). Moreover, the access control server 304 obtains the permission information and the print requirement from the ACL based on the user name and the access type obtained from the document printing program 321 (step S319).

That is to say, the access control server 304 obtains the permission information and the print requirement that are set beforehand, based on the user name and the access type. Then, the access control server 304 determines whether or not the user is allowed (step S320).

When the permission information obtained from the ACL shows “ALLOWED”, the access control server 304 sends the encryption key and the print requirement stored in the record with the permission information to the user terminal 302 to provide to the document printing program 321 (step S321).

On the other hand, when the permission information obtained from the ACL shows “NOT ALLOWED”, the access control server 304 sends only the permission information to the user terminal 302 to provide to the document printing program 321 (step S322).

When the document printing program 321 receives the permission information received from the access control server 304, the document printing program 321 refers to the permission information. When the permission information shows “NOT ALLOWED”, the document printing program 321 displays a message at the display unit of the user terminal 302 to notify the user that the process requested by the user can not be conducted (step S323).

On the other hand, when the permission information shows “ALLOWED”, the document printing program 321 decrypts the encrypted document being a portion of the secured document 13 so as to restore the document.

Next, the document printing program 321 sets the printer driver so as to satisfy the print requirement set to the document and controls the printer 303 to conduct the printing process with respect to the document (step S324). For example, if the PAC is indicated as the print requirement, the document printing program 321 sets the private access mode.

If necessary, the document printing program 321 displays a message at the display unit of the user terminal 302 to require the user to set print parameters.

If the printer 303 can not conduct the printing process so as to satisfy the print requirement, that is, if the printer 303 does not implement a function satisfying the print requirement set to the ACL, the document printing program 321 displays a message at the display unit of the user terminal 302 to inform the user, and terminates the operation without the printing process.

The operations will be described with reference to FIG. 33 through FIG. 35 in detail.

First, in FIG. 33, the decryption key obtaining part 321b of the document printing program 321 enquires the access control server 304 to confirm the access authorization.

In FIG. 35, when the access control server 304 receives an enquiry of confirming the access authorization, the user authenticating part 304b conducts the user authentication by referring to the user database 341, and sends an authentication result to the document printing program 321. When the user authentication is succeeded, the access authorization confirming part 304c obtains the permission information and the decryption key by referring to the security attribute database 343 and the ACL database 342. Then, the print requirement obtaining/sending part 304d obtains the print requirement from the ACL database 342 and sends to the document printing program 321. In FIG. 35, the authentication result is sent to the document printing program 321 and then is received from the document printing program 321 again. Alternatively, this process may be conducted at one time. Also, the permission information, the decryption key, and the print requirement are sent to the document printing program 321, respectively. Alternatively, the decryption key, and the print requirement can be simultaneously sent to the document printing program 321.

In FIG. 33, when the decryption key obtaining part 321b confirms the access authorization, the decryption key obtaining part 321b obtains the decryption key from the access control server 304, and sends to the decrypting part 321a. The print requirement obtaining part 321c obtains the print requirement from the access control server 304, and provides to the print processing part 321d.

The decrypting part 321a decrypts the secured document 13 by using the decryption key obtained from the decryption key obtaining part 321b, obtains the document, and then provides the document to the print processing part 321d.

Next, in FIG. 34, the requirement processing part 321e of the print processing part 321d conducts a plurality of processes in response to contents of the print requirement. That is, if the document itself is required to be processed as the BDP, the EBC, and the SLS are processed, the document processing part 321f processes the document by the process information and sends a processed document to the printer driver 321g. Then, the printer driver 321g provides print data to the printer 303 and the printer 303 prints out the document. In a case in that a special setting is required to the printer driver 321g such as the PAC, a print setting is conducted to the printer driver 321g. In a case in that a warning message to the user is required, the warning message is provided to the warning displaying part 321h to display at the display unit. Also, in a case in that a print log is required, log information is sent to the log recording part 321i and then log data is registered to a remote server or a like.

By the above described operations, it is possible to set the access authorization and the print requirement for each user. Moreover, as described above, in a system configuration in that the access authorization with respect to the document is determined at a server side, contents of the ACL registered in the ACL database 342 can be updated by the input operation at the distributor terminal 301 or the access control server 304. In this case, after the secured document 13 is distributed, the print requirement can be updated.

For example, it is possible to set the access authorization with respect to the secured document 13, which has been already distributed, to a new user, and it is possible to add the print requirement to a specific user.

If a person, who knows that the document protecting/printing system 3001 according to the second embodiment secures the document by the above described technology, may execute a program behaving like the document printing program 321 at a computer terminal and may illegally obtain the encryption key. Then, the person can decrypt the secured document 13. In this case, the print requirement set as the ACL will not be enforced, and the secured document 13 can be unlimitedly printed out.

Therefore, instead of simply encrypting the document by using only the encryption key, it is preferred to encrypt the document by using a combination of the secret key embedded in the document protecting program 311 and the encryption key. In this case, by embedding the same secret key in the document printing program 321, it is possible to limit only the document printing program 321 that enforces the print requirement set by the distributor, to decrypt and print out the secured document 13.

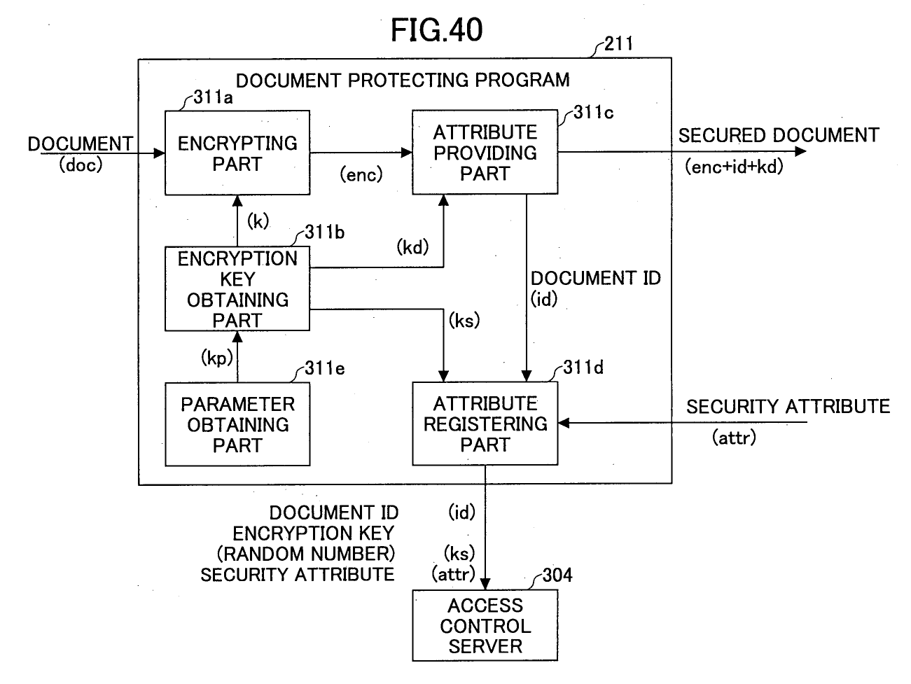

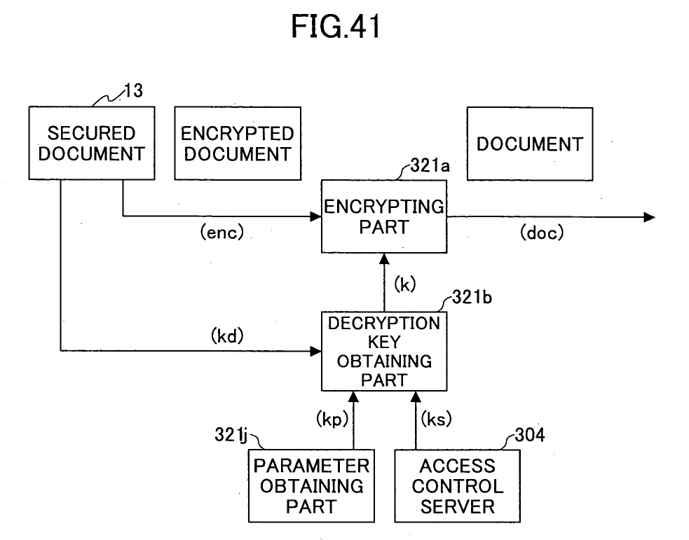

A type in a case of embedding the secret key in the document protecting program 311 will be described with reference to FIG. 40 and FIG. 41. FIG. 40 is a diagram showing a configuration example of the document protecting program according to the third embodiment of the present invention. FIG. 41 is a diagram showing a portion related to a decryption in the configuration example of the document printing program according to the third embodiment of the present invention. In FIG. 40 and FIG. 41, not only the secret key is simply embedded but also a random number is installed to guard more against an illegal access.

In FIG. 40, the document protecting program 311 includes an encrypting part 311a, an encryption key obtaining part 311b, an attribute providing part 311c, an attribute registering part 311d, and a parameter obtaining part 311e.

In operations, the parameter obtaining part 311e generates a parameter (kp), and provides to the encryption key obtaining part 311b. It should be noted that the parameter (kp) should be maintained within the document protecting program 311 and be generated when required.

After the encryption key obtaining part 311b receives the parameter (kp) from the parameter obtaining part 311e, the encryption key obtaining part 311b generates two random numbers (kd) and (ks), and generates the encryption key (k) by calculating k=H{ks, kp, kd} or k=D{kd, D[ks, kp]}. subsequently, the encryption key obtaining part 311b provides the encryption key (k) to the encrypting part 311a, the random number (kd) to the attribute providing part 311c, and the random number (ks) to the attribute registering part 311d, respectively. H{data 1, data 2, . . . } denotes to calculate the hash values of the data 1, the data 2, . . . , and D{data, key} denotes to decrypt the data by the key.

The encrypting part 311a encrypts the document (doc) received form the distributor by using the encryption key (k) obtained from the encryption key obtaining part 311b, and provides the encrypted document (enc) to the attribute providing part 311c. This expression is shown as enc=E{doc, k}. E{data, key} denotes to encrypt the data by the key.

Next, the attribute providing part 311c generates the document ID (id), provides the document ID (id) and the random number (kd) provided from the encryption key obtaining part 311b to the encrypted document, and then outputs the secured document (enc+id+kd). In addition, the attribute providing part 311c provides the document ID (id) to the attribute registering part 311d.

The attribute registering part 311d sends the document ID (id) received from the attribute providing part 311c, the random number (ks) received from the encryption key obtaining part 311b, and the security attribute (attr) obtained from the distributor to the access control server 304 to register.

Referring to FIG. 41, in order to decrypt, the decryption key obtaining part 321b obtains the random number (kd) from the secured document 13, and a parameter (kp), that is maintained in the document printing program 321 or generated in response to a request, from the parameter obtaining part 321j. The decryption key obtaining part further obtains the random number (ks) from the access control server 304, and obtains the decryption key (encryption key) (k) by calculating k=H{ks, kp, kd} or k=D{kd, D {ks, kp}} similar to the encryption.

Then, the decrypting part 321a decrypts the encrypted document (enc) by the decryption key (k) and then obtains the document (doc).

FIG. 40 and FIG. 41 show a method for generating the encryption key (decryption key) (k) based the random number (ks) registered in the access control server 304, the random number (kd) in the secured document 13, and the parameter (kp) from the document protecting program 311 or the document printing program 311. By the method, even if the access control server 304 is illegally accessed by a viper as a user and the random number (ks) is known to the viper, the secured document 13 can not be decrypted without the random number (kd) and the parameter (kp). However, in a circumstance in that the access control server 304 is sufficiently guarded not to be illegally accessed, the random number (ks) can be used as the encryption key (decryption key) (k) itself.

On the other hand, in the third embodiment, the print requirement is stored in only the access control server 304. Alternatively, the print requirement can be included in the secured document 13. For example, if the print requirement is always indicated to the document regardless of the user, the print requirement can be included in the secured document 13.

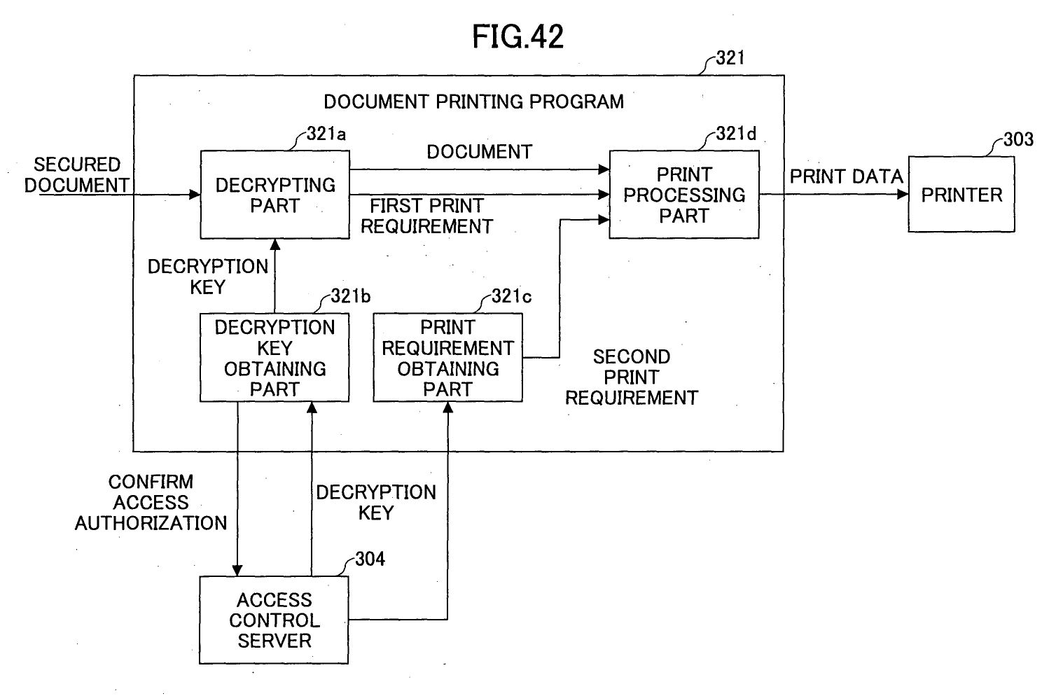

FIG. 42 is a diagram showing a configuration example of the document printing program in a case in that the entire print requirements are separated into a first print requirement to include in the secured document and a second print requirement to store in the access control server, according to the second embodiment of the present invention. In FIG. 42, the print requirement obtaining part 321c obtains the second print requirement from the access control server 304 and the decrypting part 221a obtains the first print requirement from the secured document 13. Accordingly, the print processing part 321d conducts the printing process based on the first print requirement and the second print requirement. The other operations are conducted similar to the operations of the document printing program 321 shown in FIG. 33.

Moreover, in the second embodiment, the document printing program 321 only conducts the process related to printing the document. In addition, the document printing program 321 may provides contents of the document to the user, and may implement a function of editing the document. For example, the document printing program 321 can realize a function of displaying, editing, and printing a PDA file (portable document format) as a plug-in of Adobe acrobat®.

As described above, in the document protecting/printing system 3001 according to the third embodiment of the present invention, it is possible to enforce the print requirement set as the ACL corresponding to the security attribute when the document is printed out.

### Fourth Embodiment

In the third embodiment according to the present invention, the document protecting/printing system 3001, which protects the document in accordance with the security policy of the organization which the distributor belongs to, is described.

However, in the document protecting/printing system 3001, a large number of ACLS are registered for each lower level organization beforehand in a case in that the organization which the distributor belongs to is a large scale organization. For example, such as an “ACL for technical documents of the first design room”, an “ACL for contract documents of the first design room”, an “ACL for technical documents of the first design room”, or an “ACL for contract documents of the first design room”, various ACLs should be defined beforehand to include all users.

In general, since the security policy regulated in the organization is a global rule, the security policy does not concretely regulate permission to access the document for each user.

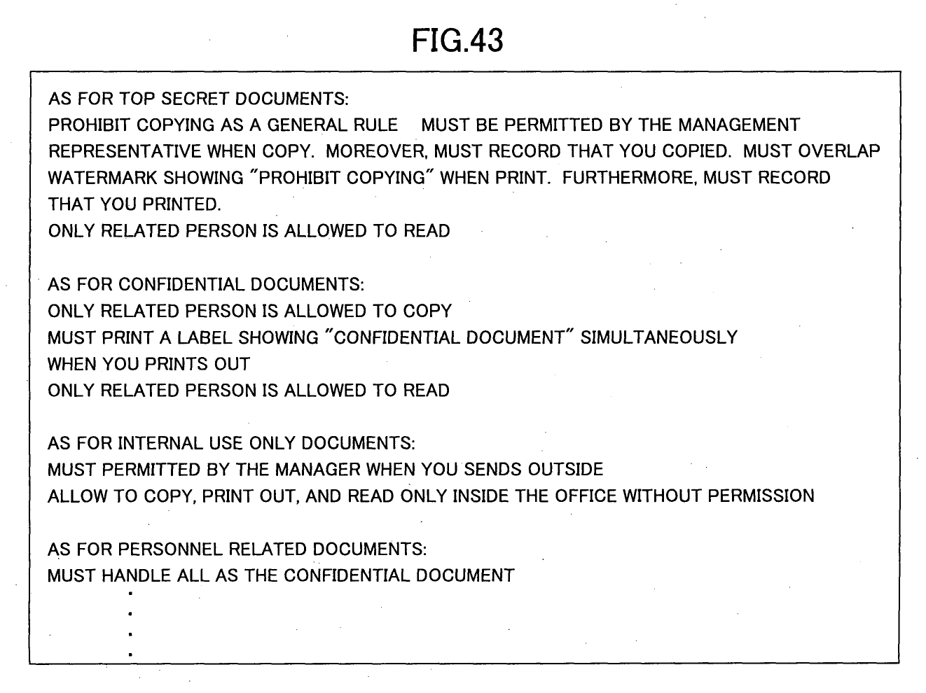

FIG. 43 is a diagram showing an example of the security policy according to a fourth embodiment of the present invention. As shown in FIG. 43, the security policy in the organization defines a security level (sensitivity) and a category with respect to the document and then defines a level and category of the user who is to be allowed to access the document, and a print requirement.

For example, only a manager of a human resource department is allowed to print out the document of a human resource in that the security level is a top secret, in a condition of conducting the background dot pattern.

For example, in the fourth embodiment of the present invention, a document protecting/printing system, which applies description electronically describing the security policy itself in the organization to a document protection, will be described.

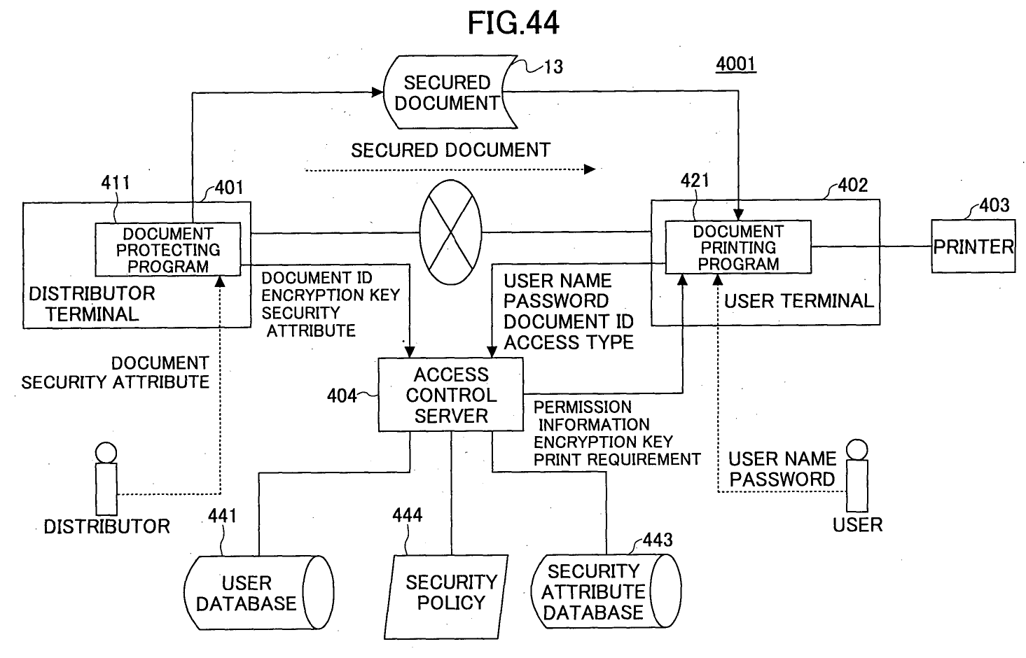

FIG. 44 is a diagram showing a document protecting/printing system according to the fourth embodiment of the present invention.

The document protecting/printing system 4001 includes a distributor terminal 401, a user terminal 402, a printer 403, and an access control server 404.

Each of the distributor terminal 401 and the user terminal 402 can be applied to a computer terminal including a display unit (for example, an LCD (Liquid Crystal Printer), an input unit (for example, a keyboard), an external storage unit (for example, an FDD (Floppy Disk Device), an HDD (Hard Disk Device), or a like). It should be noted that the distributor terminal 401 implements a document protecting program 411 and the user terminal 402 implements a document printing program 421.

The document protecting program 11 is a program to set a print requirement to a document file (hereinafter, simply called a document) in response to an input operation by a distributor using the distributor terminal 01, encrypt the document using an encryption algorithm (for example, an RC4, Triple DES, IDEA), and generate a secured document 13. A configuration of the document protecting program 411 is the same as the configuration of the document protecting program 311 in the third embodiment shown in FIG. 32.

Referring to FIG. 44, the document printing program 421 is a program to decrypt the secured document 13 in response to an input operation by a user using the user terminal 402, and to indicate the printer 403 to execute a process in accordance with the print requirement. A configuration of the document printing program 421 is the same as the configuration of the document printing program 321 in the third embodiment shown in FIG. 33 and FIG. 34.

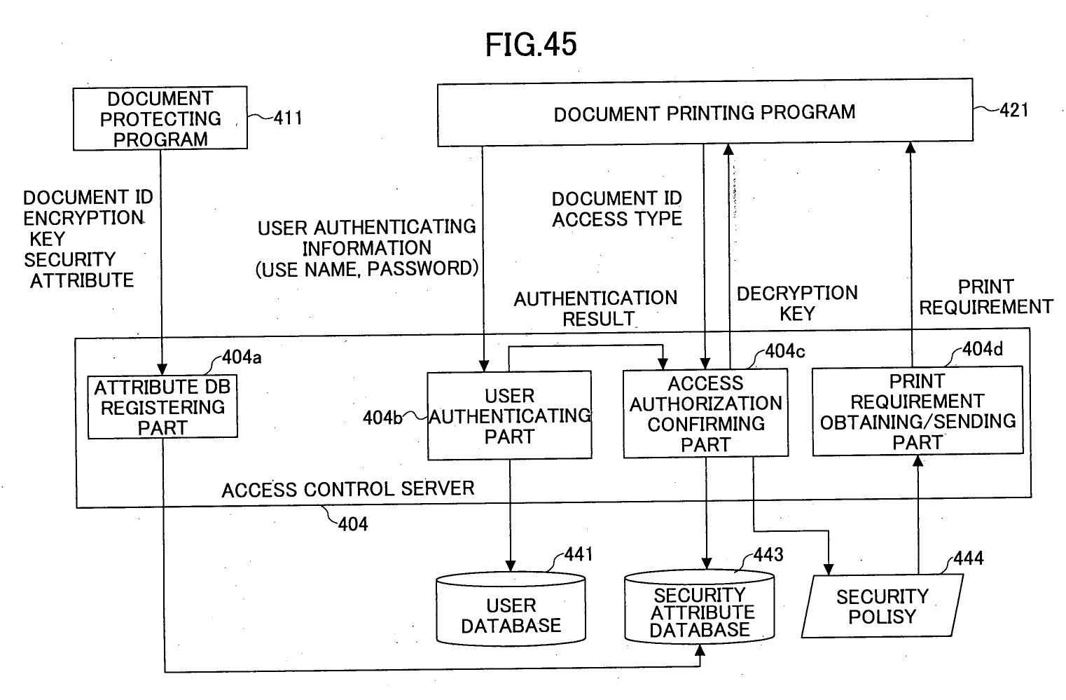

When the user attempts to access the document (for example, to print the document), the access control server 404 refers to the security policy 444 stored therein in response to a request from the document printing program 421, determines whether or not the user is authorized to access the document, and obtains the process requirement. FIG. 45 is a diagram showing a configuration example of the access control server according to the fourth embodiment of the present invention. In FIG. 44, the access control server 404 includes an attribute DB registering part 404a, a user authenticating part 404b, an access authorization confirming part 404c, and a print requirement obtaining/sending part 404d. Each function will be described later.

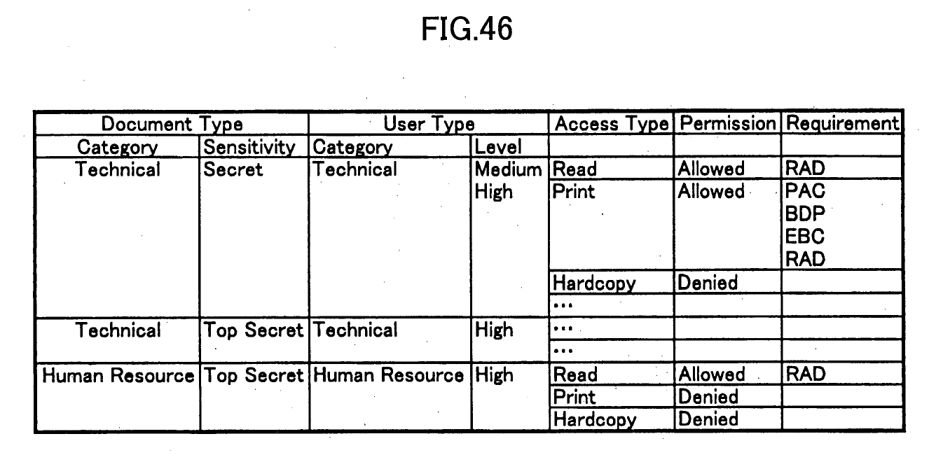

FIG. 46 is a diagram showing an example of the security policy registered in the access control server according to the fourth embodiment of the present invention.

For example, in the security policy 444 shown in FIG. 46, as for the document in that the category is “Technical” and the security level is “Secret”, a user in that the category is “Technical” and the level is “Medium” or “High” is allowed to read with the RAD as a requirement and to print out with the PAC, the BDP, the EBC, and RAD as requirements, but not allowed to hardcopy.

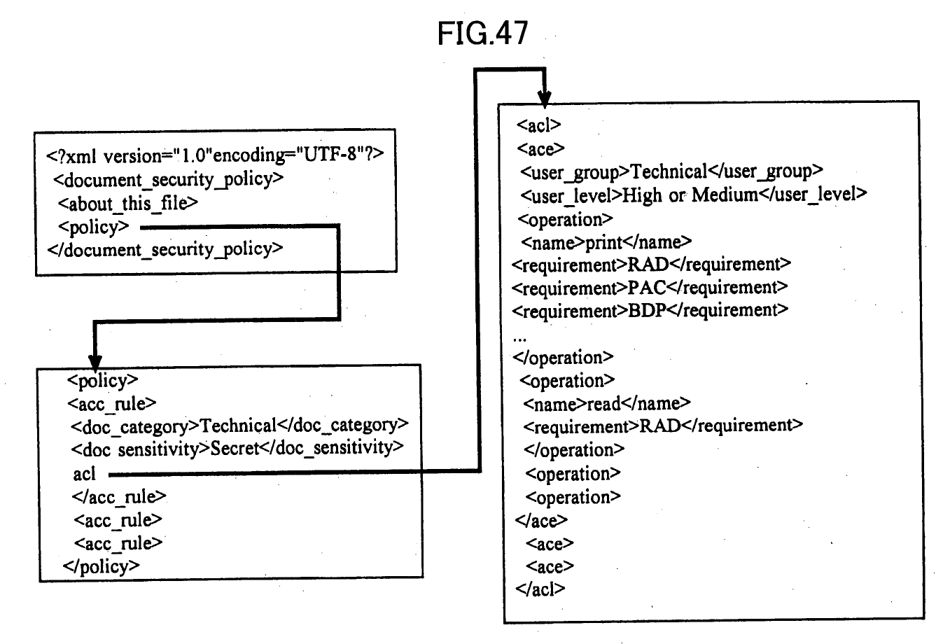

In the access control server 404, the security policy 444 can be recorded and maintained in any data format. The security policy 444 can be easily described in an XML (extensible Markup language) as shown in FIG. 47.

The access control server 404 is connected to a user database 441 for storing information (a combination of user name and password) for authenticating each user and a security attribute database 443 in which information showing what security attribute is set to each secured document 13 and an encryption key for encrypting and decrypting the secured document 13 are associated with together and registered.

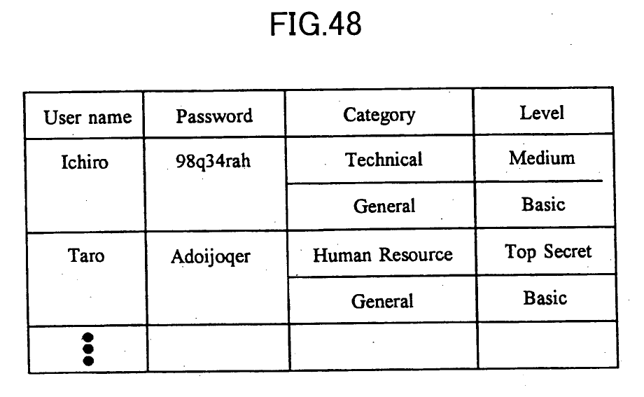

FIG. 48 is a diagram showing an example of information registered in the user database according to fourth embodiment of the present invention.

In FIG. 48, the category and the level are managed as a different attribute for each user. Alternatively, in a case in that the user is managed by using a user management of Windows® Domain, for example, “Techinical_Medium” is generated as a group account, and a user named “Ichiro” may be belonged to that group. By setting a naming rule of the group as described above, the category and the level can be managed as a single attribute.

Operations of the document protecting/printing system 4001 will be described. First, an operation of the entire document protecting/printing system 4001 will be described.

The distributor stores the document to the distributor terminal 401. For example, the distributor may create the document by operating the input unit or has the distributor terminal 401 read the document from an information recording medium by operating the external recording unit.

In case of securing the document, the distributor provides the document to the document protecting program 411 by operating the input unit. When the document protecting program 411 obtains the document, the document protecting program 411 requires the distributor to set the security attribute. For example, the document protecting program 411 displays a message at the display unit of the distributor terminal 401 and requires the distributor of setting the security attribute. A screen for requiring of setting the security attribute is the same as the screen shown in FIG. 36 in the third embodiment. It should be noted that the security attribute is information showing which security attribute registered in the securing attribute database 443 corresponds to the document to be secured.

When the distributor sets the security attribute to the document by using the input unit of the distributor terminal 401, the document protecting program 411 obtains the security attribute.

When the document protecting program 411 obtains the security attribute, the document protecting program 411 generates the document ID (Document ID) identical for each document and the encryption key (Key) used to encrypt and decrypt the document, associates the document ID and Key with the secret attribute, and sends and register to the access control server 404.

Also, the document protecting program 411 provides the document ID to the document which is encrypted by using the encryption key and then generates the secured document 13.

The distributor provides the secured document 13 generated by the document protecting program 411 to the user.

In a case in that the user attempts to print out the document, the secured document 13 is implemented to the user terminal 402. For example, the user terminal 402 may read out the secured document 13 stored in the information recording medium set in the external storage unit. Alternatively, in a case in that the user terminal 402 connects with the distributor terminal 401 through a network, the user terminal 402 may obtain the secured document 13 through the network.

When the user indicates the document printing program 421 to print out the document by using the input unit of the user terminal 402, the document printing program 421 requires the user to input the password necessary to authenticate the user. For example, the document printing program 421 displays a message at the display unit of the user terminal 402 to require the user to input the password. A similar screen shown in FIG. 19 in the second embodiment is displayed at the user terminal 402. The screen allows the user to input the user name and the password by using a keyboard or a like.

The document printing program 421 requires the access control server 404 to authenticate the user by sending the user name and the password.

The access control server 404 authenticates the user by using the user name and the password received from the document printing program 421 and then specifies the user.

When the access control server 404 specifies the user, the access control server 404 refers to the security attribute database 443.

The access control service 404 determines whether or not the user is authorized to print out the document, and obtains the print requirement that is set for the user to print out the document, based on information showing the level of the user obtained from the user database 441 and the security attribute set to the document.

When it is determined that the user is authorized to print out the document, the access control server 404 sends permission information showing that the user is allowed to print out the document, the encryption key to decrypt the secured document 13, and an the print requirement when the user prints out the document, to document printing program 421 the through the user terminal 402.

When the document printing program 421 receives the permission information, the encryption key, and the print requirement from the access control server 404, the document printing program 421 decrypts the secured document by using the encryption key and then restores the document.

Then, the document printing program 421 controls the printer 403 to conduct the printing process so as to satisfy the print requirement. For example, in a case in that the BDP is set to the document as the print requirement, the printer 403 prints out contents of the document while printing out a background image.

As described above, when the document is printed out, it is possible to enforce the print requirement corresponding to the security attribute that is set beforehand.

Next, operations of the document protecting program 411 and the access control server 404 when the document is secured, and operations of the document printing program 421 and the access control server 404 when the secured document is restored and printed out will be described in detail.

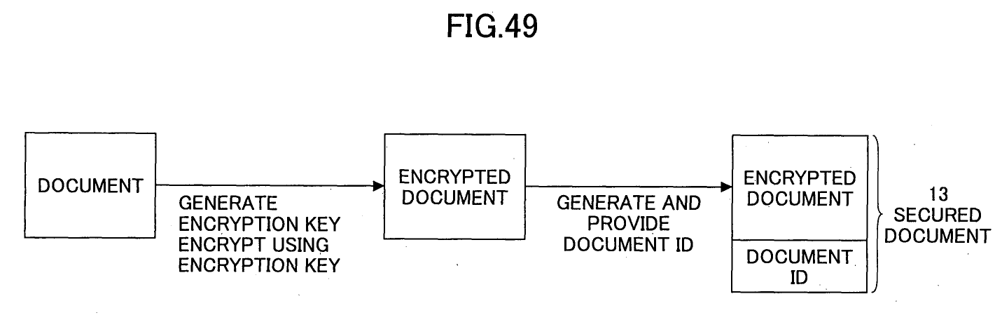

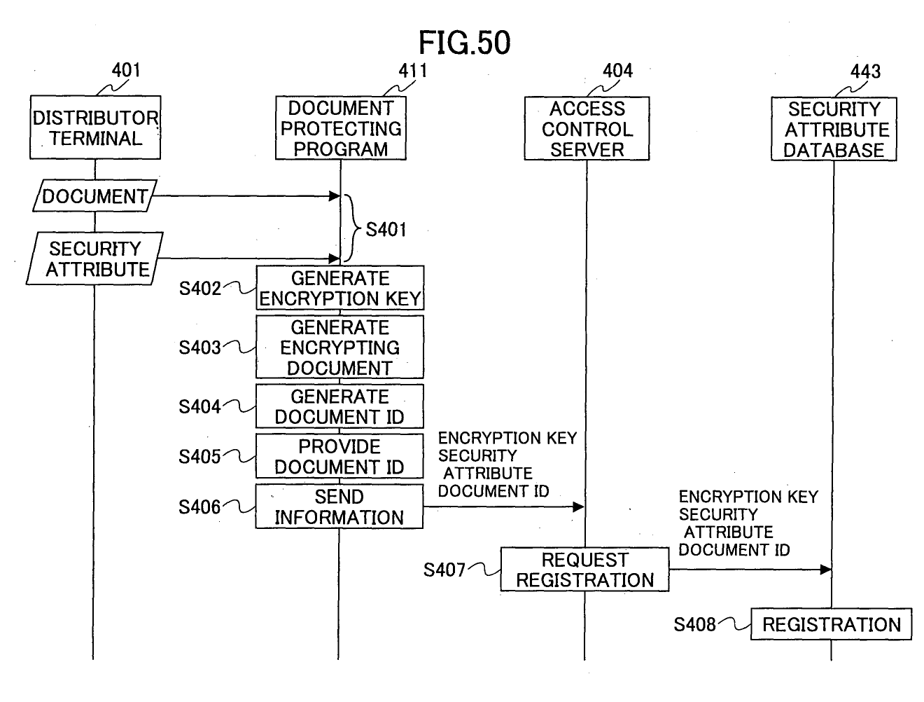

FIG. 49 is a diagram showing a process when the document protecting program generates the secured document, according to the fourth embodiment of the present invention. FIG. 50 is a diagram showing operations of the document protecting program and the access control server according to the fourth embodiment of the present invention.

When the document protecting program 411 obtains the document and the secret attribute by the input operation of the distributor at the input unit of the distributor terminal 401 (step S401), the document protecting program 411 encrypts the document and generates the encryption key to encrypt and decrypt (step S402). Then, the document protecting program 411 encrypts the document by using the encryption key and generates an encrypted document (step S403).

Moreover, the document protecting program 411 generates a document ID identical for each document (step S404), and generates the secured document 13 by attaching the document ID with the encrypted document (step S405).

After the secured document is generated, the document protecting program 411 sends the encryption key, the security attribute, and the document ID to the access control server 404 (step S406), and then requires the access control server 404 to register the encryption key, the security attribute, and the document ID (step S407).

When the access control server 404 receives the encryption key, the security attribute, and the document ID from the document protecting program 411, the access control server 404 associates the encryption key, the security attribute, and the document ID as one record and record and maintain in the security attribute database 443 (step S408). In detail, the attribute DB registering part 404a of the access control server 404 registers the record to the security attribute database 443.

In the fourth embodiment, the document protecting program 411 generates the document ID and attaches to the encrypted document. In a case in that the encrypted document is generated by using a hash algorithm such as an SHA-1, a hash value may be attached to the encrypted document, instead of the document ID. In this case, the document ID is not required to attach to the secured document. When the document ID is needed, the hash valued is calculated again.

Moreover, in the fourth embodiment, the document protecting program 411 generates the document ID and the encryption key. Alternatively, the document ID and the encryption key may be generated by the access control server 404 or another server (not shown).

If the distributor terminal 401 is not connected to the access control server 404 by a dedicated line but connected through a network and if it is concerned that the encryption key is intercepted while being sent to the access control server 404, a communication should be conducted by using a SSL (Secure Socket Layer).

A protocol for the document protecting program 411 to communicate with the access control server 404 can be any protocol. For example, a distribute object environment can be installed and information may be sent and received on a bases of Java® RMI (Remote Method invocation) and a SOAP (Simple Object Access Protocol). In this case, for example, the access control server 404 may implement a method such as “register(String docId, byte[ ] key, byte[ ] acl)”. If the SOAP is implemented, a message is exchanged by the SOAP on an HTTPS. If the RMI is implemented, by executing the RMI using a SocketFactory of an SSL base, the security on the network can be maintained.

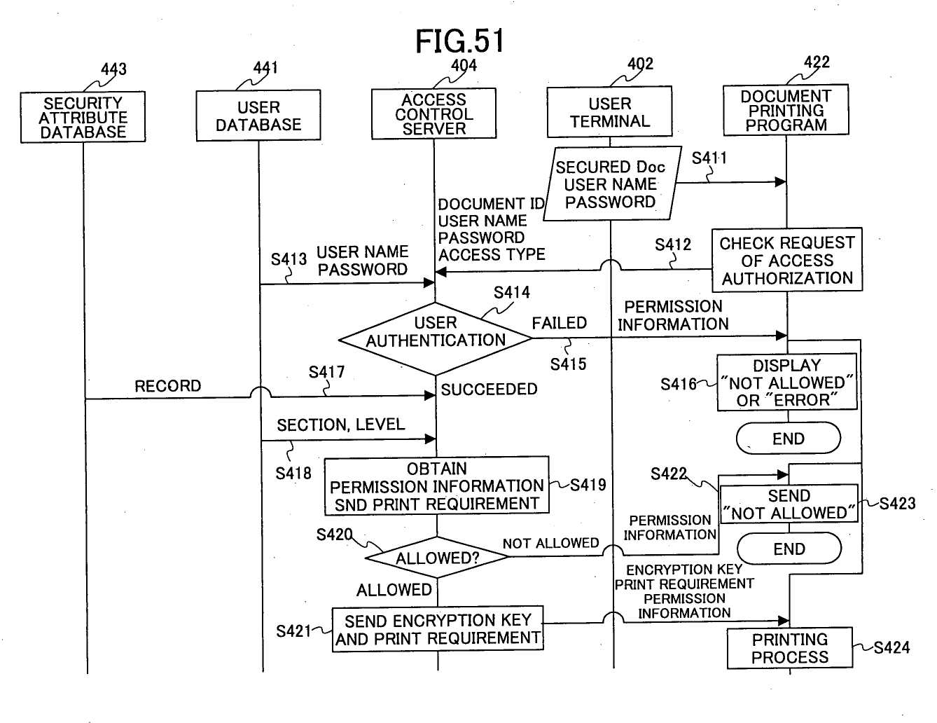

Next, the operation in a case in that the document printing program 421 prints out the secured document 13 will be described. FIG. 51 is a diagram showing the operations of the document printing program and the access control server when the secure document is printed out, according to the fourth embodiment of the present invention.

When the document printing program 421 obtains the user name and password by the input operation of the user at the input unit of the user terminal 402, the document printing program 421 obtains the document ID attached with the secured document (step S411).

Subsequently, the document printing program 421 sends the user name, the password, the document ID, the access type and requests the access control server 404 to check whether or not the user has the access authorization (step S412).

When the access control server 404 receives the user name, the password, the document ID, and the access type, the access control server 404 refers to information registered in the user database 441 (step S413) and conducts the user authentication (step S414).

That is to say, the access control server 404 refers to the information registered in the user database 441 and determines whether or not the combination of the user name and the password included in the information obtained from the document printing program 421 is registered in the user database 441.

When the user authentication is failed (that is to say, the combination of the user name and the password included in the information received from the document printing program 421 is registered), the access control server 404 sends the permission information as “NOT ALLOWED” to the document printing program 421 (step S415). In this case, the permission information showing “ERROR” may be sent to the document printing program 421. The document printing program 411 displays “NOT ALLOWED” or “ERROR” at the display unit of the user terminal 402 (step S416).

On the other hand, when the user authentication is succeeded, the access control server 404 reads out a record concerning the document ID included in the information obtained from the document printing program 421 from records registered in the security attribute database 443 (step S417). Subsequently, the access control server 404 obtains the lever and a department of the user from the user database 411 (step S418).

The access control server 404 obtains the security attribute (that is, the security level and the category) set to the document based on the record read in step S417. Subsequently, the access control server 404 obtains information showing whether or not the user is allowed to conduct a process indicated by the access type with respect to the document based on the security policy 444 and the security attribute read from the record (step S419). Then, the access control server 404 determines whether or not the user is allowed to print out the document (step S420).

When the user is authorized to print out the document, the permission information set as the security policy 444 is “ALLOWED”. Accordingly, the access control server 404 sends the encryption key and the print requirement stored in the record with the permission information to the user terminal 402, and then provides to the document printing program 421 (step S421).

On the other hand, when the user is not authorized to print out the document, the permission information set as the security policy 444 is “NOT ALLOWED”. Accordingly, the access control server 404 sends only the permission information to the user terminal 402 and then provides to the document printing program 421 (step S422)

In the process conducted by the access control server 404, in detail shown in FIG. 45, the user authenticating part 404b conducts the user authentication by referring to the user database 441 and sends the authentication result to the access authorization confirming part 404c. And when the user authentication is succeeded, the access authorization confirming part 404c obtains the permission information and the encryption key by referring to the security attribute database 443 and the security policy 444. Also, the print requirement obtaining/sending part 404d obtains the print requirement from the security policy 444 and sends to the document printing program 421. In FIG. 45, the permission information, the encryption key, and the print requirement are separately provided. Alternatively, the permission information, the encryption key, and the print requirement can be provided simultaneously.

Next, the document printing program 421 sets the printer driver so as to satisfy the print requirement set to the document and controls the printer 403 to conduct the printing process with respect to the document (step S424). For example, if the PAC is indicated as the print requirement, the document printing program 421 sets the private access mode.

If necessary, the document printing program 421 displays a message at the display unit of the user terminal 402 to require the user to set print parameters.

If the printer 403 can not conduct the printing process so as to satisfy the print requirement, that is, if the printer 403 does not implement a function satisfying the print requirement set as the security policy 444, the document printing program 421 displays a message at the display unit of the user terminal 402 to inform the user, and terminates the operation without the printing process.

By the above described operations, it is possible to set the access authorization and the print requirement for each user. Moreover, as described above, in a system configuration in that the access authorization with respect to the document is determined at a server side, the security policy 444 registered in the access control server 404 can be updated by the input operation at the distributor terminal 401 or the access control server 404. In this case, after the secured document is distributed, the print requirement can be updated.

For example, it is possible to set the access authorization with respect to the secured document 13, which has been already distributed, to a new user, and it is possible to add the print requirement to a specific user.

In a case in that the document printing program 421 always enquires the security policy to the access control server 404 when the document is printed, the more users, the larger amount of information to process in the access control server 404. Workload increases in the access control server 404.

Therefore, a part of functions of the access control server 404 can be implemented in the document printing program 421.

For example, the document printing program 421 may conduct the user authentication and then may send the document ID to the access control server 404. After that, the document printing program 421 may receive the security policy, the encryption key, and the security attribute from the access control server 404 and then may determine the permission information and the print requirement based on the security policy, the encryption key, and the security attribute.

By processing as described above, it is possible to reduce an amount of information to process and the workload in the access control server 404. In this case, since the document printing program 421 determines based on the security policy, the document may be encrypted to generate the encrypted document after the security attribute is attached to the document, and then the document ID may be attached to the encrypted document to generate the secured document 13. The access control server 404 is note required to maintain the security attribute, and it is possible to reduce the workload of the access control server 404 on a system operation.

If a person, who knows that the document protecting/printing system 4001 according to the second embodiment secures the document by the above described technology, may execute a program behaving like the document printing program 421 at a computer terminal and may illegally obtain the encryption key. Then, the person can decrypt the secured document 13. In this case, the print requirement set as the security policy will not be enforced, and the secured document 13 can be unlimitedly printed out.

Therefore, instead of simply encrypting the document by using only the encryption key, it is preferred to encrypt the document by using a combination of the secret key embedded in the document protecting program 411 and the encryption key. In this case, by embedding the same secret key in the document printing program 421, it is possible to limit only the document printing program 421 that enforces the print requirement set by the distributor, to decrypt and print out the secured document 13. That is, the document printing program 421 can be configured as the same as the document protecting program 311 shown in FIG. 40 and FIG. 41 in the third embodiment.

Moreover, in the fourth embodiment, the document printing program 221 only conducts the process related to printing the document. In addition, the document printing program 421 may provides contents of the document to the user, and may implement a function of editing the document. For example, the document printing program 421 can realize a function of displaying, editing, and printing a PDA file (portable document format) as a plug-in of Adobe acrobat®.

As described above, in the document protecting/printing system 4001 according to the fourth embodiment of the present invention, the print requirement set as the security policy beforehand can be enforced when the document is printed out.

Operation of the document printing program 421 in a case in that the PAC is set as the print requirement is the same as the operation the document printing program 221 in the second embodiment, and explanation thereof will be omitted.

Operations of the document printing program 421 in a case in that the EBC is set as the print requirement is the same as the operations of the document printing program 221 in the second embodiment, and explanation thereof will be omitted.

Operations of the document printing program 421 in a case in that the BDP is set as the print requirement is the same as the operations of the document printing program 221 in the second embodiment, and explanation thereof will be omitted.

Operations of the document printing program 421 in a case in that the SLS is set as the print requirement is the same as the operations of the document printing program 221 in the second embodiment, and explanation thereof will be omitted.

Each example described above is just an example of the print requirement. Alternatively, the digital watermark providing a tamper-proof may be printed, or the document to be secured may be printed on a special paper sheet (a tray is limited a tray for a special paper sheet).

That is to say, the print requirement can include a requirement for limiting or canceling a function, or a requirement for compulsory using a function, and additionally a print condition indication for a normal print. As an example of limiting or canceling the function, there is a print requirement for allowing only a special user to print out in color to distinguish over an original private (confidential) document and restricting other user so as to allow printing the original private (confidential) document in grayscale. As examples of enforcing to user the function, there are a print requirement for enforcing to user the private access mode, a print requirement for enforcing to print the user name of the user who prints out, a print requirement for enforcing to print the watermark, a print requirement for enforcing to print the background dot pattern, and a like. As example of indicating a general print condition, there are a print requirement for indicating an A4 size as a regular sheet, a print requirement for using a tray for a recycled paper, and a print requirement for indicating a both sides print.

As an description format of the print requirement, it is not limited to use keywords such as the RAD and the PAC as described above. For example, the print requirement can be described and regulated by using data themselves of a setting file to set to the printer driver 421g, a character string itself to display at a screen, data describing contents of a requirement to be processed in a script language. That is, it is not limited to the keywords such as the RAD or the PAC to describe the print requirement.

As described above, by setting the print requirement in accordance with a security policy by using various security function supported by the printer 403, the security function can be fully utilized, and a consistent security can be maintain. The security can be realized similarly in other embodiments.

In the third and fourth embodiments, the present invention is applied to the entire document as a secured object. Alternatively, portions (called segments) to be secured objects and portions not to be secured objects can be mixed. For example, as shown in FIG. 29, secured segments may exist within a plurality of secured documents. In this case, a different segment ID is assigned to each secured segment. The document ID described above can be read the segment ID. In a similar manner, it is possible to conduct the access control including the printing process for each secured segment. In practice, a start marker showing a start of the secured segment and an end marker showing an end of the secured segment are needed to provide at the beginning and the ending of the secured segment. A conventional technology such as a multi-part separator of a MIME can be used to provide those markers.

In the third and fourth embodiments, the document protecting program is arranged in the distributor terminal. Alternatively, a main part of the document protecting program may be arranged in a remote server. For example, the distributor terminal 401, relationships among the document protecting program 411, and the access control server 204 in FIG. 11 can be modified as shown in FIG. 30. By arranging as shown in FIG. 30, even if the document protecting program is not installed into a terminal, it is possible for the terminal to obtain the secured document 13 by sending the document and necessary parameters to the remote server.

The present invention is not limited to each of the embodiments.

For example, in each of embodiments, the distributor terminal and the user terminal are illustrated as separate terminals. Alternatively, the distributor terminal and the user terminal can be the same terminal.

Moreover, it is not limited to a case in that the user directly operates the user terminal where the document printing program is implemented. For example, the document printing program can be implemented in a server, and the user may execute the document printing program through the network by operating the user terminal.

Furthermore, a method for the user authentication is not limited to a method using the user name and the password. Alternatively, an authenticating method in a base of a PKI using a smart card.

The present invention can be modified.

In the embodiments, it is not limited to a word “printer” to use. The word “printer” is not to strictly limit to a dedicated printer but is applied to a copier, a facsimile, and an apparatus composing or fusing these functions together. That is, the word “printer” is applied to any apparatus including a print function.

### Fifth Embodiment

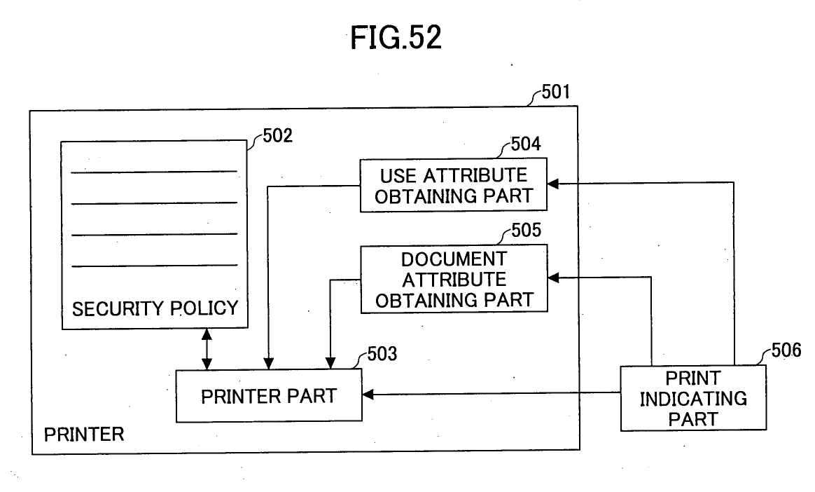

FIG. 52 is a diagram showing a configuration of a printer according to a fifth embodiment of the present invention.

In FIG. 52, a printer 501 includes a security policy 502 that is electronically described, a printing part 503 for conducting a printing process, a user attribute obtaining part 504 for obtaining a user attribute (a category and a security level) of a user who requests to print out a document, and a document attribute obtaining part 505 for obtaining a document attribute (a category and a security level) of the document to print out. A print indicating part 506 conducts a print indication based on a request of the user, and sends the user attribute and the document attribute to the printer 501.

For example, the security policy 502 is a script electronically describing the security policy as shown in FIG. 43 in the fourth embodiment.

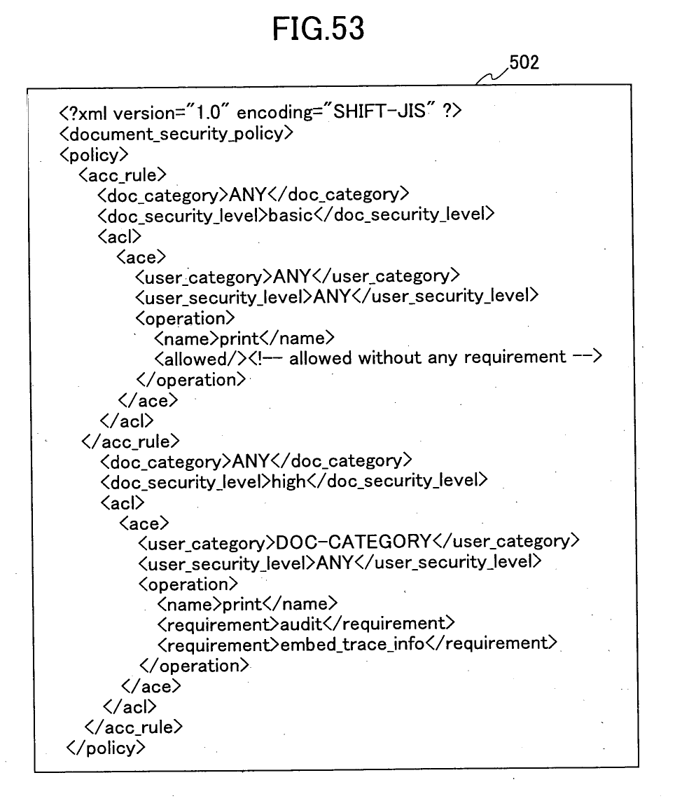

For example, the security policy 502 can be the script describing the security policy in an XML (eXtensible Markup language). FIG. 53 is a diagram showing an example of a script describing the security policy in the XML according to the fifth embodiment of the present invention.

The security policy 502 of the first half shown in FIG. 53 shows a condition in that the printing process is allowed without any requirement, regardless of the category of the user (<user_category>ANY</user_category>), when the security level of the document is basic (<doc_security_level>basic</doc_security_level>), regardless of the category of the document (<doc_category>ANY</doc_category>).

The security policy 502 of the last half shown in FIG. 53 shows a condition in that the printing process is allowed when the requirements of recording a log and embedding traceable information are satisfied (<name>print</name><requirement>audit</requirement><requirement>embed_trace_info</requirement>), regardless of the security level of the user (<user_security_level>basic</user_security_level>), when the category of the user is the same as the category of the document (<user_category>DOC-CATEGORY</user_category>), when the security level of the document is high (<doc_security_level>high</doc_security_level>), regardless of the category of the document (<doc_category>ANY</doc_category>).

In the following, operations according to the fifth embodiment of the present invention will be described based on the configuration of the printer 501.

When the user requests printing out the document, the print indicating part 506 sends a print indication of the document to the printer 501 based on the request of the user. Then, the user attribute obtaining part 504 obtains the category of the user and the security level of the user fro the print indicating part 506, and informs to the printing part 503. The document attribute obtaining part 505 obtains the category of the document and the security of the document from the print indicating part 506 and informs to the printing part 503. The printing part 503 searches for an entry corresponding to the security policy 502 based on the categories and the security levels of the user and the document received from the user attribute obtaining part 504 and the document attribute obtaining part 505, and retrieves the requirement (print requirement) that is enforced when the document is printed out.

It is assumed that the operations are conducted based on the security policy 502 shown in FIG. 53. For example, when the user attempts to print out the document having the security level “basic”, there is no requirement to enforce. For example, when the user attempts to print out the document having the security level “high”, the requirements of recording a log and embedding traceable information should be satisfied.

When there is no requirement, the printing part 503 prints out the document and then terminates the printing process. For example, this case corresponds to a case of the security level “basic”. When there are requirements, it is determined whether or not the printing part 503 can satisfy all the requirements. When the printing part 503 can not satisfy all the requirements, the printing part 503 informs the user that the printing process can not be conducted, and then terminates the operations of the printer 502. When the printing part 503 can satisfy all the requirements, the printing part 503 conducts all the requirement and prints out the document. For example, this case is a case of the security level “high”. That is, the log is recorded, the traceable information (such as an electronic watermark, a barcode, or a like) is embedded, and the printing process is terminated.

As the print requirement, the electronic watermark or the barcode is additionally printed out, a special paper sheet different from a regular paper sheet is used to print out, or the log is recorded. For example, the electronic watermark is a technology generally used to embed information concerning a literary work in digital data such as music, an image, or a like. Similar to the barcode, by using the electronic watermark, the information can be embedded in the document. The special paper sheet different from the regular paper sheet is not a white paper sheet generally used to print out. The special paper sheet can be distinguishable over the white paper sheet. For example, the special paper sheet can be a color paper sheet.

By the operations described above, the print requirement defined based on the security policy 502 beforehand can be automatically enforced when the document is printed out. In this case, regarding a security setting of printing out the document, it is not required to have knowledge about the security of each apparatus. Moreover, it is not required to set the security for each apparatus. Furthermore, it is possible to understand the entire security state and it is possible for the user to realize that the security of the document is actually maintained.

### Sixth Embodiment

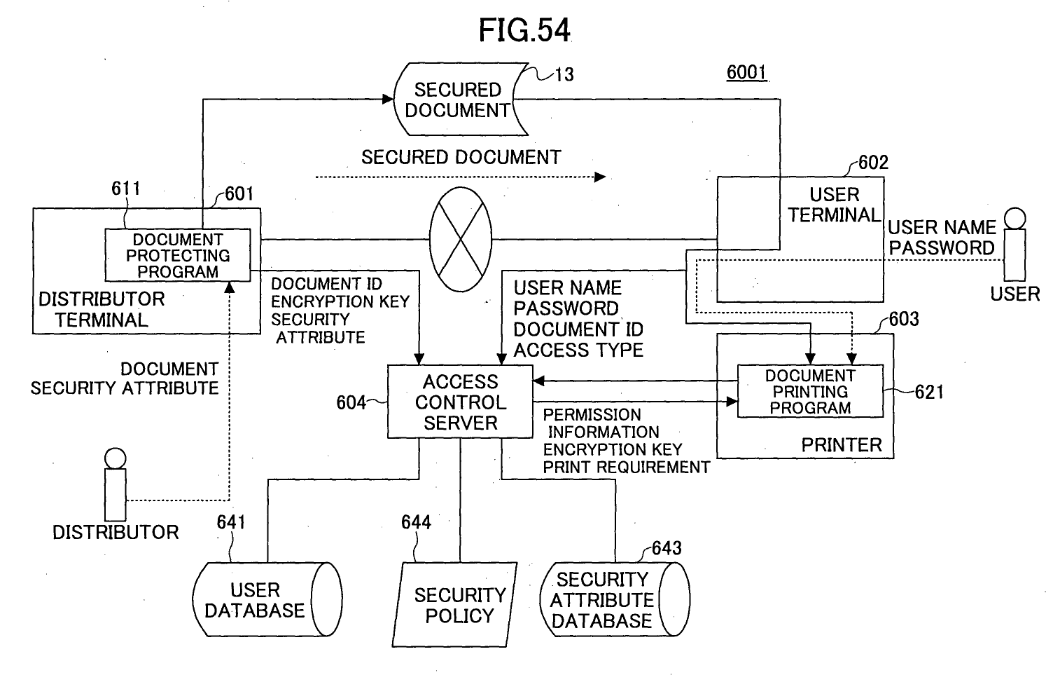

FIG. 54 is a diagram showing a document protecting/printing system according to a sixth embodiment of the present invention.

In FIG. 54, a document protecting/printing system 6001 includes a distributor terminal 601, a user terminal 602, a printer 603, and an access control server 604.

Each of the distributor terminal 601 and the user terminal 602 can be applied to a computer terminal including a display unit (for example, an LCD (Liquid Crystal Printer), an input unit (for example, a keyboard), an external storage unit (for example, an FDD (Floppy Disk Device), an HDD (Hard Disk Device), or a like). It should be noted that the distributor terminal 601 implements a document protecting program 611 and the user terminal 602 implements a document printing program 621.

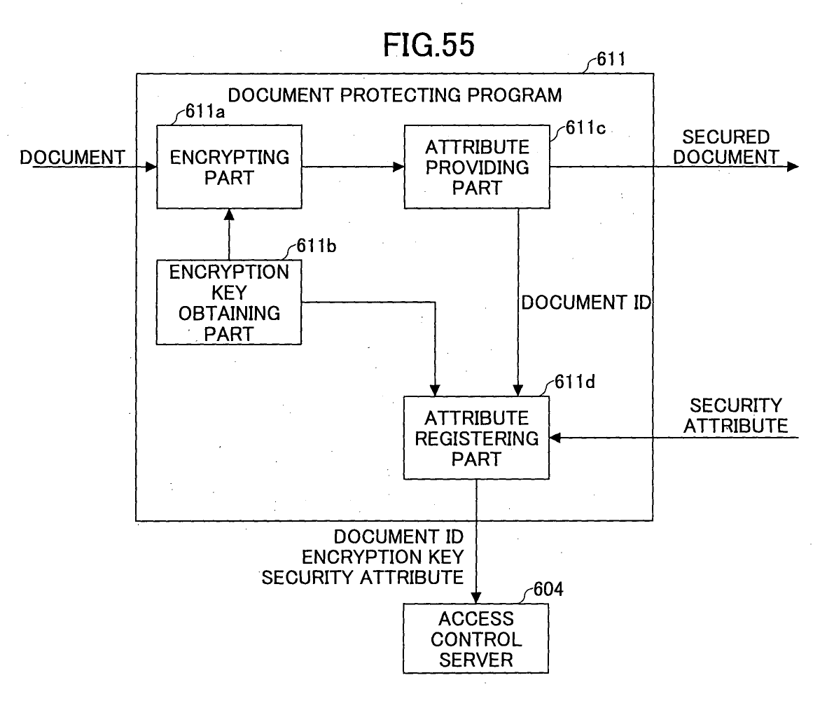

The document protecting program 11 is a program to set a print requirement to a document file (hereinafter, simply called a document) in response to an input operation by a distributor using the distributor terminal 01, encrypt the document using an encryption algorithm (for example, an RC4, Triple DES, IDEA), and generate a secured document 13. FIG. 55 is a diagram showing a configuration example of the document program protecting program according to the sixth embodiment of the present invention. In FIG. 55, the document program protecting program 611 includes an encrypting part 611a, an encryption key obtaining part 611b, an attribute providing part 611c, and an attribute registering part 611d. Each function will be described later.

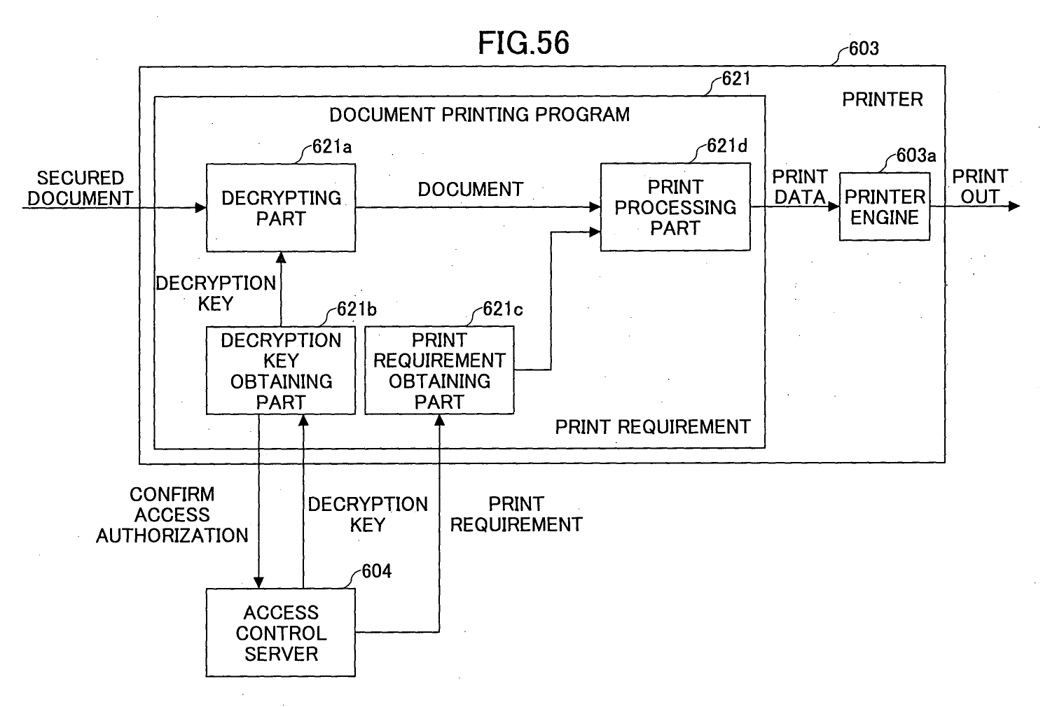

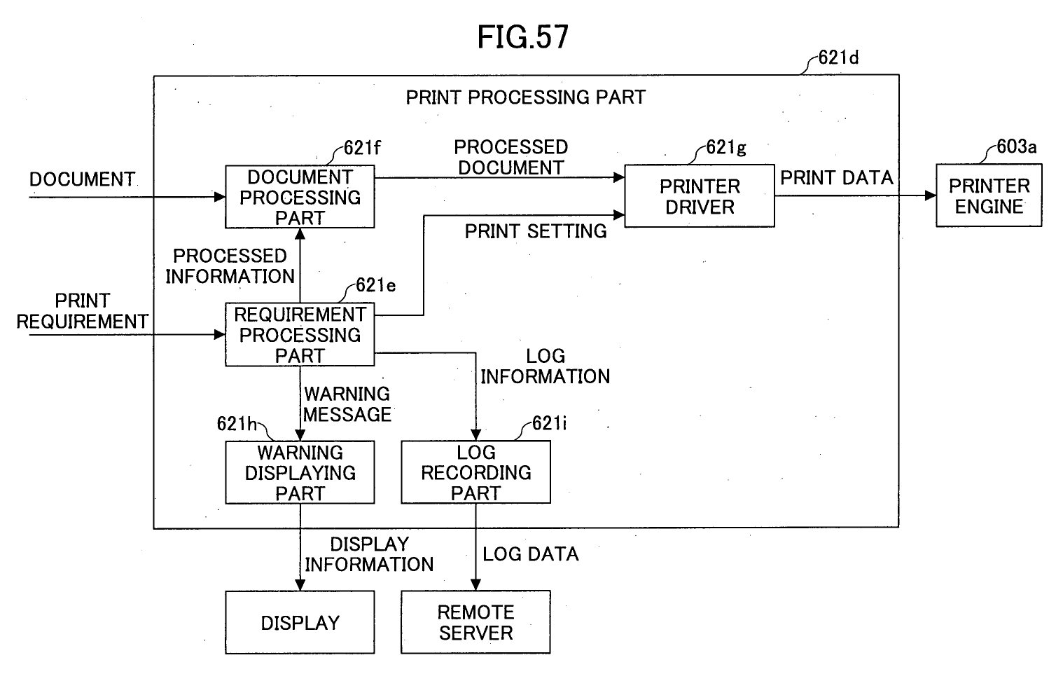

The document printing program 621 is a program to decrypt the secured document 13 in response to an input operation by a user using the user terminal 602, and to indicate the printer 603 to execute a process in accordance with the print requirement. FIG. 56 is a diagram showing a configuration example of the document printing program according to the sixth embodiment of the present invention. In FIG. 56, the document printing program 621 includes a decrypting part 621a, a decryption key obtaining part 621b, a print requirement obtaining part 621c, and a print processing part 621d. The print data is provided to the print engine 603a. FIG. 57 is a diagram showing a configuration example of the print processing part according to the sixth embodiment of the present invention. In FIG. 57, the print processing part 621d includes a requirement processing part 621e, a document processing part 621f, a printer driver 6212g, a warning displaying part 621h, and a log recording part 621i. Each function will be described later.

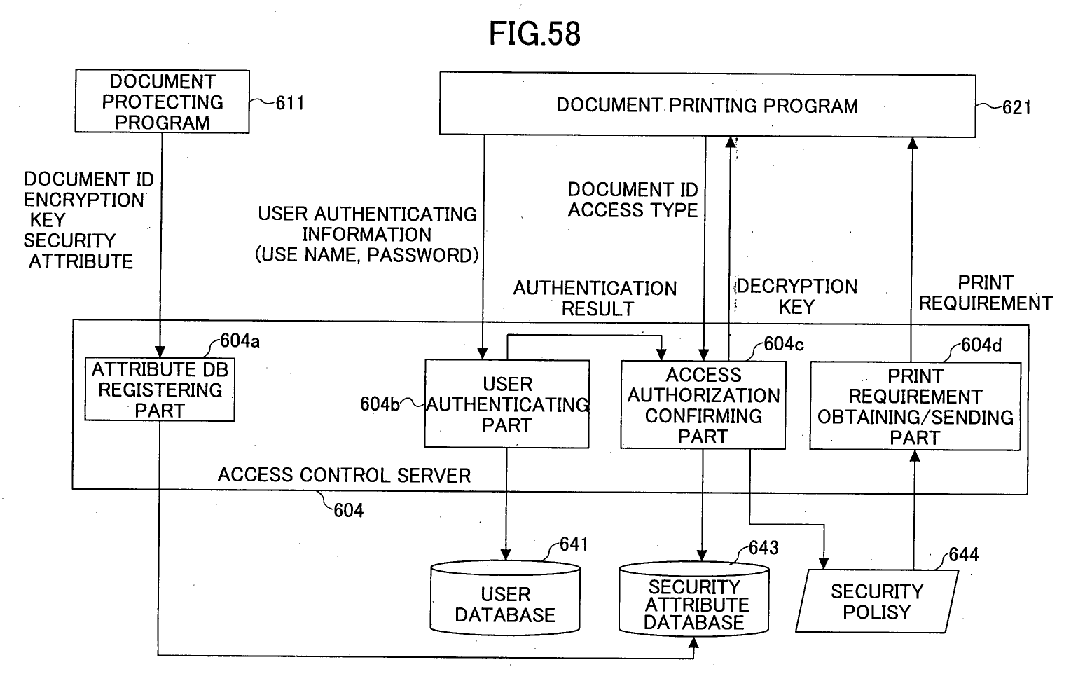

When the user attempts to access the document (for example, to print the document), the access control server 604 refers to the security policy 644 stored therein in response to a request from the document printing program 621, determines whether or not the user is authorized to access the document, and obtains the process requirement. FIG. 58 is a diagram showing a configuration example of the access control server according to the sixth embodiment of the present invention. FIG. 58, the access control server 604 includes an attribute DB registering part 604a, a user authenticating part 604b, an access authorization confirming part 604c, and a print requirement obtaining/sending part 604d. Each function will be described later.

As a print requirement which the document protecting program □11 sets to the document in response to the input operation of the distributor, for example, a BDP (Background Dot Pattern), a PAC (Private Access), a DWM (Digital Watermark), an EBC (Embedding Barcode), or an SLS (Security Label Stamp) may be required.

A security policy 644 registered in the access control server 604 is the same as the security policy 444 registered in the access control server 404 in FIG. 46 in the fourth embodiment. In the sixth embodiment, the security policy in the organization defines a security level (sensitivity) and a category with respect to the document and then defines a level and category of the user who is to be allowed to access the document, and a print requirement. For example, s for the document in that the category is “Technical” and the security level is “Secret”, a user in that the category is “Technical” and the level is “Medium” or “High” is allowed to read with the RAD as a requirement and to print out with the PAC, the BDP, the EBC, and RAD as requirements, but not allowed to hardcopy.

In the access control server 604, the security policy 644 can be recorded and maintained in any data format. The security policy 644 can be easily described in an XML (extensible Markup language) as shown in FIG. 47, similar to the fourth embodiment.

Referring to FIG. 54, the access control server 604 is connected to a user database 641 for storing information (a combination of user name and password) for authenticating each user and a security attribute database 643 in which information showing what security attribute is set to each secured document 13 and an encryption key for encrypting and decrypting the secured document 13 are associated with together and registered.

Similar to the fourth embodiment, the information illustrated in FIG. 48 is registered in the user data base 641.

Referring to FIG. 48 in the fourth embodiment, the category and the level are managed as a different attribute for each user. Alternatively, in a case in that the user is managed by using a user management of Windows® Domain, for example, “Techinical_Medium” is generated as a group account, and a user named “Ichiro” may be belonged to that group. By setting a naming rule of the group as described above, the category and the level can be managed as a single attribute.

Operations of the document protecting/printing system 6001 will be described. First, an operation of the entire document protecting/printing system 6001 will be described.

The distributor stores the document to the distributor terminal 601. For example, the distributor may create the document by operating the input unit or has the distributor terminal 601 read the document from an information recording medium by operating the external recording unit.

In case of securing the document, the distributor provides the document to the document protecting program 611 by operating the input unit. When the document protecting program 611 obtains the document, the document protecting program 611 requires the distributor to set the security attribute. For example, the document protecting program 611 displays a message at the display unit of the distributor terminal 601 and requires the distributor of setting the security attribute. A screen for requiring of setting the security attribute is the same as the screen shown in FIG. 36 in the third embodiment. It should be noted that the security attribute is information showing which security attribute registered in the securing attribute database 643 corresponds to the document to be secured.

When the distributor sets the security attribute to the document by using the input unit of the distributor terminal 601, the document protecting program 611 obtains the security attribute.

When the document protecting program 611 obtains the security attribute, the document protecting program 611 generates the document ID (Document ID) identical for each document and the encryption key (Key) used to encrypt and decrypt the document, associates the document ID and Key with the secret attribute, and sends and register to the access control server 604.

Also, the document protecting program 611 provides the document ID to the document which is encrypted by using the encryption key and then generates the secured document 13.

The distributor provides the secured document 13 generated by the document protecting program 611 to the user.

In a case in that the user attempts to print out the document, the secured document 13 is implemented to the user terminal 602. For example, the user terminal 602 may read out the secured document 13 stored in the information recording medium set in the external storage unit. Alternatively, in a case in that the user terminal 602 connects with the distributor terminal 601 through a network, the user terminal 602 may obtain the secured document 13 through the network.

When the user indicates the printer 603 to print out the document by using the input unit of the user terminal 602, the document printing program 621 in the printer 603 requires the user to input the password necessary to authenticate the user, through the user terminal 602. For example, the document printing program 621 displays a message at the display unit of the user terminal 602 to require the user to input the password. A similar screen shown in FIG. 19 in the second embodiment is displayed at the user terminal 602. The screen allows the user to input the user name and the password by using a keyboard or a like.

The document printing program 621 requires the access control server 604 to authenticate the user by sending the user name and the password.

The access control server 604 authenticates the user by using the user name and the password received from the document printing program 621 and then specifies the user.

When the access control server 604 specifies the user, the access control server 604 refers to the security attribute database 643.

The access control service 604 determines whether or not the user is authorized to print out the document, and obtains the print requirement that is set for the user to print out the document, based on information showing the level of the user obtained from the user database 641 and the security attribute set to the document.

When it is determined that the user is authorized to print out the document, the access control server 604 sends permission information showing that the user is allowed to print out the document, the encryption key to decrypt the secured document 13, and an the print requirement when the user prints out the document, to document printing program 621 the through the user terminal 602.

When the document printing program 621 receives the permission information, the encryption key, and the print requirement from the access control server 604, the document printing program 621 decrypts the secured document by using the encryption key and then restores the document.

Then, the document printing program 621 controls the print engine 603a of the printer 603 to conduct the printing process so as to satisfy the print requirement. For example, in a case in that the BDP is set to the document as the print requirement, the printer 603 prints out contents of the document while printing out a background image.

As described above, when the document is printed out, it is possible to enforce the print requirement corresponding to the security attribute that is set beforehand.

In a case in that the user is not aware of the print requirement or only a special printer can process the print requirement, information showing that may be provided to the user before executing the printing process. A confirmation screen displayed at the display unit of the user terminal 602 in the sixth embodiment is the same as the confirmation screen displayed at the display unit of the user terminal 102 in FIG. 8 in the sixth embodiment. In the confirmation screen shown in FIG. 8, the print requirements and available printers are displayed and the user can select one of the available printers to use.

Next, an operation of the document protecting program 611 (a secured document generating process) and an operation of the document printing program 621 (a secured document printing process) will be described in detail.

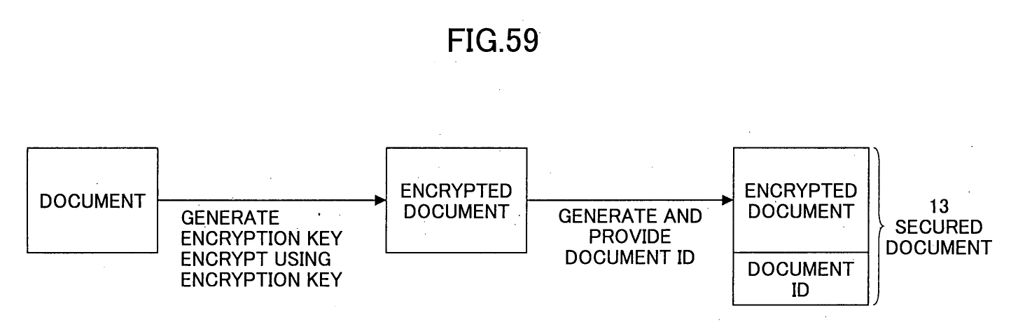

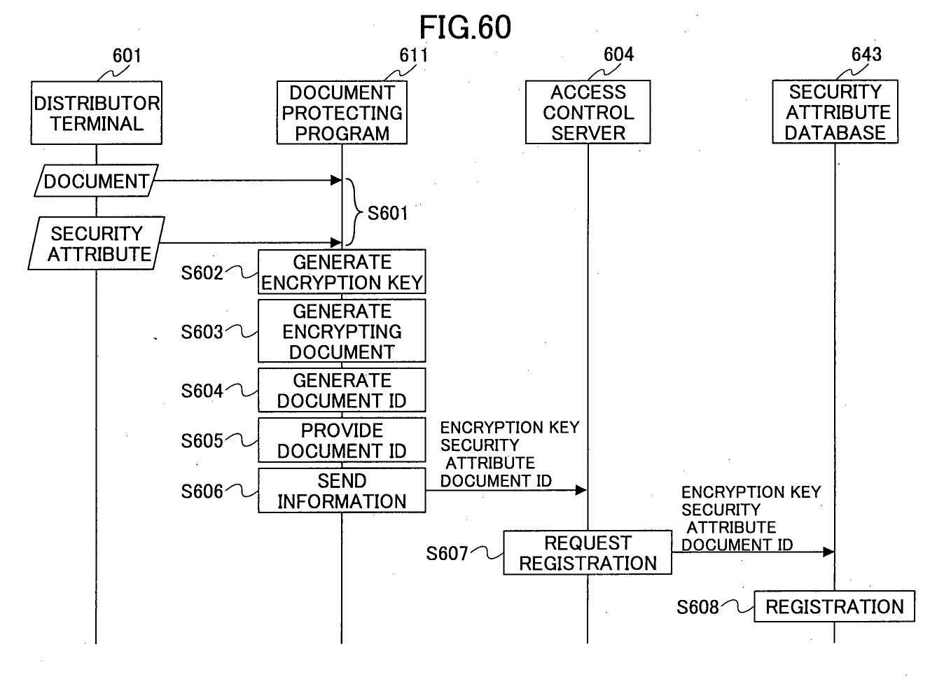

FIG. 59 is a diagram showing a process when the document protecting program generates the secured document, according to the sixth embodiment of the present invention. FIG. 60 is a diagram showing operations of the document protecting program and the access control server according to the sixth embodiment of the present invention.

When the document protecting program 611 obtains the document and the secret attribute by the input operation of the distributor at the input unit of the distributor terminal 601 (step S601), the document protecting program 611 encrypts the document and generates the encryption key to encrypt and decrypt (step S602). Then, the document protecting program 611 encrypts the document by using the encryption key and generates an encrypted document (step S603).

Moreover, the document protecting program 611 generates a document ID identical for each document (step S604), and generates the secured document 13 by attaching the document ID with the encrypted document (step S605).

After the secured document is generated, the document protecting program 611 sends the encryption key, the security attribute, and the document ID to the access control server 604 (step S606), and then requires the access control server 604 to register the encryption key, the security attribute, and the document ID (step S607).

When the access control server 604 receives the encryption key, the security attribute, and the document ID from the document protecting program 611, the access control server 604 associates the encryption key, the security attribute, and the document ID as one record and record and maintain in the security attribute database 643 (step S608).

The operations will be further described with reference to FIG. 55 and FIG. 58 in detail.

First, in FIG. 55, the encrypting part 611a of the document protecting program 611 encrypts the document received from the distributor by using the encryption key generated by the encryption key obtaining part 611b, and then sends an encrypted document to the attribute providing part 611c.

The attribute providing part 611c generates the document ID, provides the document ID to the encrypted document received from the encrypting part 611a, and outputs the secured document 13.

The attribute registering part 611d receives the security attribute from the distributor and also receives the encryption key from the encryption key obtaining part 611b and the document ID from the attribute providing part 611c. Then, the attribute registering part 611d sends the security attribute, the encryption key, and the document ID to the access control server 604 to register.

Next, in FIG. 58, the attribute DB registering part 604a of the access control server 604 registers the security attribute, the encryption key, and the document ID to the security attribute database 643.

In the sixth embodiment, the document protecting program 611 generates the document ID and attaches to the encrypted document. In a case in that the encrypted document is generated by using a hash algorithm such as an SHA-1, a hash value may be attached to the encrypted document, instead of the document ID. In this case, the document ID is not required to attach to the secured document. When the document ID is needed, the hash valued is calculated again.

Moreover, in the sixth embodiment, the document protecting program 611 generates the document ID and the encryption key. Alternatively, the document ID and the encryption key may be generated by the access control server 604 or another server (not shown).

If the distributor terminal 601 is not connected to the access control server 604 by a dedicated line but connected through a network and if it is concerned that the encryption key is intercepted while being sent to the access control server 604, a communication should be conducted by using a SSL (Secure Socket Layer).

A protocol for the document protecting program 611 to communicate with the access control server 604 can be any protocol. For example, a distribute object environment can be installed and information may be sent and received on a bases of Java® RMI (Remote Method invocation) and a SOAP (Simple Object Access Protocol). In this case, for example, the access control server 604 may implement a method such as “register(String docId, byte[ ] key, byte[ ] acl)”. If the SOAP is implemented, a message is exchanged by the SOAP on an HTTPS. If the RMI is implemented, by executing the RMI using a SocketFactory of an SSL base, the security on the network can be maintained.

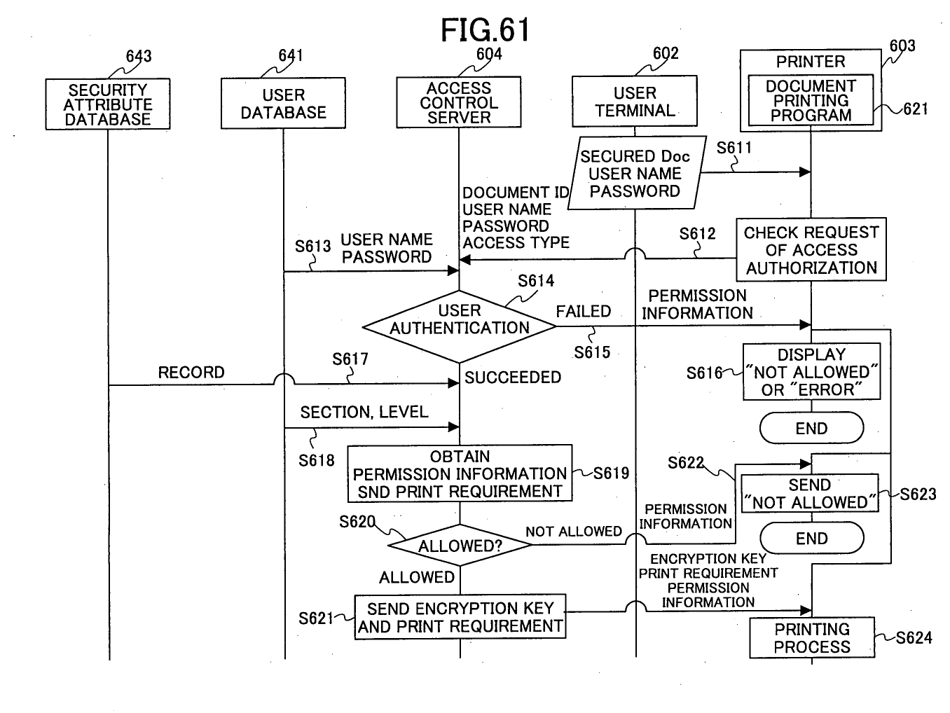

Next, the operation in a case in that the document printing program 621 prints out the secured document 13 will be described. FIG. 61 is a diagram showing the operations of the document printing program and the access control server when the secure document is printed out, according to the sixth embodiment of the present invention.

When the document printing program 621 obtains the user name and password by the input operation of the user at the input unit of the user terminal 602, the document printing program 621 obtains the document ID attached with the secured document (step S611).

Subsequently, the document printing program 621 sends the user name, the password, the document ID, the access type and requests the access control server 604 to check whether or not the user has the access authorization (step S612). An enquiry example by the SOAP to the access control server 604 is the same as the enquiry by the SOAP the access control server 204 as shown in FIG. 22 in the second embodiment.

When the access control server 604 receives the user name, the password, the document ID, and the access type, the access control server 604 refers to information registered in the user database 641 (step S613) and conducts the user authentication (step S614).

That is to say, the access control server 604 refers to the information registered in the user database 641 and determines whether or not the combination of the user name and the password included in the information obtained from the document printing program 621 is registered in the user database 641.

When the user authentication is failed (that is to say, the combination of the user name and the password included in the information received from the document printing program 621 is registered), the access control server 604 sends the permission information as “NOT ALLOWED” to the document printing program 621 in the printer 603 (step S615). In this case, the permission information showing “ERROR” may be sent to the document printing program 621. The document printing program 611 displays “NOT ALLOWED” or “ERROR” at the display unit of the user terminal 602 (step S616).

On the other hand, when the user authentication is succeeded, the access control server 604 reads out a record concerning the document ID included in the information obtained from the document printing program 621 from records registered in the security attribute database 643 (step S617). Subsequently, the access control server 604 obtains the lever and a department of the user from the user database 611 (step S618).

The access control server 604 obtains the security attribute (that is, the security level and the category) set to the document based on the record read in step S617. Subsequently, the access control server 604 obtains information showing whether or not the user is allowed to conduct a process indicated by the access type with respect to the document based on the security policy 644 and the security attribute read from the record (step S619). Then, the access control server 604 determines whether or not the user is allowed to print out the document (step S620).

When the user is authorized to print out the document, the permission information set as the security policy 644 is “ALLOWED”. Accordingly, the access control server 604 sends the encryption key and the print requirement stored in the record with the permission information to the user terminal 602, and then provides to the document printing program 621 (step S621).

On the other hand, when the user is not authorized to print out the document, the permission information set as the security policy 644 is “NOT ALLOWED”. Accordingly, the access control server 604 sends only the permission information to the user terminal 402 and then provides to the document printing program 621 (step S622)

Next, the document printing program 621 sets the printer driver so as to satisfy the print requirement set to the document and controls the print engine 603a to conduct the printing process with respect to the document (step S624). For example, if the PAC is indicated as the print requirement, the document printing program 621 sets the private access mode.

If necessary, the document printing program 621 displays a message at the display unit of the user terminal 602 to require the user to set print parameters.

If the printer 603 can not conduct the printing process so as to satisfy the print requirement, that is, if the printer 603 does not implement a function satisfying the print requirement set as the security policy 644, the document printing program 621 displays a message at the display unit of the user terminal 602 to inform the user, and terminates the operation without the printing process.

The operations will be described with reference to FIG. 56 through FIG. 58 in detail.

First, in FIG. 56, the decryption key obtaining part 621b of the document printing program 621 in the printer 603 enquires the access control server 604 to confirm the access authorization.

In FIG. 58, when the access control server 604 receives an enquiry of confirming the access authorization, the user authenticating part 604b conducts the user authentication by referring to the user database 641, and sends an authentication result to the access authorization confirming part 604c. When the user authentication is succeeded, the access authorization confirming part 604c obtains the permission information and the decryption key by referring to the security attribute database 643 and the security polity 644. Then, the print requirement obtaining/sending part 604d obtains the print requirement from the security policy 644 and sends to the document printing program 621. In FIG. 58, the authentication result is sent to the document printing program 621 and then is received from the document printing program 621 again. Alternatively, this process may be conducted at one time. Also, the permission information, the decryption key, and the print requirement are sent to the document printing program 621, respectively. Alternatively, the decryption key, and the print requirement can be simultaneously sent to the document printing program 621.

In FIG. 56, when the decryption key obtaining part 621b confirms the access authorization, the decryption key obtaining part 621b obtains the decryption key from the access control server 604, and sends to the decrypting part 621a. The print requirement obtaining part 621c obtains the print requirement from the access control server 604, and provides to the print processing part 621d.

The decrypting part 621a decrypts the secured document 13 by using the decryption key obtained from the decryption key obtaining part 621b, obtains the document, and then provides the document to the print processing part 621d.

Next, in FIG. 57, the requirement processing part 621e of the print processing part 621d conducts a plurality of processes in response to contents of the print requirement. That is, if the document itself is required to be processed as the BDP, the EBC, and the SLS are processed, the document processing part 621f processes the document by the process information and sends a processed document to the printer driver 621g. Then, the printer driver 621g provides print data to the print engine 603a and the printer 603 prints out the document. In a case in that a special setting is required to the printer driver 621g such as the PAC, a print setting is conducted to the printer driver 621g. In a case in that a warning message to the user is required, the warning message is provided to the warning displaying part 621h to display at the display unit. Also, in a case in that a print log is required, log information is sent to the log recording part 621i and then log data is registered to a remote server or a like.

By the above described operations, it is possible to set the access authorization and the print requirement for each user. Moreover, as described above, in a system configuration in that the access authorization with respect to the document is determined at a server side, the security policy 644 registered in the access control server 604 can be updated by the input operation at the distributor terminal 601 or the access control server 604. In this case, after the secured document 13 is distributed, the print requirement can be updated.

For example, it is possible to set the access authorization with respect to the secured document 13, which has been already distributed, to a new user, and it is possible to add the print requirement to a specific user.

In a case in that the document printing program 621 always enquires the security policy to the access control server 604 when the document is printed, the more users, the larger amount of information to process in the access control server 604. Workload increases in the access control server 604.

Therefore, a part of functions of the access control server 604 can be implemented in the document printing program 621.

For example, the document printing program 621 may conduct the user authentication and then may send the document ID to the access control server 604. After that, the document printing program 621 may receive the security policy, the encryption key, and the security attribute from the access control server 604 and then may determine the permission information and the print requirement based on the security policy, the encryption key, and the security attribute.

By processing as described above, it is possible to reduce an amount of information to process and the workload in the access control server 604. In this case, since the document printing program 621 determines based on the security policy, the document may be encrypted to generate the encrypted document after the security attribute is attached to the document, and then the document ID may be attached to the encrypted document to generate the secured document 13. The access control server 604 is note required to maintain the security attribute, and it is possible to reduce the workload of the access control server 604 on a system operation.

If a person, who knows that the document protecting/printing system 6001 according to the sixth embodiment secures the document by the above described technology, may execute a program behaving like the document printing program 621 at a computer terminal and may illegally obtain the encryption key. Then, the person can decrypt the secured document 13. In this case, the print requirement set as the security policy will not be enforced, and the secured document 13 can be unlimitedly printed out.

Therefore, instead of simply encrypting the document by using only the encryption key, it is preferred to encrypt the document by using a combination of the secret key embedded in the document protecting program 611 and the encryption key. In this case, by embedding the same secret key in the document printing program 621, it is possible to limit only the document printing program 621 that enforces the print requirement set by the distributor, to decrypt and print out the secured document 13.

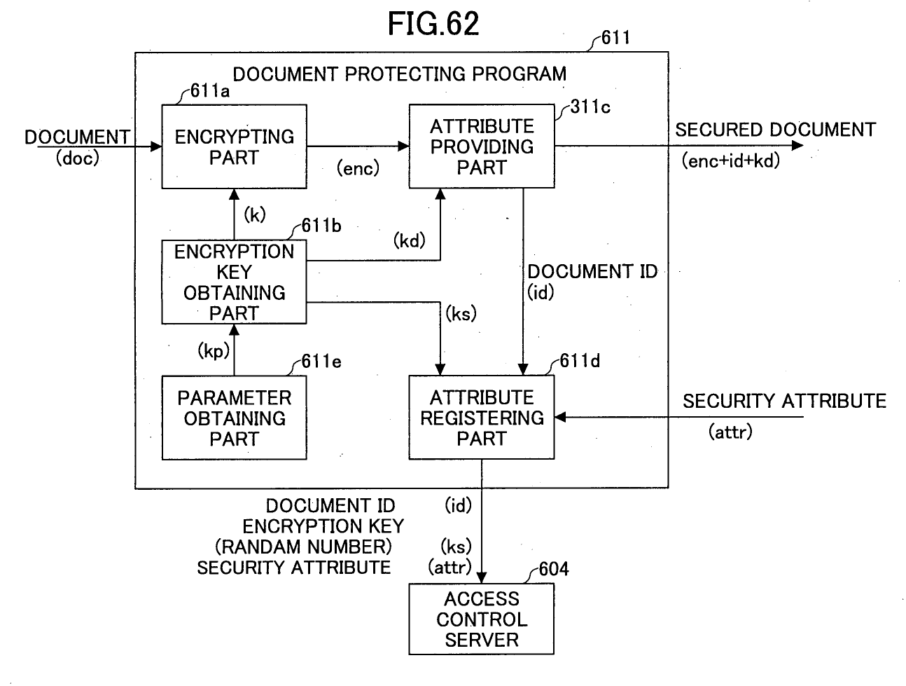

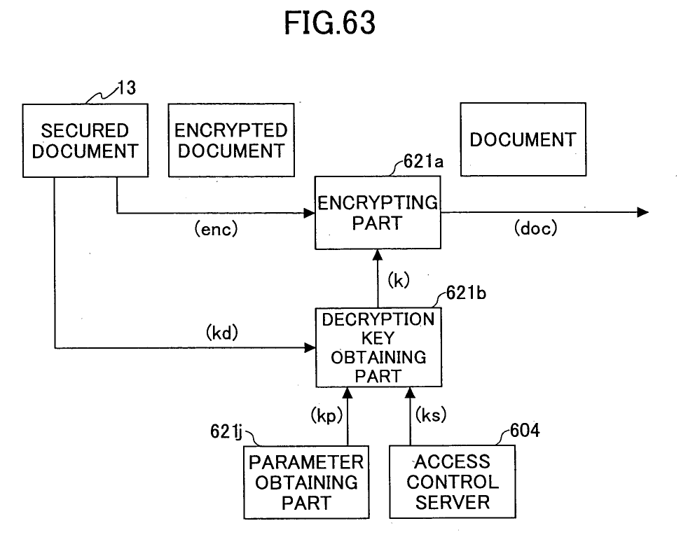

A type in a case of embedding the secret key in the document protecting program 611 will be described with reference to FIG. 62 and FIG. 63. FIG. 62 is a diagram showing a configuration example of the document protecting program according to the sixth embodiment of the present invention. FIG. 63 is a diagram showing a portion related to a decryption in the configuration example of the document printing program according to the sixth embodiment of the present invention. In FIG. 62 and FIG. 63, not only the secret key is simply embedded but also a random number is installed to guard more against an illegal access.

In FIG. 62, the document protecting program 611 includes an encrypting part 611a, an encryption key obtaining part 611b, an attribute providing part 611c, an attribute registering part 611d, and a parameter obtaining part 611e.

In operations, the parameter obtaining part 611e generates a parameter (kp), and provides to the encryption key obtaining part 611b. It should be noted that the parameter (kp) should be maintained within the document protecting program 611 and be generated when required.

After the encryption key obtaining part 611b receives the parameter (kp) from the parameter obtaining part 611e, the encryption key obtaining part 611b generates two random numbers (kd) and (ks), and generates the encryption key (k) by calculating k=H{ks, kp, kd} or k=D{kd, D[ks, kp]}. subsequently, the encryption key obtaining part 611b provides the encryption key (k) to the encrypting part 611a, the random number (kd) to the attribute providing part 611c, and the random number (ks) to the attribute registering part 611d, respectively. H{data 1, data 2, . . . } denotes to calculate the hash values of the data 1, the data 2, . . . , and D{data, key} denotes to decrypt the data by the key.

The encrypting part 611a encrypts the document (doc) received form the distributor by using the encryption key (k) obtained from the encryption key obtaining part 611b, and provides the encrypted document (enc) to the attribute providing part 611c. This expression is shown as enc=E{doc, k}. E{data, key} denotes to encrypt the data by the key.

Next, the attribute providing part generates the document ID (id), provides the document ID (id) and the random number (kd) provided from the encryption key obtaining part 611b to the encrypted document, and then outputs the secured document (enc+id+kd). In addition, the attribute providing part 611c provides the document ID (id) to the attribute registering part 611d.

The attribute registering part 611d sends the document ID (id) received from the attribute providing part 611c, the random number (ks) received from the encryption key obtaining part 611b, and the security attribute (attr) obtained from the distributor to the access control server 604 to register.

Referring to FIG. 63, in order to decrypt, the decryption key obtaining part 621b obtains the random number (kd) from the secured document 13, and a parameter (kp), that is maintained in the document printing program 621 or generated in response to a request, from the parameter obtaining part 621j. The decryption key obtaining part further obtains the random number (ks) from the access control server 604, and obtains the decryption key (encryption key) (k) by calculating k=H{ks, kp, kd} or k=D{kd, D{ks, kp}} similar to the encryption.

Then, the decrypting part 621a decrypts the encrypted document (enc) by the decryption key (k) and then obtains the document (doc).

FIG. 62 and FIG. 63 show a method for generating the encryption key (decryption key) (k) based the random number (ks) registered in the access control server 604, the random number (kd) in the secured document 13, and the parameter (kp) from the document protecting program 611 or the document printing program 611. By the method, even if the access control server 604 is illegally accessed by a viper as a user and the random number (ks) is known to the viper, the secured document 13 can not be decrypted without the random number (kd) and the parameter (kp). However, in a circumstance in that the access control server 604 is sufficiently guarded not to be illegally accessed, the random number (ks) can be used as the encryption key (decryption key) (k) itself.

On the other hand, in the third embodiment, the print requirement is stored in only the access control server 604. Alternatively, the print requirement can be included in the secured document 13. For example, if the print requirement is always indicated to the document regardless of the user, the print requirement can be included in the secured document 13.

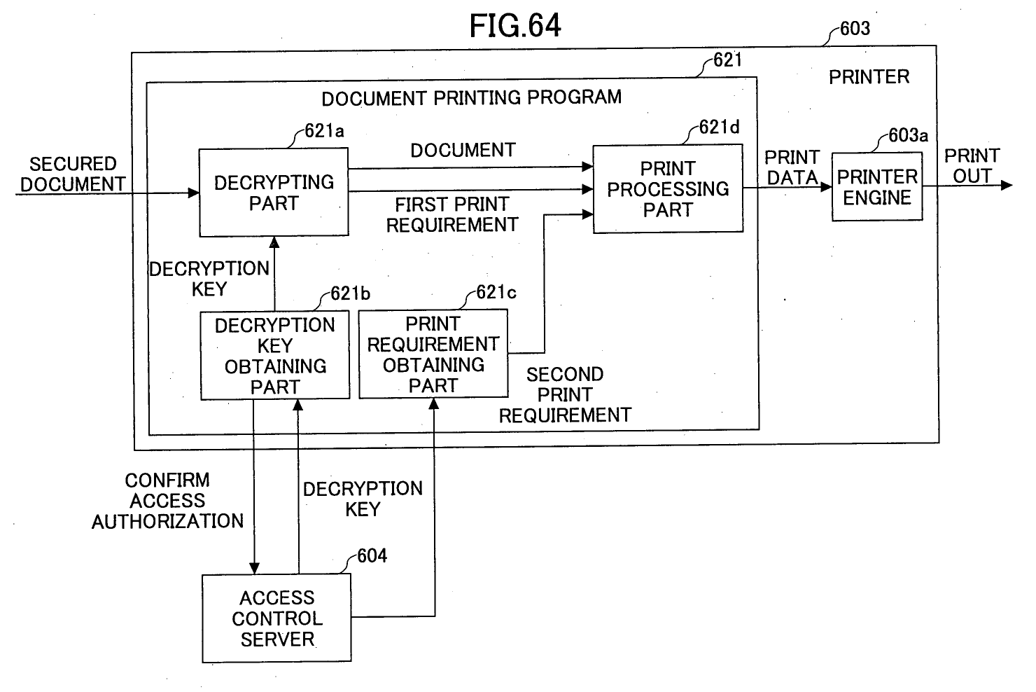

FIG. 64 is a diagram showing a configuration example of the document printing program in a case in that the entire print requirements are separated into a first print requirement to include in the secured document and a second print requirement to store in the access control server, according to the sixth embodiment of the present invention. In FIG. 64, the print requirement obtaining part 621c obtains the second print requirement from the access control server 604 and the decrypting part 621a obtains the first print requirement from the secured document 13. Accordingly, the print processing part 621d conducts the printing process based on the first print requirement and the second print requirement. The other operations are conducted similar to the operations of the document printing program 621 shown in FIG. 56.

Moreover, in the sixth embodiment, the document printing program 621 only conducts the process related to printing the document. In addition, the document printing program 621 may provides contents of the document to the user, and may implement a function of editing the document. For example, the document printing program 621 can realize a function of displaying, editing, and printing a PDA file (portable document format) as a plug-in of Adobe acrobat®.

As described above, in the document protecting/printing system 6001 according to the fourth embodiment of the present invention, the print requirement set as the security policy beforehand can be enforced when the document is printed out.

The portion of the security function implemented in the printer 203 applied in the second embodiment can be applied in the sixth embodiment. A system configuration example according to the sixth embodiment of the present invention will be concretely described.

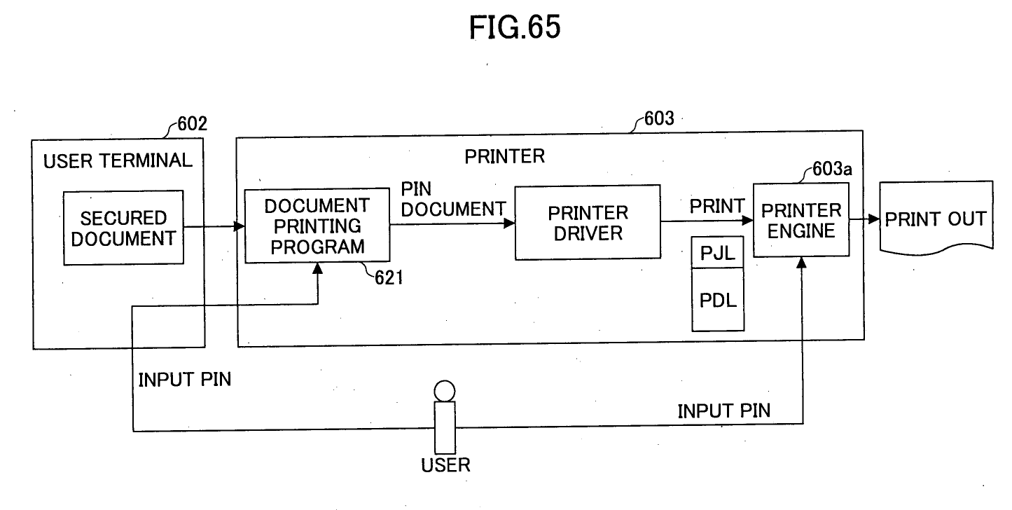

First, operations of the document printing program 621 will be described in a case in that the PAC is set as the print requirement. FIG. 65 is a diagram showing the operation of the document printing program in the case in that the PAC is set as the print requirement, according to the sixth embodiment of the present invention.

(1) when the document printing program 621 prints out the document where the PAC is set, the document printing program 621 displays a dialog for inputting a PIN (personal identification number) at the display unit of the user terminal 602 after displaying a print dialog, as shown in FIG. 28.

(2) When the user inputs the PIN by using the input unit of the user terminal 602, the document printing program 621 sets the PIN to the printer driver 621g and indicates to print out.

The printer driver 621g generates print data (PDL data described in a PDL (Page Description Language) such as a Postscript from the document, additionally provides PJL (Print Job Language) data describing print job information showing the number of copies and an output tray to a header of the PDL data. The printer driver 621g further additionally provides the PIN as a portion of the PJL data and sends the PDL data with the PJL data to the print angina 603a.

The print engine 603a refers to contents of the PJL data when receiving the PDL data with PJL data, and stores the PDL data with the PJL data in a storage unit (a hard disk device) if the PIN for the private access is included. When the user inputs the PIN through the operation panel of the printer 603, the printer 603 checks the PIN input by the user with the PIN included in the PJL data. When both PINs are identified, the document is printed out in accordance with the PDL data applying a print job condition (the number of copies, the output tray, or the like) included in the PJL data.

(3) When the PIN can not be set to the printer driver 621g, that is, when the printer 603 does not support the private access, the user is informed to select another printer supporting the private access, and the process is terminated without printing out the document.

As described above, after the printing process is executed, the printout of the document can not be output from the printer 603 until a PIN identical to the PIN input by the user prior to the printing process is input by the user at the operation panel of the printer 603. Accordingly, the printout of the document is not carelessly left at the printer 603. Thus, it is possible to prevent the document from being leaked by the printout. Furthermore, a communication with the printer 603 should be secured by the SSL so that the print data transmitting through the network can not be intercepted.

Alternatively, the document printing program 621 may be associated with a user management of Windows® Domain, so that the user is not required to input the PIN. For example, the PIN is not input by the user but the user ID being currently logged on is obtained from Windows® Domain, and the user ID is sent to the printer 603 with the print data. The printer 603 receives the password input by the user at the operation panel, conducts the user authentication with the user ID and the password by using a user authentication organization of Window® Domain. When the user authentication is succeeded, the printer 603 prints out the document. However, it is not limited to Window® Domain. By associating with the user management installed beforehand, it is possible to eliminate an input of the PIN which is a problem for the user.

Next, operations of the document printing program 621 will be described in a case in that the EBC is set as the print requirement.

(1) The document printing program 621 generates data for a barcode image data (or a two dimensional code) showing the document ID when the document where the EBC is set is printed out.

(2) The document printing program 621 sets a generated barcode image data to the printer driver 621g as a stamp image, and indicates the print engine 603a to print out the document.

(3) When the EBC can not be set to the printer driver 621g, that is, when the printer 603 does not support a stamp function, the user is informed to select another printer supporting the stamp function and the process is terminated without the printing process.

As described above, a barcode is printed on each page of the printout of the document. Thus, only a copier, a facsimile, or a scanner that can identify this barcode can obtain the document ID by decoding the barcode, and can determine based on the document ID by accessing the access control server 604 whether or not a hardcopy, an image reader, a facsimile transmission, or a like is allowed. Therefore, it is possible to maintain a consistent security including a paper document.

Next, operations of the document printing program 621 will be described in a case in that the BDP is set as the print requirement.

(1) The document printing program 621 obtains the user name of the user who requests to print out the document, and a print date as a character string (for example, Ichiro, Aug. 4, 2002 23:47:10) when printing out the document where the BDP is set.

(2) The document printing program 621 generates the background dot pattern so that a generated character string seems to be a relief character string when copying the printout of the document by a copier.

(3) The document printing program 621 sets the generated background dot pattern as a stamp and indicates the print engine 603a to print out the document.

(4) When the BDP can not be set to the printer driver 621g, that is when the printer 603 does not support the background dot pattern, the user is informed to select another printer supporting the background dot pattern, and the process is terminated without printing out the document.

Accordingly, the background dot pattern where the user name and the date are shown as relief characters is printed on each page of the printout of the documents, so that the relief characters are formed if the printout is processed by the copier, the scanner, or the facsimile. This is effective in a case of using the copier that does not support the EBC. In addition, it can be suppressed to leak information by copying the printout of the document.

Next, operations of the document printing program 621 will be described in a case in that the SLS is set as the print requirement.

(1) The document printing program 621 selects an image (mark of “Top Secret”) corresponding a confidential level of the document from images prepared beforehand when printing out the document where the SLS is set as the print requirement.

(2) Data of a selected image are set to the printer driver 621g as a stamp, the document printing program 621 indicates the print engine 603a to print out the document.

(3) When the SLS can not be set to the printer driver 621g, that is when the printer 603 does not support the SLS, and the process is terminated without printing out the document.

Accordingly, since the mark of “Top Secret” is automatically printed out as the stamp when the document is printed out, it can be clearly seen that the document is a private (confidential) document. That is, it is possible to warn a person possessing the printout in order to manage the private (confidential) document.

Each example described above is just an example of the print requirement. Alternatively, the digital watermark providing a tamper-proof may be printed, or the document to be secured may be printed on a special paper sheet (a tray is limited a tray for a special paper sheet).

That is to say, the print requirement can include a requirement for limiting or canceling a function, or a requirement for compulsory using a function, and additionally a print condition indication for a normal print. As an example of limiting or canceling the function, there is a print requirement for allowing only a special user to print out in color to distinguish over an original private (confidential) document and restricting other user so as to allow printing the original private (confidential) document in grayscale. As examples of enforcing to user the function, there are a print requirement for enforcing to user the private access mode, a print requirement for enforcing to print the user name of the user who prints out, a print requirement for enforcing to print the watermark, a print requirement for enforcing to print the background dot pattern, and a like. As example of indicating a general print condition, there are a print requirement for indicating an A4 size as a regular sheet, a print requirement for using a tray for a recycled paper, and a print requirement for indicating a both sides print.

As an description format of the print requirement, it is not limited to use keywords such as the RAD and the PAC as described above. For example, the print requirement can be described and regulated by using data themselves of a setting file to set to the printer driver 621g, a character string itself to display at a screen, data describing contents of a requirement to be processed in a script language. That is, it is not limited to the keywords such as the RAD or the PAC to describe the print requirement.

As described above, by setting the print requirement in accordance with a security policy by using various security function supported by the printer 603, the security function can be fully utilized, and a consistent security can be maintain. The security can be realized similarly in other embodiments.

In the third and fourth embodiments, the present invention is applied to the entire document as a secured object. Alternatively, portions (called segments) to be secured objects and portions not to be secured objects can be mixed. For example, as shown in FIG. 29, secured segments may exist within a plurality of secured documents. In this case, a different segment ID is assigned to each secured segment. The document ID described above can be read the segment ID. In a similar manner, it is possible to conduct the access control including the printing process for each secured segment. In practice, a start marker showing a start of the secured segment and an end marker showing an end of the secured segment are needed to provide at the beginning and the ending of the secured segment. A conventional technology such as a multi-part separator of a MIME can be used to provide those markers.

In the third and fourth embodiments, the document protecting program is arranged in the distributor terminal. Alternatively, a main part of the document protecting program may be arranged in a remote server. For example, the distributor terminal 601, relationships among the document protecting program 611, and the access control server 604 in FIG. 54 can be modified as shown in FIG. 30. By arranging as shown in FIG. 30, even if the document protecting program is not installed into a terminal, it is possible for the terminal to obtain the secured document 13 by sending the document and necessary parameters to the remote server.

The present invention is not limited to each of the embodiments.

For example, in each of embodiments, the distributor terminal and the user terminal are illustrated as separate terminals. Alternatively, the distributor terminal and the user terminal can be the same terminal.

Moreover, it is not limited to a case in that the user directly operates the user terminal where the document printing program is implemented. For example, the document printing program can be implemented in a server, and the user may execute the document printing program through the network by operating the user terminal.

Furthermore, a method for the user authentication is not limited to a method using the user name and the password. Alternatively, an authenticating method in a base of a PKI using a smart card.

In the embodiments, it is not limited to a word “printer” to use. The word “printer” is not to strictly limit to a dedicated printer but is applied to a copier, a facsimile, and an apparatus composing or fusing these functions together. That is, the word “printer” is applied to any apparatus including a print function.

### Seventh Embodiment

A seventh embodiment of the present invention will be described according to the present invention.

First, a common outline of an electronic file management apparatus in each embodiment will be described.

The electronic file management apparatus according to the present invention includes a computer main unit, an input unit for a user to input data, and a display unit for displaying various information to the user.

For example, the input unit is a keyboard or a mouse, and the display unit is an LCD (Liquid Crystal Display).

The computer main unit manages an original document (Document; original electronic document), and a secured document (Protected Document; access-controlled electronic file), and displays information in accordance with an access authorization of the user operating from the input unit, at the display unit.

It is not limited to the display unit as an output unit from the computer main unit. Alternatively, for example, by connecting a printer to the computer main unit, information can be printed at the printer. If an access request of the user indicates to store information to an information recording medium such as a removable disk such as a floppy® disk, the information can be stored in the information recording medium.

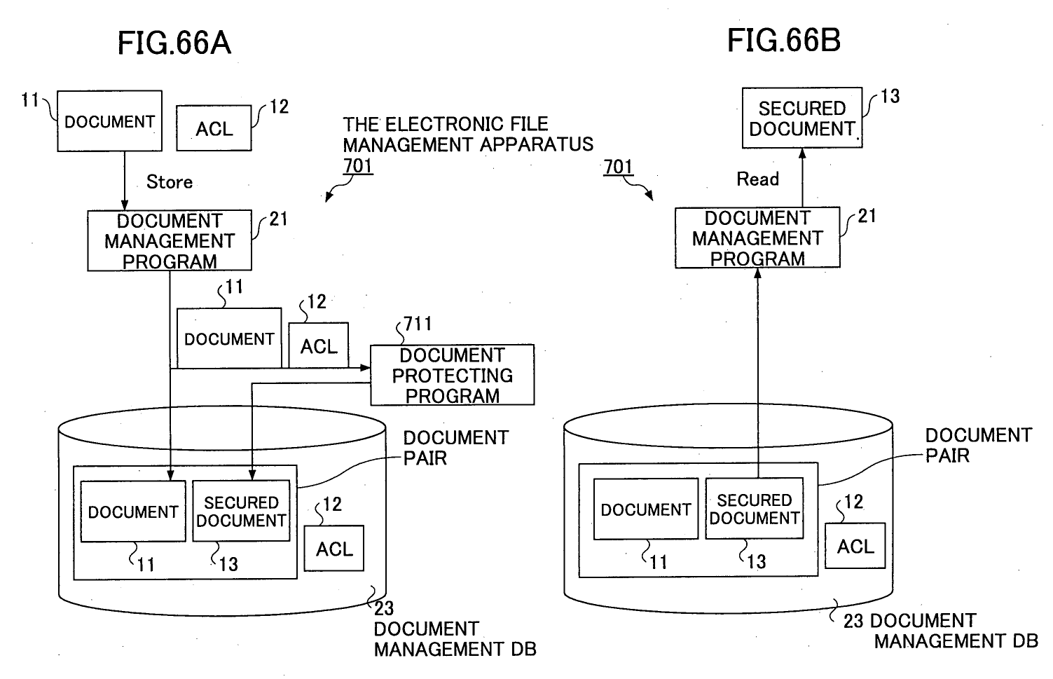

Next, a electronic file management apparatus will be described with reference to FIG. 66A and FIG. 66B. FIG. 66A and FIG. 66B are diagram showing the electronic file management apparatus according to the seventh embodiment of the present invention.

Referring to FIG. 66A, in a seventh embodiment of the present invention, when a document 11 (original document; original electronic file), an ACL (Access Control List; access authorization information) 12 are stored in a document management program 21, the secured document 13 is created and basically only the secured document 13 can be accessed.

The electronic file management apparatus 701, that is controlled by the computer main unit in the seventh embodiment, includes the document management program (managing part) 21 for receiving and managing the document 11 and the ACL 12 from an administrator, a document protection program (access controlling part) 711 for generating the secured document 13 where the access restriction is applied based on the document 11 and the ACL 12, a document management DB (storing part) 23 for storing the electronic files (various documents) and the ACL 12, and a storage unit (not shown) such as an HDD (Hard Disk Drive).

The ACL 12 is an access authorization for the document 11. The access authorization is defined by the administrator and includes information for restricting the access to the document 11 by the user.

The electronic file management apparatus 701 according to the seventh embodiment physically includes the storage unit, described above, to store various programs and data, and a main control unit such as a CPU (Central Processing Unit). The main control unit conducts processes in accordance with the programs stored in the storage unit, so that the electronic file management apparatus 701 functions as the managing part, the access restricting part, and the storing part as described above.

That is, the electronic file management apparatus 701 functions as the managing part since the main control unit conducts a process in accordance with the document program management program 21 stored in the storing part. The electronic file management apparatus 701 functions as the access restricting part since the main control unit conduct a process in accordance with a document 11 stored in the storage unit.

As the ACL 12, the ACL 12 shown in FIG. 16 in the second embodiment is applied. The ACL 12 includes parameters of “User name” as a user name, “Access type” as an access type, “Permission” as permission information, and “Requirement” as the process requirement.

That is, with respect to the user name (User name) of the user, who is authorized to have a certain access authorization, the access authorization is associated with an operation instruction (Access type) requested by the user. “Allowed” and “Denied” are defined for each access type by the user.

The ACL 12 includes a process requirement (Requirement). If only regular access control is required, the process requirement can be eliminated.

The ACL 12 is created by a creator who created the document 11, or the administrator (user having a administrator authorization) of the electronic file management apparatus 701 and is provided to the document 11. The electronic file management apparatus 701 conducts various outputs in response to each operation instruction from the user using the input unit based on the ACL 12 in accordance with the document management program 21.

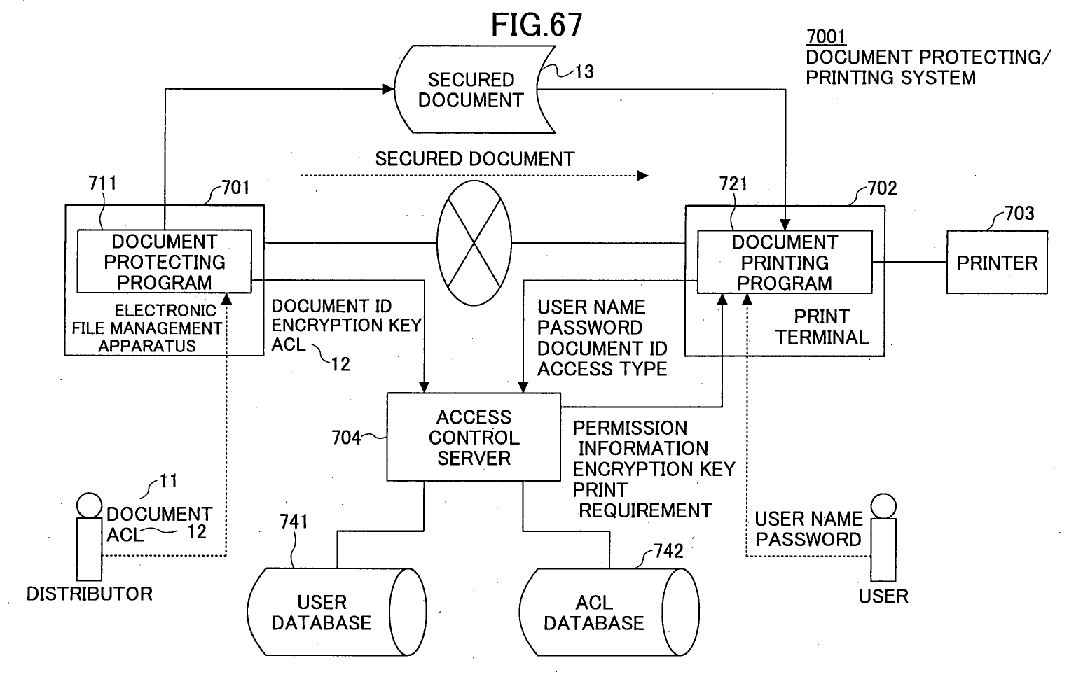

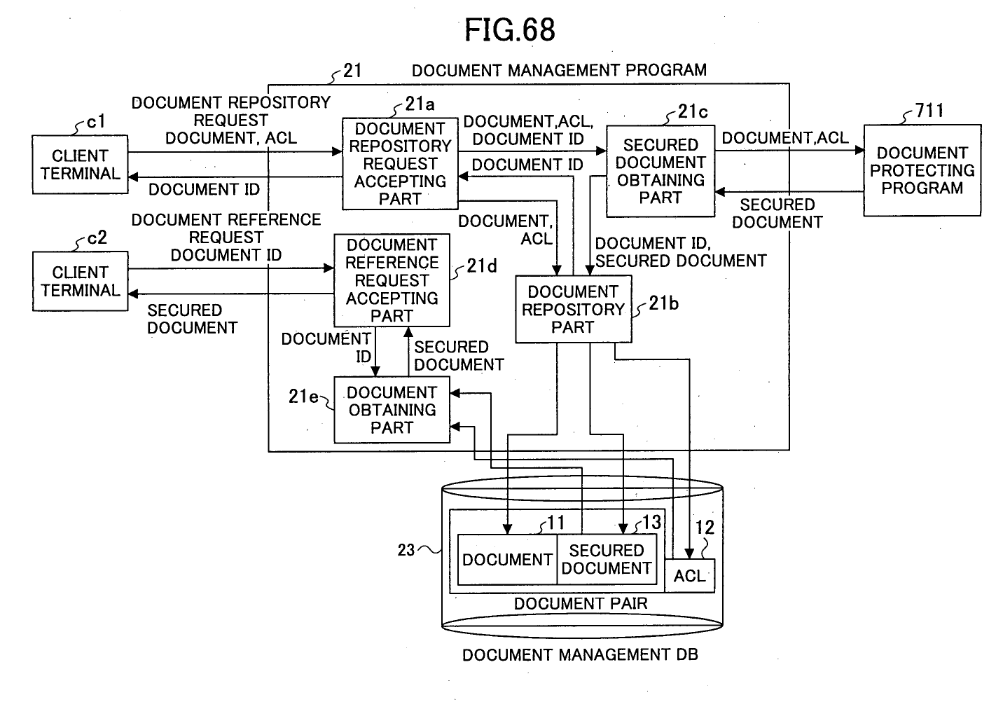

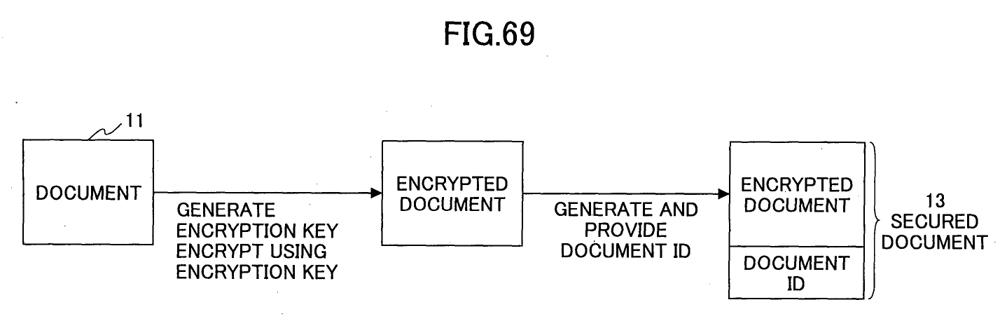

Next, operations of the electronic file management apparatus 701 in a document protecting/printing system will be described with reference to FIG. 66A, FIG. 67, FIG. 68, and FIG. 69.

In a document protecting/printing system 7001 in FIG. 67, when the document management program 21 receives and stores the document 11 and the ACL 12, the document management program 21 sends the document 11 and the ACL 12 to the document protecting program 711 and receives the secured document 13.

That is, the document protecting program 711 receives the ACL 12 from the document management program 21 and generates the secure document 13 from the document 11 so as to apply the same restriction indicated by the access authorization set in the ACL 12 to the document 11.

Operations of the document protecting program 711 and the document protecting/printing system 7001 will be described with FIG. 67. FIG. 67 is a diagram showing a configuration example of the document protecting/printing system according to the seventh embodiment of the present invention. A case in that the secured document 13 is used to securely print out the document 11.

The document protecting/printing system 7001 includes the electronic file management apparatus 701, a print terminal 702, a printer 703, and an access control server 704.

Each of the electronic file management apparatus 701 and the print terminal 702 can be applied to a computer terminal including a display unit (for example, an LCD (Liquid Crystal Display), an input unit (for example, a keyboard), an external storage unit (for example, an FDD (Floppy Disk Device), an HDD (Hard Disk Device), or a like). It should be noted that the electronic file management apparatus 701 implements the document protecting program 711 and the print terminal 702 implements a document printing program 721.

The document protecting program 711 is a program to set a print requirement to a document file (hereinafter, simply called a document) in response to an input operation by a distributor using the electronic file management apparatus 701, encrypt the document using an encryption algorithm (for example, an RC4, Triple DES, IDEA), and generates the secured document 13.

As a print requirement which the document protecting program 711 sets to the document in response to the input operation of the administrator, for example, a BDP (Background Dot Pattern), a PAC (Private Access), a DWM (Digital Watermark), an EBC (Embedding Barcode), or an SLS (Security Label Stamp) may be required.

The document printing program 721 is a program to decrypt the secured document 13 in response to an input operation by a user, and to have the printer 703 execute a process in accordance with the print requirement.

When the user attempts to print out the document, the access control server 704 refers to the ACL 12 in response to a request from the document printing program 721, determines whether or not the user is authorized to print out the document, and obtains the print requirement.

The access control server 704 is connected to a user database 741 for storing information (a combination of user name and password) for authenticating each user and an ACL database 742 for registering the ACL including the print requirement defined to each user.

When the document protecting program 711 obtains the ACL 12, the document protecting program 711 generates the document ID (Document ID) identical for each document and the encryption key (Key) used to encrypt and decrypt the document, associates the document ID and Key with the ACL 12, and sends to the access control server 704 to register to the ACL database 742.

Also, the document protecting program 711 encrypts the document 11 by using the encryption key as shown in FIG. 69, and provides the document ID to the document (encrypted document) and then generates the secured document 13.

When the secured document 13 is generated, the document management program 21 associates the secured document 13 with the document 11 and the ACL 12, and stores the secured document 13, the document 11, and the ACL 12 in the document management DB 23. Then, the electronic file management apparatus 701 manages the document 11 and the secured document 13 as a document pair by providing the ACL 12.

Next, a case in that the electronic file management apparatus 701 receives the access request from the user for the document pair managed therein will be described with reference to FIG. 66B and FIG. 67.

When the document management program 21 receives the access request from the user with respect to the document pair, the document management program 21 conducts a user authentication. In the user authentication, the document management program 21 determines whether or not the user is authorized to read the document 11, by referring to the ACL 12 provided to the document pair. When it is determined that the user authorized to read the document 11, the document management program 21 provides the secured document 13 to the user. That is, the electronic file management apparatus 701 displays information concerning the secured document 13 at the display unit.

As a result of the user authentication, when the user who accessed to the document 11 is not authorized to read the document 11, that is, when the document management program 21 determines that the user is not authorized to read the document 11, the document management program 21 displays a message at the display unit.

In the document protecting/printing system 7001 shown in FIG. 67, decryption of the secured document 13 will be described.

As an output from the electronic file management apparatus 701 with respect to the user who attempts to print out and read the document 11, a case of providing by the administrator the information recording medium such as an FD and a case of sending to the print terminal 702 through a network are shown in the document protecting/printing system 7001 shown in FIG. 67.

In a case in that the user attempts to print out the document 11, the secured document 13 is implemented to the print terminal 702. For example, the print terminal 702 may read out the secured document 13, which is output from the electronic file management apparatus 701 to the information recording medium by using the external storage unit. Alternatively, in a case in that the print terminal 702 connects with the electronic file management apparatus 701 through a network, the secured document 13 may be output from the electronic file management apparatus 701 to the print terminal 702 through the network.

When the user indicates the document printing program 721 to print out the document by using the input unit of the print terminal 702, the document printing program 721 requires the user to input the password necessary to authenticate the user. For example, the document printing program 721 displays a message at the display unit of the print terminal 702 to require the user to input the password.

The document printing program 721 requires the access control server 704 to authenticate the user by sending the user name and the password.

The access control server 704 authenticates the user by using the user name and the password received from the document printing program 721 and then specifies the user.

When the access control server 704 specifies the user, the access control server 704 refers to the ACL database 742, determines whether or not the user is authorized to print out the document, and obtains the print requirement when the user prints out the document 11.

When it is determined that the user is authorized to print out the document, the access control server 704 sends authentication information showing an authentication result, the encryption key to decrypt the secured document 13, and an the print requirement when the user prints out the document 11, to document printing program 721 the through the print terminal 702.

When the document printing program 721 receives the authentication information, the encryption key, and the print requirement from the access control server 704, the document printing program 721 decrypts the secured document by using the encryption key and then restores the document.

Then, the document printing program 721 controls the printer 703 to conduct the printing process so as to satisfy the print requirement. For example, in a case in that the BDP is set to the document as the print requirement, the printer 703 prints out contents of the document while printing out the background dot pattern.

As described above, when the document 11 is printed out, it is possible for the administrator to enforce the print requirement set by the administrator with respect to each user. That is, it is possible for the administrator to enforce restriction by the access authorization as the ACL 12 set to each user.

Next, a functional configuration realized by the document management program 21 according to the seventh embodiment will be described with reference to FIG. 68. FIG. 68 is a diagram showing the functional configuration realized by the document management program according to the seventh embodiment of the present invention. In FIG. 68, client terminal c1 and c2 may be the same client terminal.

In FIG. 68, the document management program 21 realizes at least a document repository request accepting part 21a, a document repository part 21b, a secured document obtaining part 21c, a document reference request accepting part 21d, and a document obtaining part 21e.

When the document repository request accepting part 21a receives a document repository request with the document 11 and the ACL 12 from the client terminal c1 requesting storing the document 11, the document repository request accepting part 21a sends the document 11 and the ACL 12 to the document repository part 21b.

The document repository part 21b stores the document 11 in the document management DB 23, and sets the ACL 12 received from the document repository request accepting part 21a as the ACL 12 of the document 11. The document repository part 21b provides a document ID identifying the document 11 to the document repository request accepting part 21a.

When the document repository request accepting part 21a receives the document ID from the document repository part 21b, the document repository request accepting part 21a sends the document 11, the ACL 12, and the document ID to the secured document obtaining part 21c. The secured document obtaining part 21c sends the document 11 and the ACL 12 to the document protecting program 711, receives the secured document 13, and sends the document ID and the secured document 13 to the document repository part 21b.

The document repository part 21b stores the secured document 13 by associating with the document 11 specified by the document ID.

The document repository request accepting part 21a sends the document ID to the client terminal c1 which sent the document repository request. A timing of sending the document ID may be immediately after the document 11 is stored, or may be after it is confirmed that the secured document 13 is stored.

In addition, when the document reference request accepting part 21d receives the document reference request with the document ID from the client terminal c2 requesting of referencing to the document 11, the document reference request accepting part 21d sends the document ID to the document obtaining part 21e.

The document obtaining part 21e confirms the ACL 12 corresponding to the document 11 from the document management DB 23 based on the document ID. When the user having a reference authorization requested, the document obtaining part 21e obtains the secured document 13 stored with the document 11 in the document management DB 23, and provides to the document reference request accepting part 21d.

The document reference request accepting part 21d provides the secured document 13 to the client terminal c2 which sent the document reference request. When the user using the client terminal c2 does not have a reference authorization, the document reference request accepting part 21d sends an error message to the client terminal c2. On the other hand, when the user is authorized to refer to the document 11 that is original, the document 11 itself may be sent to the client terminal c2, instead of sending the secured document 13.

Next, operations of the document protecting program 711 and the access control server 704 in a case in that the secured document 13 is generated from the document 11 will be described. Also, operations of the document printing program 721 and the access control server 704 in a case in which the document 11 is decrypted from the secured document 13 and printed out will be described.

First, operations for the document protecting program 711 to generate the secured document 13 will be described.

In FIG. 69, when the document protecting program 711 obtains the document 11 and the ACL 12 by an input operation of the administrator at the input unit of the electronic file management apparatus 701, the document protecting program 711 generates the encryption key used to encrypt and decrypt the document 11. Subsequently, the document protecting program 711 encrypts the document 11 by using the encryption key and generates an encrypted document.

Furthermore, the document protecting program 711 attaches the document ID identical for each document 11, and generates the secured document 13.

After the secured document 13 is generated, the document protecting program 711 sends the encryption key, the ACL 12, and the document ID to the access control server 704 by using a communication function of the electronic file management apparatus 704, and requests the access control server 704 to register the encryption key, the ACL 12, and the document ID.

When the access control server 704 receives the encryption key, the ACL 12, and the document ID from the document protecting program 711, as shown in FIG. 17 in the second embodiment, the access control server 701 records and maintains the encryption key, the ACL 12, and the document ID as a single record by associating these information with each other. The ACL database 742 manages the encryption key (key) and the ACL 12 for each document ID (Document ID).

As described above, the document protecting program 711 generates the document ID and the encryption key. Alternatively, these processes can be conducted by the access control server 704 or another server (not shown) for generating the document ID and the encryption key.

If the electronic file management apparatus 701 is not connected to the access control server 704 by a dedicated line but connected through a network and if it is concerned that the encryption key is intercepted while being sent to the access control server 704, a communication should be conducted by using a SSL (Secure Socket Layer).

A protocol for the document protecting program 711 to communicate with the access control server 704 can be any protocol. For example, a distributed object environment can be installed and information may be sent and received on a basis of Java® RMI (Remote Method invocation) and a SOAP (Simple Object Access Protocol). In this case, for example, the access control server 704 may implement a method such as “register(String docId, byte[ ] key, byte[ ] acl)”. If the SOAP is implemented, a message is exchanged by the SOAP on an HTTPS. If the RMI is implemented, by executing the RMI using a SocketFactory of an SSL base, the security on the network can be maintained.

Next, the operation in a case in that the document printing program 721 prints out the secured document 13 will be described.

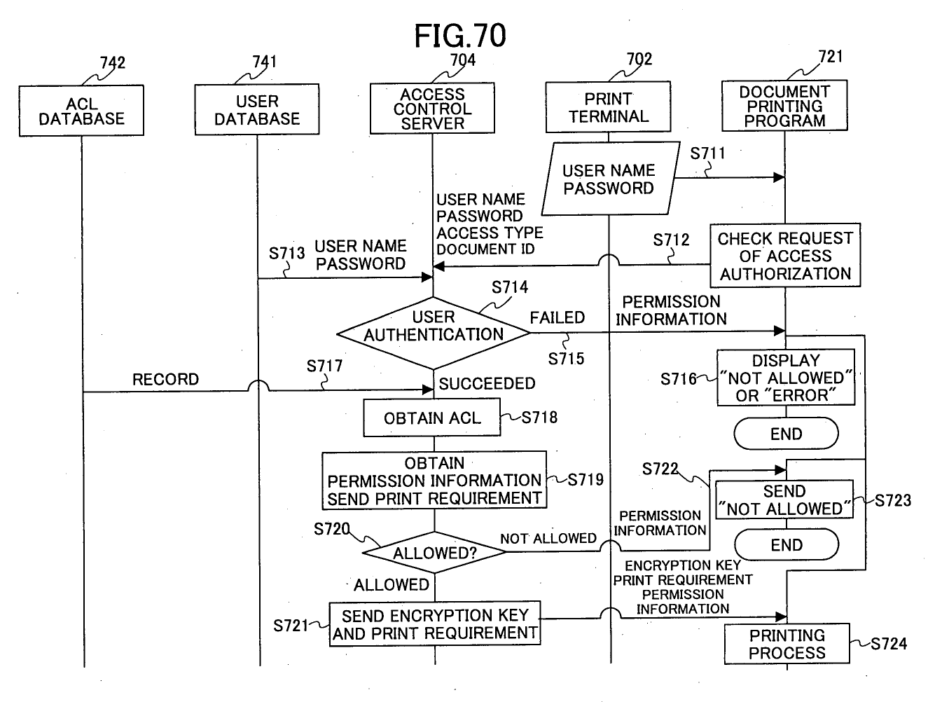

FIG. 70 is a diagram showing the operations of the document printing program and the access control server when the secure document is printed out, according to the seventh embodiment of the present invention.

When the document printing program 721 obtains the user name and password by the input operation of the user at the input unit of the print terminal 702, the document printing program 721 obtains the document ID attached with the secured document (step S711).

Subsequently, the document printing program 721 sends the user name, the password, the document ID, the access type and requests the access control server 704 to check whether or not the user has the access authorization (step S712). The access type is information showing a process requested by the user. In this case, the access type shows “print” since the user attempts to print out the secured document.

Similar to the second embodiment, the enquiry example by the SOAP to the access control server is applied as shown in FIG. 22. Referring to FIG. 22, a SOAP 291 including the user name (userId), the document ID (docId), and the access type (accessType) is sent to enquire whether or not the access is allowed to the user. And a SOAP 292 showing a result (isAllowedReponse) is received. The result shows that the user is allowed (“allowed” indicates “true”) and the result includes a requirement (“requirement”).

When the access control server 704 receives the user name, the password, the document ID, and the access type, the access control server 704 refers to information registered in the user database 741 (step S713) and conducts the user authentication (step S714).

That is to say, the access control server 704 refers to the information registered in the user database 741 and determines whether or not the combination of the user name and the password included in the information obtained from the document printing program 721 is registered in the user database 741.

When the user authentication is failed (that is to say, the combination of the user name and the password included in the information received from the document printing program 721 is registered), the access control server 704 sends the permission information (information showing whether or not the process requested by the user is allowed) as “NOT ALLOWED” to the print terminal 702, and sends to the document printing program 721 (step S715). In this case, the permission information showing “ERROR” may be sent to the document printing program 721. The document printing program 721 displays “NOT ALLOWED” or “ERROR” at the display unit of the print terminal 702 (step S716).

On the other hand, when the user authentication is succeeded, the access control server 704 reads out a record concerning the document ID included in the information obtained from the document printing program 721 from records stored in the ACL database 742 (step S717).

The access control server 704 obtains the ACL included in the record read out from the ACL database 742 (step S718), and obtains the permission information and the print requirement from the ACL based on the user name and the access type obtained from the document printing program 721 (step S719).

That is to say, the access control server 704 obtains the permission information and the print requirement that are set beforehand, based on the user name and the access type.

Then, the access control server 704 determines whether or not the user is allowed (step S720). When the permission information obtained from the ACL shows “ALLOWED”, the access control server 704 sends the encryption key and the print requirement stored in the record with the permission information to the print terminal 702 to provide to the document printing program 721 (step S721).

On the other hand, when the permission information obtained from the ACL shows “NOT ALLOWED”, the access control server 704 sendss only the permission information to the print terminal 702 to provide to the document printing program 721 (step S722).

When the document printing program 721 receives the permission information received from the access control server 704, the document printing program 721 refers to the permission information. When the permission information shows “NOT ALLOWED”, the document printing program 721 displays a message at the display unit of the print terminal 702 to notify the user that the process requested by the user can not be conducted (step S723).

On the other hand, when the permission information shows “ALLOWED”, the document printing program 721 decrypts the encrypted document being a portion of the secured document 13 so as to restore the document.

Next, the document printing program 721 sets the printer driver so as to satisfy the print requirement set to the document and controls the printer 703 to conduct the printing process with respect to the document (step S724). For example, if the PAC is indicated as the print requirement, the document printing program 721 sets the private access mode.

If necessary, the document printing program 721 displays a message at the display unit of the print terminal 702 to require the user to set print parameters.

If the printer 703 can not conduct the printing process so as to satisfy the print requirement, that is, if the printer 703 does not implement a function satisfying the print requirement set to the ACL 12, the document printing program 721 displays a message at the display unit of the print terminal 702 to inform the user, and terminates the operation without the printing process.

By the above described operations, it is possible to set the access authorization and the print requirement for each user. Moreover, as described above, in a system configuration in that the access authorization with respect to the document is determined at a side of the access control server 704, contents of the ACL 12 registered in the ACL database 742 can be updated by the input operation at the electronic file management apparatus 701 or the access control server 704. In this case, after the secured document is distributed, the print requirement can be updated.

For example, it is possible to set the access authorization with respect to the secured document 13, which has been already distributed, to a new user, and it is possible to add the print requirement to a specific user.

If a person, who knows that the document protecting/printing system 7001 according to the seventh embodiment shown in FIG. 67 secures the document by the above described technology, may execute a program behaving like the document printing program 721 at a computer terminal and may illegally obtain the encryption key. Then, the person can decrypt the secured document 13. In this case, the print requirement set as the ACL 12 will not be enforced, and the secured document 13 can be unlimitedly printed out.

Therefore, instead of simply encrypting the document by using only the encryption key, it is preferred to encrypt the document by using a combination of the secret key embedded in the document protecting program 711 and the encryption key.

In this case, by embedding the same secret key in the document printing program 721, it is possible to limit only the document printing program 721 that enforces the print requirement set by the distributor, to decrypt and print out the secured document 13.

In the document protecting/printing system 7001 shown in FIG. 67, the document printing program 721 conducts processes related to printing out the document 11. Alternatively, the document printing program 721 may display contents of the document 11, and may have a function for editing the document 11. For example, this function can be realized as a plug-in of Adobe Acrobat®.

In the electronic file management apparatus 701 according to the seventh embodiment, for example, “GetOriginal” (access authorization to an original electronic file) may be additionally defined as the “Access type” in the ACL 12. When the user who has an access authorization for “GetOriginal” accesses the document pair, the document protecting program 711 may provide the document 11, instead of the secured document 13.

That is, the electronic file management apparatus 701 conducts the user authentication based on the ACL defining “GetOriginal”.

Alternatively, the access authorization to the document 11 as the original electronic file may not be defined in the ALC 12. In this case, a special user (for example, user who stored the document 11) may be allowed to have the access authorization to the document 11. That is, the document protecting program 711 allows only a special user defined beforehand to have the access authorization to the document 11.

According to the present invention, it is possible to maintain a consistency of an access control (restriction of the access authorization) with respect to the document 11 maintained and stored by the document management program 21, and another access control with respect to the document 11 (portable document) provided from the user (output from the electronic file management apparatus 701).

The administrator sets the restriction of the access authorization as the ACL 12. And the administrator only operates the electronic file management apparatus 701 by using the input unit so as to provide the document 11 and the ACL 12 to the document protecting program 711. The administrator can control the electronic file management apparatus 701 to manage the secured document 13 to provide to the user based on the access authorization set by the administrator.

That is, once the administrator defines the restriction of the access authorization as the ACL 12, the electronic file management apparatus 701 manages to output the document 11 to the display unit or an external storage unit by the restriction of the access authorization.

Moreover, by defining the access authorization for the original electronic file, the electronic file management apparatus 701 can enforce a management in accordance with the restriction of the access authorization with respect to the document 11 and the secured document 13. That is, the electronic file management apparatus 701 can manage to output the document 11 or/and the secured document 13 in accordance with the access authorization defines as the ACL 12.

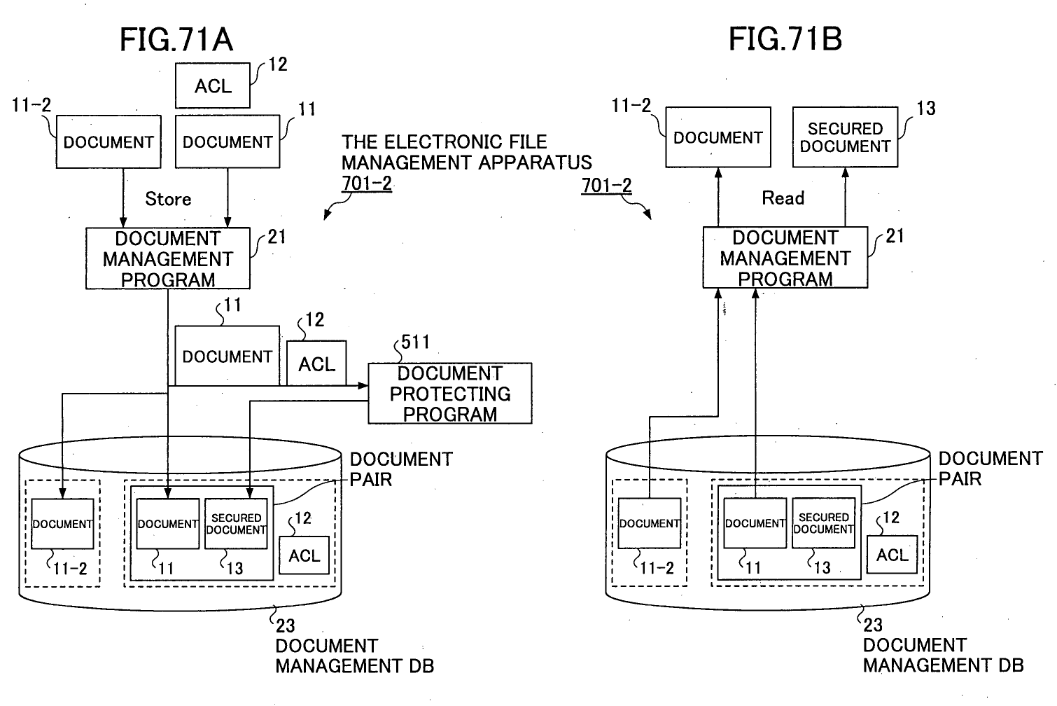

A modification of the electronic file management apparatus 701 shown in FIG. 66A and FIG. 66B will be described with reference to FIG. 71A and FIG. 71B. FIG. 71A and FIG. 71B are diagrams showing the modification of the electronic file management apparatus according to the seventh embodiment of the present invention. In the electronic file management apparatus 701 shown in FIG. 66A and FIG. 66B, a document 11-2 that is the original electronic file can be also stored alone.

In an electronic file management apparatus 701-2 in FIG. 71A, in a case in which the document management program 21 receives only the document 11-2, the document management program 21 directly stores the document 11-2 in the document management DB 23. In the electronic file management apparatus 701-2 in FIG. 71B, when the document file management program 21 receives the access request of the document 11-2 (but not the document pair) from the user, the document file management program 21 displays the document 11-2 at the display unit in response to the access request. In this case, the user authentication can be conducted but a read authorization of the user by comparing with the ACL 12 is not be determined.

### Eighth Embodiment

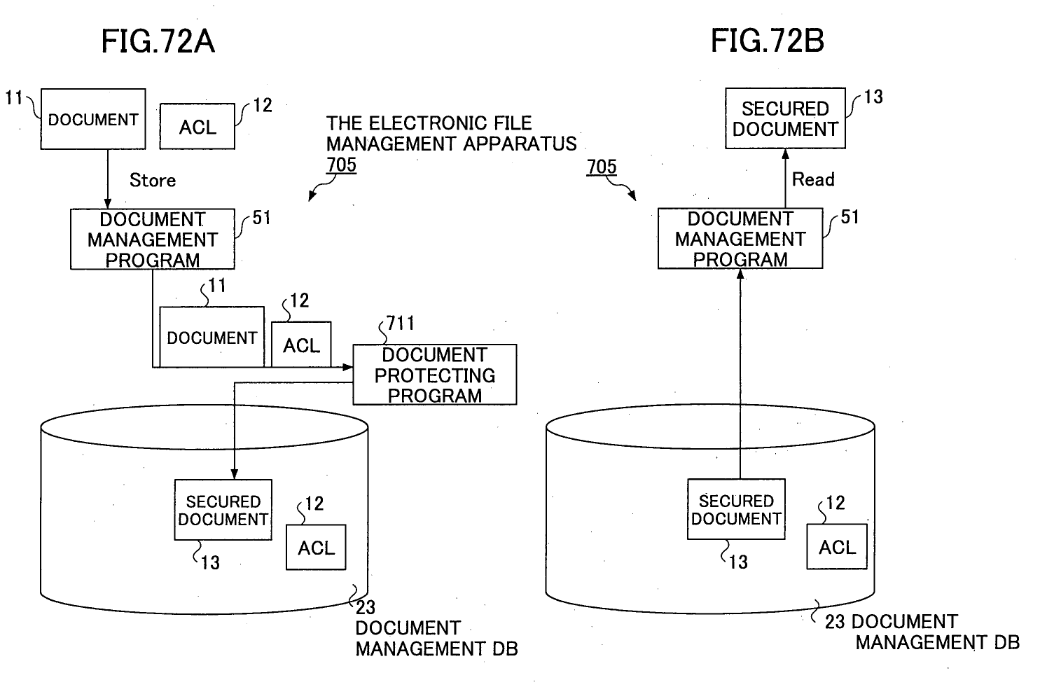

Next, an electronic file management apparatus 705 according to an eighth embodiment of the present invention will be described with reference to FIG. 72A and FIG. 72B. FIG. 72A and FIG. 72B are diagrams showing the electronic file management apparatus according to the eighth embodiment of the present invention.

In the electronic file management apparatuses 701 and 701-2 in the seventh embodiment, the document management program 21 associates the document 11 and the secured document 13 (document pair) with the ACL 12. In the electronic file management apparatuses 705, instead, the secured document 13 is stored but the document 11 is deleted.

That is, in the seventh embodiment, if the document 11 remains and the user, who authorized to access the document 11, accesses the document 11, the document 11 that is not protected can be distributed without any restriction. In such a circumstance, the electronic file management apparatus 705 according to the eighth embodiment of the present invention can be applied and the secured document 13 can be preferably managed.

A physical configuration of the electronic file management apparatus 705 in the eighth embodiment is the same as that of the electronic file management apparatus 701 in the seventh embodiment. As shown in FIG. 72A and FIG. 72B, the electronic management apparatus 705 includes a storing part (not shown) such as an HDD (Hard Disk Drive) including a document management file program 51, the document protecting program 711, and a document management DB 23.

In the FIG. 72A and FIG. 72B, parts that are the same as those shown in the previously described figures are given the same reference numbers and the explanation thereof will be omitted.

Operations in that the document protecting program 711 generates the secured document 13 from the document 11, and decrypts the secured document 13 accessed by the user to print out at the printer 703 are the same as described above.

Operations of the electronic file management apparatus 705 will be described with reference to FIG. 72A according to the eighth embodiment of the present invention.

When the user operates the input unit to provide and store the document 11 and the ACL 12 to the document management program 51, the document management program 51 sends the document 11 and the ACL 12 to the document protecting program 711. That is, the document protecting program 711 generates the secured document 13.

When the document management program 51 receives the secured document 13, the document management program 51 stores the secured document 13 to the document management DB 23, and deletes the document 11 and the ACL 12.

Operations in that the electronic file management apparatus 705 receives the access request from the user with respect to the document will be described with reference to FIG. 72B.

When the document management program 51 receives the access request to the document, the document management program 51 provides the secured document 13 stored in the document management DB 23. That is, the electronic file management apparatus 705 displays information of the secured document 13 at the display unit.

In the eighth embodiment, after the document 11 is deleted and the user reads the secured document 13, the access control can be conducted in accordance with the ACL 12. Therefore, the document management program 51 is not required to conduct the access control.

However, if the secured document 13 is obtained to be decoded, the secured document 13 can be accessed and modified. In order to reduce that possibility, similar to the seventh embodiment, when the document management program 51 stores the secured document 13 in the document management DB 23, the secured document 13 is associated with the ACL 12 and stored in the document management DB 21, and then the access control is conducted based on the ACL 12. That is, when the document 11 is deleted, the document management program 51 may store the document 11 in the document management DB 23 by associating with the secured document 13, instead of deleting the document 11.

According to the present invention, it is possible to maintain a consistency of an access control (restriction of the access authorization) with respect to the document 11 maintained and stored by the document management program 51, and another access control with respect to the document 11 (portable document) provided from the user (output from the electronic file management apparatus 705).

According to the eighth embodiment, by deleting the document 11 that is not encrypted, it is possible to improve the security of documents managed in the document protecting/printing system 7001.

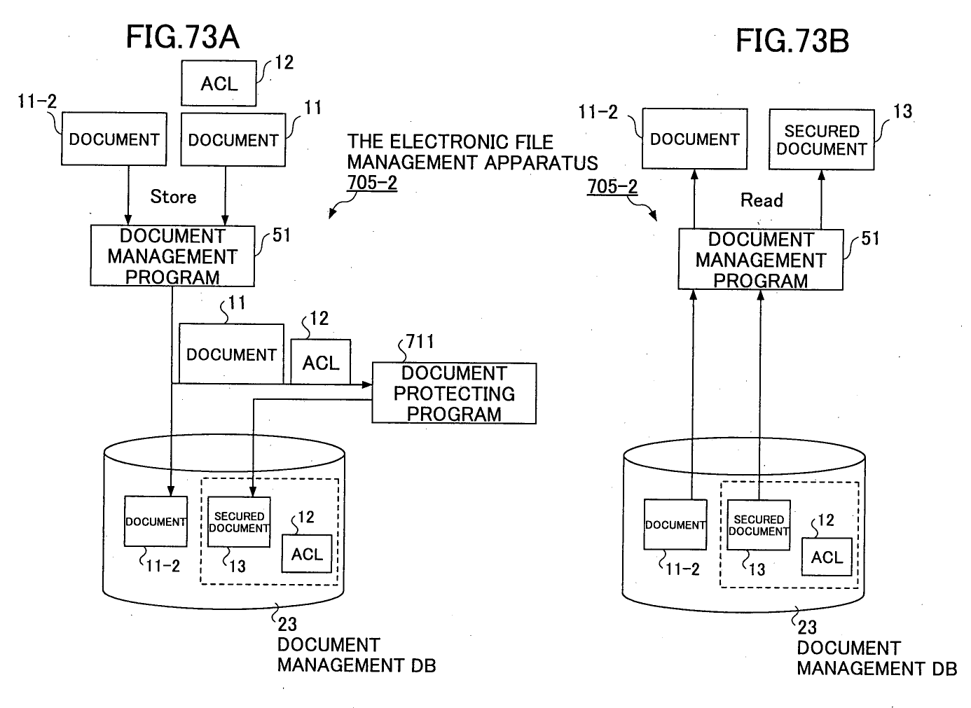

A modification of the electronic file management apparatus 705 shown in FIG. 72A and FIG. 72B will be described with reference to FIG. 73A and FIG. 73B. FIG. 73A and FIG. 73B are diagrams showing the modification of the electronic file management apparatus according to the seventh embodiment of the present invention. In the electronic file management apparatus 701 shown in FIG. 72A and FIG. 72B, a document 11-2 that is the original electronic file can be also stored alone.

In an electronic file management apparatus 705-2 in FIG. 73A, in a case in which the document management program 51 receives only the document 11-2, the document management program 51 directly stores the document 11-2 in the document management DB 23. In the electronic file management apparatus 705-2 in FIG. 73B, when the document file management program 51 receives the access request of the document 11-2 (but not the document pair) from the user, the document file management program 51 displays the document 11-2 at the display unit in response to the access request. In this case, the user authentication can be conducted but a read authorization of the user by comparing with the ACL 12 is not be determined.

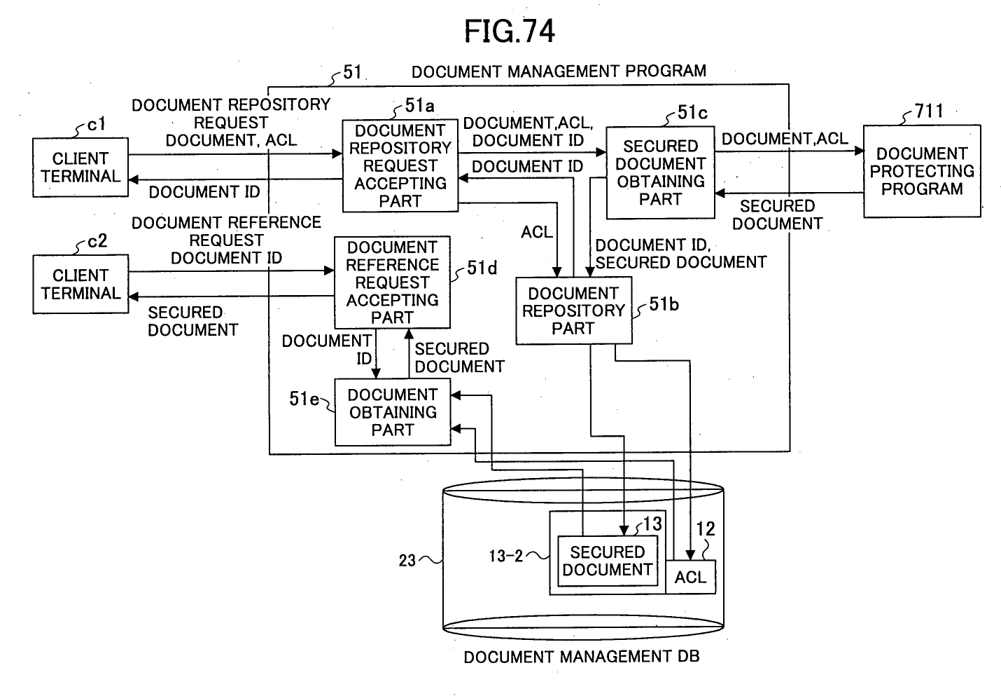

Next, a functional configuration realized by the document management program 51 according to the eighth embodiment will be described with reference to FIG. 74. FIG. 74 is a diagram showing the functional configuration realized by the document management program according to the eighth embodiment of the present invention. In FIG. 74, client terminal c1 and c2 may be the same client terminal.

In FIG. 74, different from the document management program 21 shown in FIG. 68, the original document 11 is not managed in the document management DB 13. The document management program 51 realizes at least a document repository request accepting part 51a, a document repository part 51b, a secured document obtaining part 51c, a document reference request accepting part 51d, and a document obtaining part 51e.

The document repository request accepting part 51a sends the ACL 12 alone to the document repository part 51b but does not send the document 11, and obtains the document ID. In the document management program 51, an empty document area 13-2 where only the ACL 12 is set is created in the document management DB 23, and the secured document 13 is stored in the empty document area 13-2.

The secured document obtaining part 51c, the document reference request accepting part 51d, and the document obtaining part 51e operate similar to the secured document obtaining part 21c, the document reference request accepting part 21d, and the document obtaining part 21e and therefore explanation thereof will be omitted.

Instead of creating the empty document area 13-2, after the secured document 13 is created, the secured document 13 is stored in the empty document area 13-2.

In this case, since the document management program 51 is a program to maintain only the secured document 13, the document management program 51 is activated in the same computer as the document protecting program 711.

### Ninth Embodiment

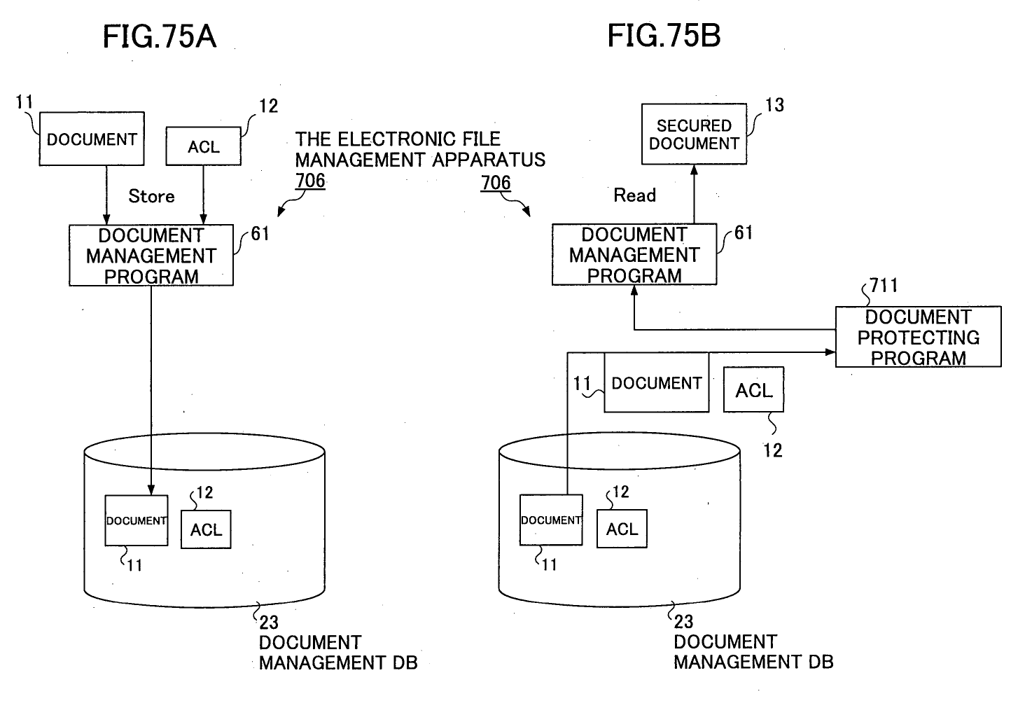

Next, an electronic file management apparatus 706 will be described with reference to FIG. 75A and FIG. 75B. FIG. 75A and FIG. 75B are diagram showing the electronic file management apparatus according to the ninth embodiment of the present invention.

In the seventh embodiment, the document protecting program 711 generates the secured document 13, and stores the document 11 and the secured document 13 (document pair) by associating with the ACL 12. However, in the ninth embodiment, a document management program 61 stores the document 11 by associating with the ACL 12, and the document protecting program 711 generates and outputs the secured document 13 when the document protecting program 711 receives the access request from a user.

That is, if the seventh embodiment is applied, an extra disk area is required to always maintain the secured document 13. Accordingly, in the ninth embodiment, the secured document 13 is dynamically generated when an access to the secured document 13 is requested by the user. Since the extra disk area for the secured document 13 is not always required, it is possible to minimize the disk area for the secured document 13.

A physical configuration of the electronic file management apparatus 706 in the ninth embodiment is the same as that of the electronic file management apparatus 701 in the seventh embodiment. As shown in FIG. 75A and FIG. 75B, the electronic file management apparatus 706 includes a storing part (not shown) such as an HDD (Hard Disk Drive) including a document management file program 61, the document protecting program 711, and a document management DB 23.

Operations in that the document protecting program 711 generates the secured document 13 from the document 11, and decrypts the secured document 13 accessed by the user to print out at the printer 703 are the same as described above.

Operations in that the electronic file management apparatus 706 stores the electronic file will be described with reference to FIG. 75B.

When the user operates to store the document 11 and the ACL 12 by document management program 61 by using the input unit, the document management program 61 attaches the ACL 12 with the document 11 and stores the document 11 in the document management DB 23.

Operations in that the electronic management apparatus 706 receives the access request with respect to the document 11 from the user will be described with reference to FIG. 75B.

When the document management program 61 receives the access request to the document 11, the document management program 61 determines whether or not the user has the access authorization based on the ACL 12 attached to the document 11. When the user has the access authorization, the document management program 61 retrieves the document 11 and the ACL 12 from the document management DB, and sends to the document protecting program 711. Then, the document management program 61 receives the secured document 13 generated as described above, and sends the secured document 13 to the document management program 61. That is, the electronic file management apparatus 706 display the secured document 13 at the display unit.

In the ninth embodiment, similar to the seventh embodiment, “GetOriginal” (access authorization to an original electronic file) may be additionally defined as the “Access type” in the ACL 12. Then, the electronic file management apparatus 706 conducts the user authentication. When the user who has an access authorization for “GetOriginal” accesses the document pair, the document protecting program 711 may provide the document 11, instead of the secured document 13.

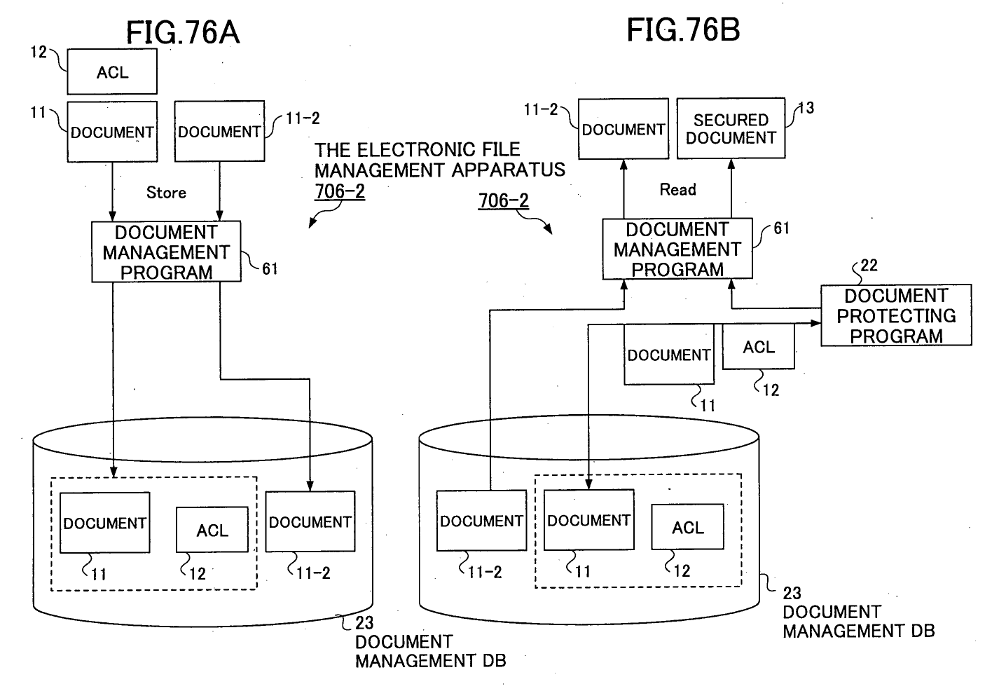

A modification of the electronic file management apparatus 706 shown in FIG. 75A and FIG. 75B will be described with reference to FIG. 76A and FIG. 76B. FIG. 76A and FIG. 76B are diagrams showing the modification of the electronic file management apparatus according to the seventh embodiment of the present invention. In the electronic file management apparatus 706 shown in FIG. 76A and FIG. 76B, a document 11-2 that is the original electronic file can be also stored alone.

In an electronic file management apparatus 706-2 in FIG. 76A, in a case in which the document management program 61 receives only the document 11-2, the document management program 61 directly stores the document 11-2 in the document management DB 23. In the electronic file management apparatus 706-2 in FIG. 76B, when the document file management program 61 receives the access request of the document 11-2 (but not the document pair) from the user, the document file management program 61 displays the document 11-2 at the display unit in response to the access request. In this case, the user authentication can be conducted but a read authorization of the user by comparing with the ACL 12 is not be determined. In this case, the user authentication can be conducted but a read authorization of the user by comparing with the ACL 12 is not be determined.

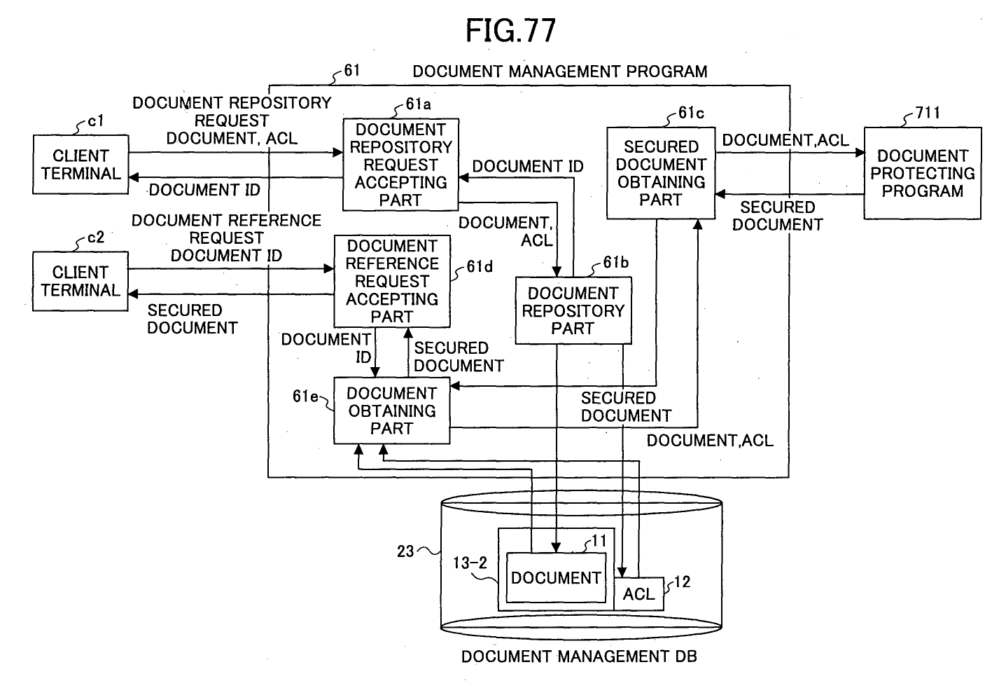

Next, A functional configuration realized by the document management program 61 according to the ninth embodiment will be described with reference to FIG. 77. FIG. 77 is a diagram showing the functional configuration realized by the document management program according to the ninth embodiment of the present invention. In FIG. 77, client terminal c1 and c2 may be the same client terminal.

In FIG. 77, instead of generating the secured document 13 beforehand, the document management program 61 dynamically generates the secured document 13 when receiving the access request from the user. The document management program 61 realizes at least a document repository request accepting part 61a, a document repository part 61b, a secured document obtaining part 61c, a document reference request accepting part 61d, and a document obtaining part 61e.

When the document repository request accepting part 61a receives the document repository request, the document 11, and the ACL 12, the document repository request accepting part 61a sends document 11 and the ACL 12 to the document repository part 61b.

The document repository part 61b stores the document 11 in the document management DB 23, sets the ACL 12 to the document 11 stored in the document management DB 23, and send the document ID identifying the document 11 to the document repository request accepting part 61a.

And the document repository request accepting part 61a sends the document ID to the client terminal c1 that conducted the document repository request.

When the document reference request accepting part 61d receives the document reference request with the document ID from the client terminal c2 that conducts the document reference request, the document reference request accepting part 61d sends the document ID to the document obtaining part 61e.

The document obtaining part 61e refers to the ACL 12 attached with the document 11 corresponding to the document ID from the document management DB 23 and determines whether or not the user conducting the access request has the reference authorization. When the user having the reference authorization requested, the document obtaining part 61e obtains the document 11 in the document management DB 23. The document obtaining part 61e sends the document 11 and the ACL 12 to the secured document obtaining part 61c.

The secured document obtaining part 61c sends the document 11 and the ACL 12 to the document protecting program 711, receives the secured document 13 from the document protecting program 711, and sends the secured document 13 to the secured document obtaining part 61c.

The secured document obtaining part 61c sends to the secured document 13 to the document obtaining part 61c. The document obtaining part 61e sends the secured document 13 to the document reference request accepting part 61d.

The document reference request accepting part 61d sends the secured document 13 to the client terminal c2.

When the user is not authorized to refer to the document 11, the user can not access the secure document 13. Thus, a process to confirm the access authorization can be eliminated and the secured document 13 may be provided to anyone. However, even if the document 11 is encrypted, once the secure document 13 is provided to anyone, the secured document 13 can be forced to be decrypted. Therefore, the secured document 13 should not be provided so that the user who does not have the access authorization can not access even the secured document 13.

According to the present invention, it is possible to maintain a consistency of an access control (restriction of the access authorization) with respect to the document 11 maintained and stored by the document management program 61, and another access control with respect to the document 11 (portable document) provided from the user (output from the electronic file management apparatus 706).

Moreover, the disk area can be reduced by an area for the secured document 13. Therefore, it is possible to realize the document protecting/printing system 7001 even if a capacity of the disk is relatively small.

### Tenth Embodiment

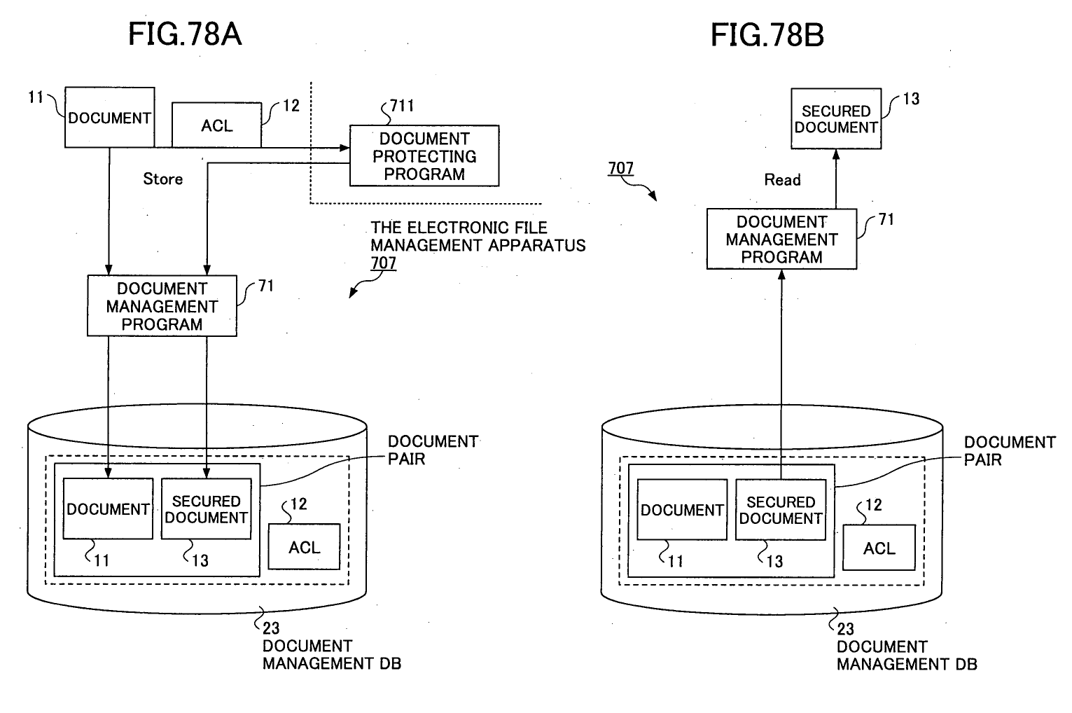

Next, an electronic file management apparatus 707 according to a tenth embodiment of the present invention will be described with reference to FIG. 78A and FIG. 78B. FIG. 78A and FIG. 78B are diagrams showing the electronic file management apparatus according to the tenth embodiment of the present invention.

In the first embodiment, the document protecting program 711 generates the secured document 13 and the document 11 and the secured document 13 (document pair) are stored in the document management DB 23 by associating with the ACL 12. In the electronic file management apparatus 707 according to the tenth embodiment, a document management program 71 instructs the document protecting program 711 to generate and store the secured document 13 beforehand, and stores the document 11 and the secured document 13 (document pair) by associating with the ACL 12 in the document management DB 23.

That is, in a case in which the electronic file management apparatus 707 internally executes the document protecting program 711, a process performance may be deteriorated. However, in the tenth embodiment, since the document protecting program 711 protects the document 11 to generate the secured document 13 beforehand, it is possible to properly manage the document 11 and the secured document 13.

A physical configuration of the electronic file management apparatus 707 in the tenth embodiment is the same as that of the electronic file management apparatus 701 in the seventh embodiment. As shown in FIG. 78A and FIG. 78B, the electronic file management apparatus 707 includes a storing part (not shown) such as an HDD (Hard Disk Drive) including a document management file program 71, the document protecting program 711, and a document management DB 23.

In the FIG. 78A and FIG. 78B, parts that are the same as those shown in the previously described figures are given the same reference numbers and the explanation thereof will be omitted.

Operations in that the document protecting program 711 generates the secured document 13 from the document 11, and decrypts the secured document 13 accessed by the user to print out at the printer 703 are the same as described above.

Operations of the electronic file management apparatus 707 will be described with reference to FIG. 78A according to the tenth embodiment of the present invention.

First, the user provides the document 11 and the ACL 12 to the document protecting program 711 to generate the secured document 13.

The document 11, the ACL 12, and the secured document 13 are sent to the document management program 71. When the user operates the input unit to store the document 11, the ACL 12, and the secured document 13, the document management program 71 stores the document 11 and the secured document 13 in the document management DB 23 by associating with the ACL 12.

Operations in that the electronic management apparatus 707 receives the access request with respect to the document 11 from the user will be described with reference to FIG. 78B.

The document management program 71 receives the access request with respect to the document pair, conducts the user authentication, and determines whether or not the user has the access authorization based on the ACL 12 attached to the document pair. When the user has the access authorization, the document management program 71 sends the secured document 13 stored in the document management DB 23. That is, the secured document 13 is displayed at the display unit of the electronic file management apparatus 707.

In the tenth embodiment, similar to the seventh embodiment, “GetOriginal” (access authorization to an original electronic file) may be additionally defined as the “Access type” in the ACL 12. Then, the electronic file management apparatus 707 conducts the user authentication. When the user who has an access authorization for “GetOriginal” accesses the document pair, the document protecting program 711 may provide the document 11, instead of the secured document 13.

Moreover, in the tenth embodiment, the document protecting program 711 can be implemented in another apparatus, instead of the document protecting program 711. In this case, the secured document 13 is generated from document 11 in the apparatus implementing the document protecting program 711. From the apparatus where the secured document 13 is generated, the document 11, the secured document 13, and the ACL 12 are provided to the electronic file management apparatus 707 through the network or the information recording medium.

Furthermore, instead of providing both the document 11 and the secured document 13 to the document management program 71 to store, only the secured document 13 may be provided but the document 11 may be deleted.

According to the present invention, it is possible to maintain a consistency of an access control (restriction of the access authorization) with respect to the document 11 maintained and stored by the document management program 71, and another access control with respect to the document 11 (portable document) provided from the user (output from the electronic file management apparatus 707).

Moreover, it is possible to avoid a generation of the secured document 13 by the document protecting program 711 so that heavier workload of other processes can not be conducted simultaneously. Therefore, even if the process performance of the electronic file management apparatus 707 is relatively lower, it is possible to properly generate the secured document 13.

Furthermore, by generating the secured document 13 by the document protecting program 711 in another apparatus, workload of generating the secured document 13 can be effectively distributed. Therefore, even if the process performances of the electronic file management apparatus 707 and another apparatus are relatively lower, the secured document 13 can be properly generated.

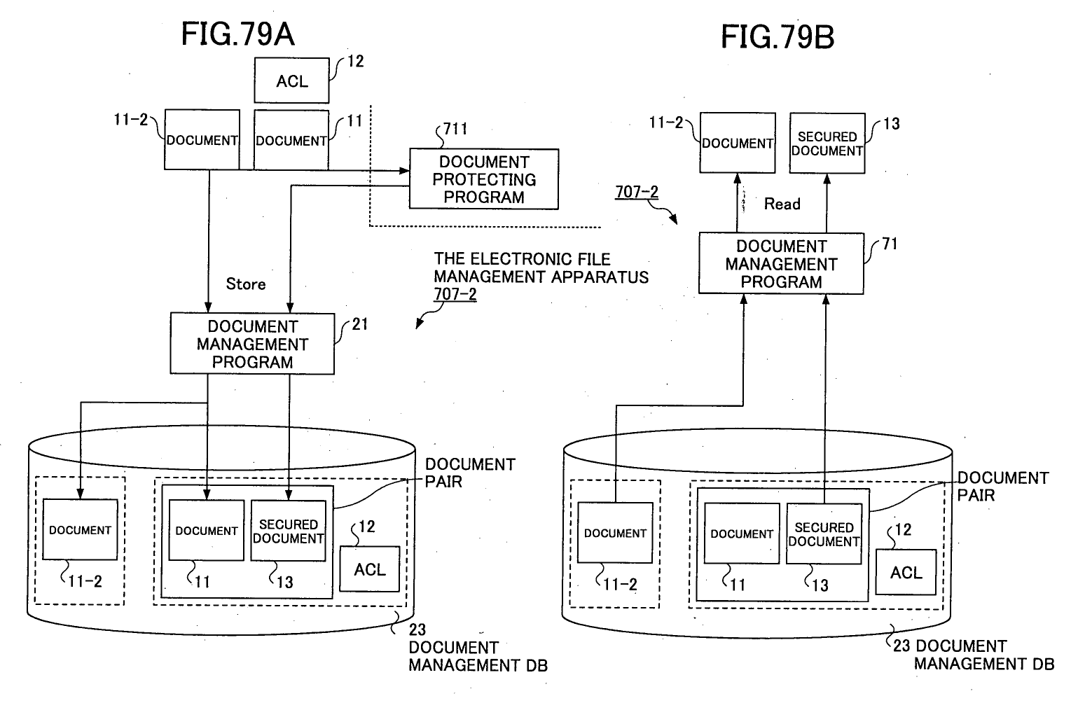

A modification of the electronic file management apparatus 707 shown in FIG. 78A and FIG. 78B will be described with reference to FIG. 79A and FIG. 79B. FIG. 79A and FIG. 79B are diagrams showing the modification of the electronic file management apparatus according to the tenth embodiment of the present invention. In the electronic file management apparatus 707 shown in FIG. 78A and FIG. 78B, a document 11-2 that is the original electronic file can be also stored alone.

In an electronic file management apparatus 707-2 in FIG. 79A, in a case in which the document management program 21 receives only the document 11 -2, the document management program 71 directly stores the document 11-2 in the document management DB 23. In the electronic file management apparatus 707-2 in FIG. 79B, when the document file management program 71 receives the access request of the document 11-2 (but not the document pair) from the user, the document file management program 71 displays the document 11-2 at the display unit in response to the access request. In this case, the user authentication can be conducted but a read authorization of the user by comparing with the ACL 12 is not be determined.

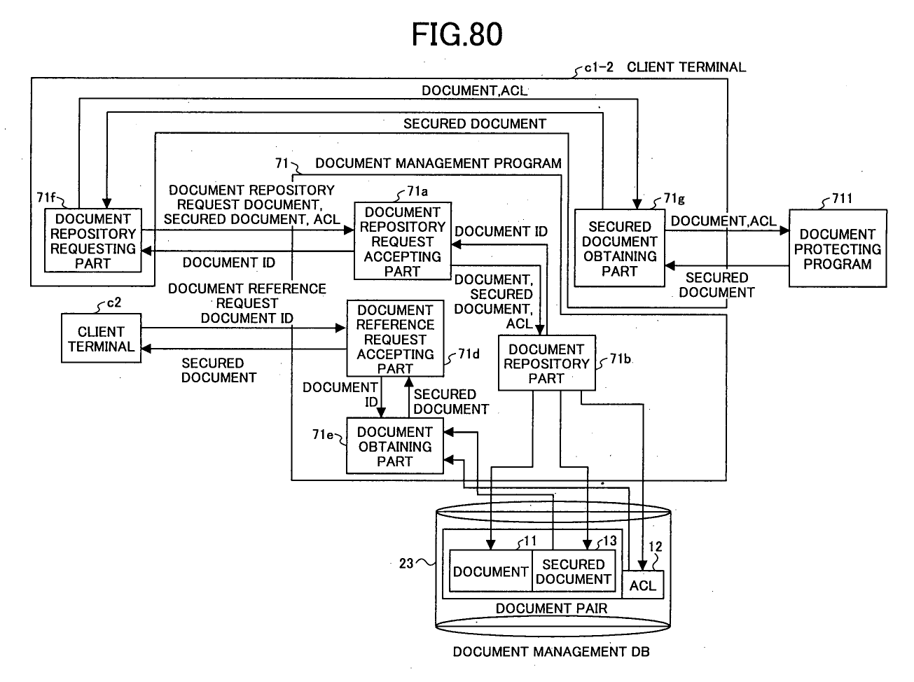

Next, a functional configuration realized by the document management program 71 according to the eighth embodiment will be described with reference to FIG. 80. FIG. 80 is a diagram showing the functional configuration realized by the document management program according to the tenth embodiment of the present invention. In FIG. 80, client terminal c1-2 and c2-2 may be the same client terminal.

In FIG. 80, The document management program 71 realizes at least a document repository request accepting part 71a, a document repository part 71b, a document reference request accepting part 71d, and a document obtaining part 71e.

In a case in which the secured document 13 is generated outside the document management program 71 and then is stored, the client terminal c1-2 conducting the document repository request includes a document repository requesting part 71f, and a secured document obtaining part 71g.

The document repository requesting part 71f sends the document 11 and the ACL 12 to the secured document obtaining part 71g. The secured document obtaining part 71g sends the document 11 and the ACL 12 to the document protecting program 711, and then receives the secured document 13 from the document protecting program 711. Then, document repository requesting part 71f sends the secured document 13 to the document repository requesting part 71f.

The document repository requesting part 71f sends the document repository request with the document 11, the secured document 13, and the ACL 12 to the document management program 71 in that the client terminal c1-2 is a client conducting the document repository request.

The document repository request accepting part 71a of the document management program 71 receives the document 11, the secured document 13, the ACL 12 with the document repository request from the client terminal c1-2 conducting the document repository request, and then sends to the document repository part 71b.

The document repository part 71b stores the document 11 and the secured document 13 as the document pair in the document management DB 23, and associates the ACL 12 to the document pair. The document repository part 71b sends the document ID identifying the document pair to the document repository request accepting part 71a.

The document repository request accepting part 71a sends the document ID to the client terminal c1-2 that conducted the document repository request.

In the document management program 71, operations when the document reference request from the client terminal c2-2 conducting the document reference request are the same as the operations shown in FIG. 68, and explanation thereof will be omitted.

In the seventh through the tenth embodiments, operations for various private accesses are the same as the operation in the sixth embodiment, and explanation thereof will be omitted.

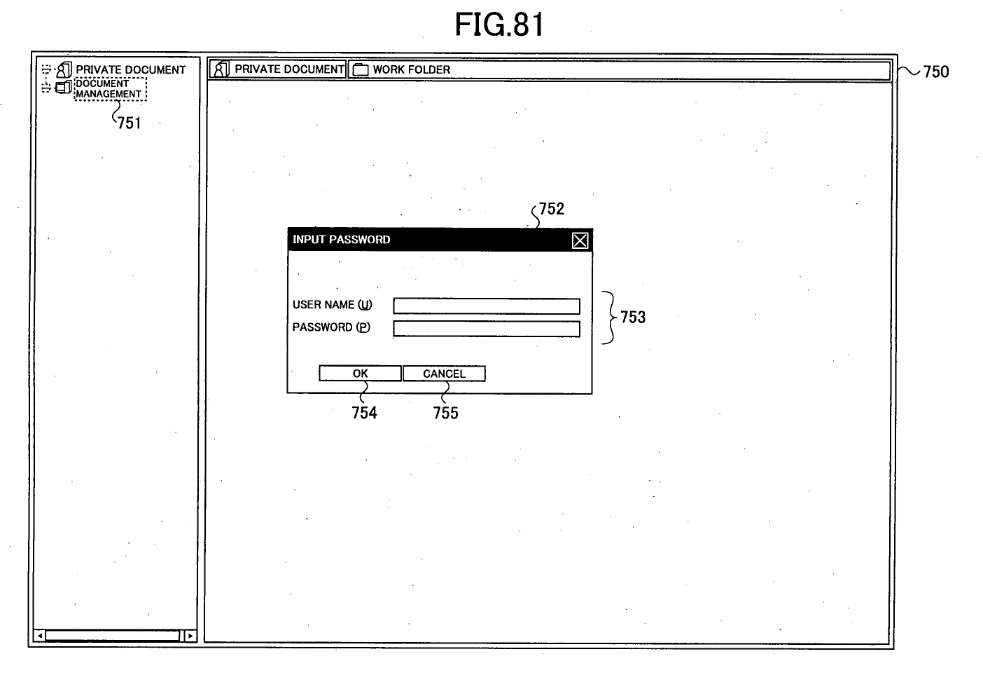

Screens provided to the user in common in the seventh through the tenth embodiments will be described with reference to FIG. 81 through FIG. 85. FIG. 81 is a diagram showing a screen to display when the user accesses the electronic file management apparatus. In FIG. 81, for example, when the user as the administrator selects a document management 751 displayed at a screen 750 of a client of the user, a dialog 752 is displayed to authenticate the user. When the user inputs a user name and a password to an input area 753, and clicks an OK button 754 to execute the user authentication, the electronic file management apparatus 701 conducts the user authentication. On the other hand, when the user clicks a cancel button 755, the access of the user to the electronic management apparatus 701 is canceled.

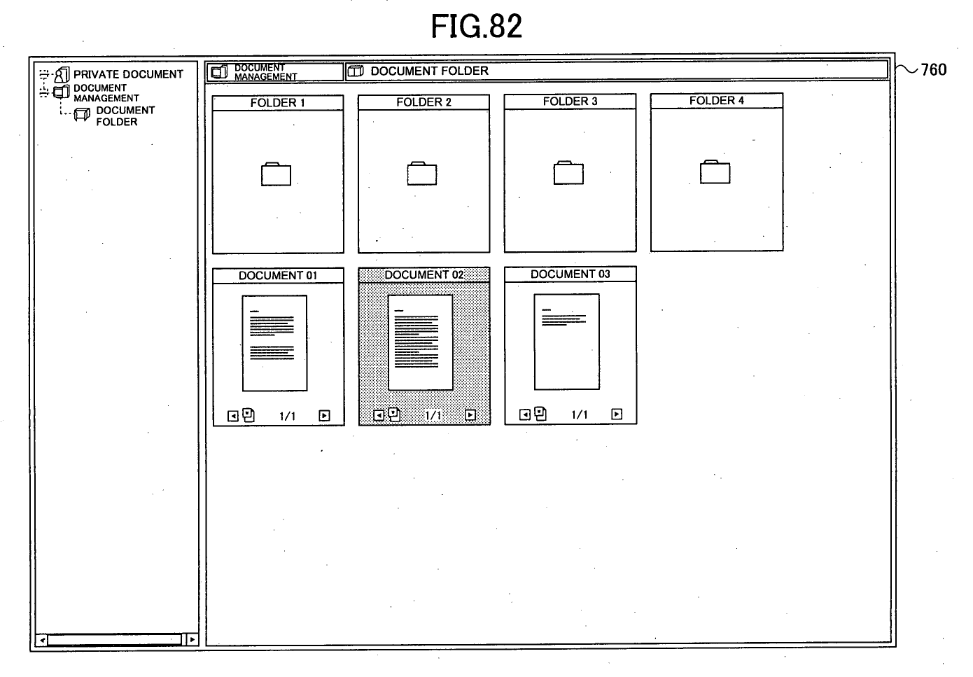

When the user authentication is succeeded, a list of documents managed in the electronic file management apparatus 701 is displayed as shown in FIG. 82. FIG. 82 is a diagram showing a screen to display the list of the documents managed in the electronic file management apparatus.

In FIG. 82, a screen 760 is a screen when the user is successfully authenticated, and displays the list of the documents managed in the electronic file management apparatus 701.

As the list of documents, a folder 1, a folder 2, a folder 3, a folder 4, a document 01, a document 02, and a document 03 are displayed. For example, the folders 1 through 4 are displayed by icons representing a folder shape, and the documents 01 through 04 are displayed by thumb-nails.

For example, when the user selects the document 02, the document reference request is sent to the electronic file apparatus 701, and the access authorization of the user is confirmed. When the user has the access authorization with respect to the document 02, only the secured document 13 of the document 02 is provided to the client of the user.

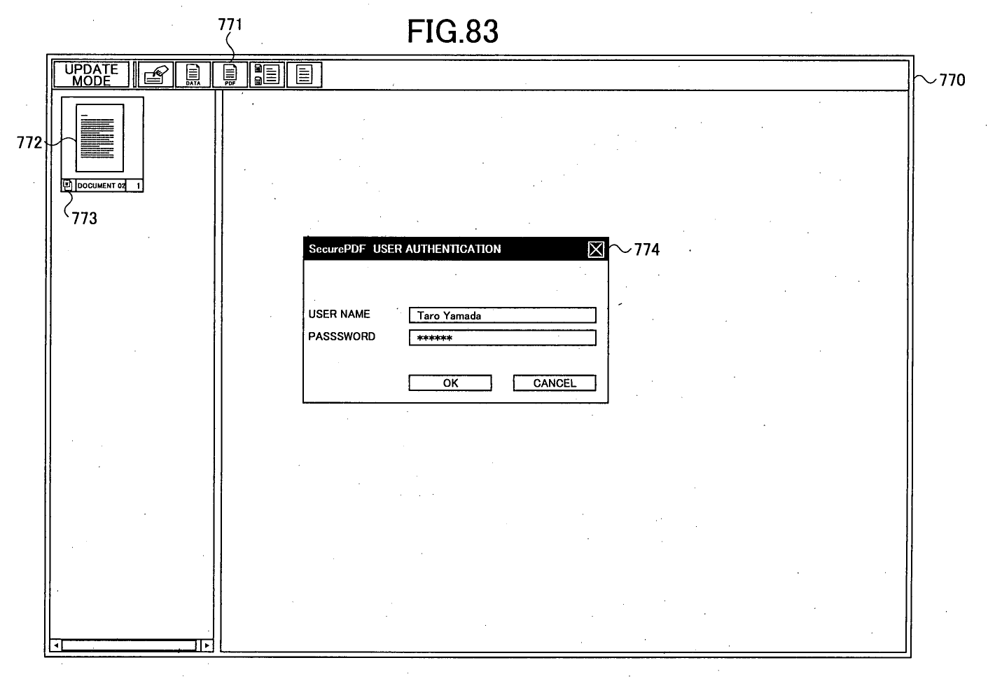

FIG. 83 is a diagram showing a screen on which only the secured document is displayed. In a screen 770 in FIG. 83, an icon 772 indicates that only the secured document of the document 02 is provided as the document 02. For example, the icon 771 shows that the document 02 is a PDF file and that the user is allowed to access only the secured document 13 of the document 02 if the icon 771 is shown in an available state.

For example, a thumb-nail 772 of the document 02 shows an icon 773 showing that a file format of an original document is MS Word®.

At a client side, in order to open the secured document 13 of the document 02, a dialog 774 is displayed and the user authentication is required again. In this case, information previously input by the user may be automatically used.

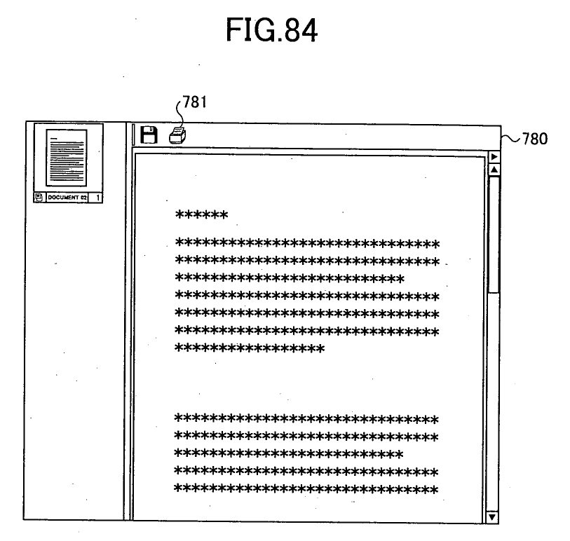

When the user authentication is succeeded by the information input in the dialog 774, for example, a screen is displayed as shown in FIG. 84. FIG. 84 is a diagram showing a state in that the secured document is opened.

In FIG. 84, a screen 780 displays that the user authentication is succeeded with respect to the secured document 13 of the document 02 and displays the secured document 13 if the user is authorized to open the secured document 13.

Then, the user can refer to contents of the secured document of the document 02, and can print out the secured document 13 if the user is authenticated to print out. That is, when the user clicks icon 781 to print out, it is determined whether or not the user is authorized to print out, and the printing process is conducted so as to satisfy a requirement of the security with respect to the document 02.

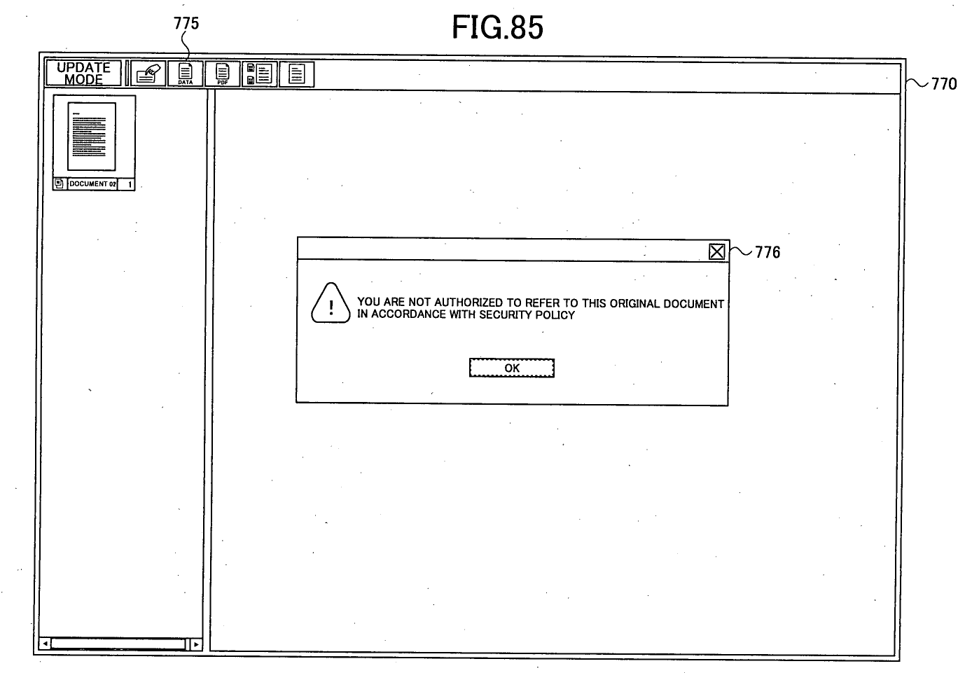

On the other hand, in the screen 770 shown in FIG. 83, a case in that the user refers to the original document 02 will be described with reference to FIG. 85. FIG. 85 is a diagram showing a screen in a case in that the user does not have an original reference authorization.

In FIG. 85, when the user attempts to access the document 02 by clicking an icon 775, it is determined whether or not the user is authorized to access the document 02 which is original. When the user is not authorized to access the original document 02, a message such as “YOU ARE NOT AUTHORIZED TO REFER TO THIS ORIGINAL DOCUMENT IN ACCORDANCE WITH SECURITY POLICY” is displayed at a dialog 776. Accordingly, the user can not refer to the original document 02.

The present invention is not limited to the specifically disclosed embodiments, and variations and modifications may be made without departing from the scope of the present invention.

For example, contents of various document (electronic file) used in the above seventh through tenth embodiments are not limited to the document 11. For example, the present invention can be applied to a document file including images and an image file.

Moreover, in the above seventh through tenth embodiments, the electronic management apparatus includes the input unit and the display unit. For example, the electronic file management apparatus 701 may receive an input form a user terminal of the user through a network. Alternatively, the electronic file management apparatus may output to the display unit or the external information storage unit through the network.

Moreover, in a case in that the printer 703 may be connected to the electronic file management apparatus or the print terminal 702 through the network and configure a single system.

Furthermore, when there are a plurality of storage units, the document pair and the ACL 12 may be separately stored in different storage unit it is possible to confirm that the ACL 12 is associated to the document pair.

Moreover, if the electronic file can be managed by setting information for managing the access authorization, for example, the present invention can be applied a system in that the access is controlled in accordance with a policy instead of the ACL 12 in a case in that a document protecting program of a policy base access control model is used. In this case, the document protecting program of a policy base access control model is basically the same as the document protecting program according to the seventh through tenth embodiments.

### Eleventh Embodiment

An eleventh embodiment will be described according to the present invention. In the eleventh embodiment, a document issuance workflow system examines and approves an issued document, and then issues a secured document. “Document” simply means a document, and also may be an electronic data such as a program, an image, a database, or other data.

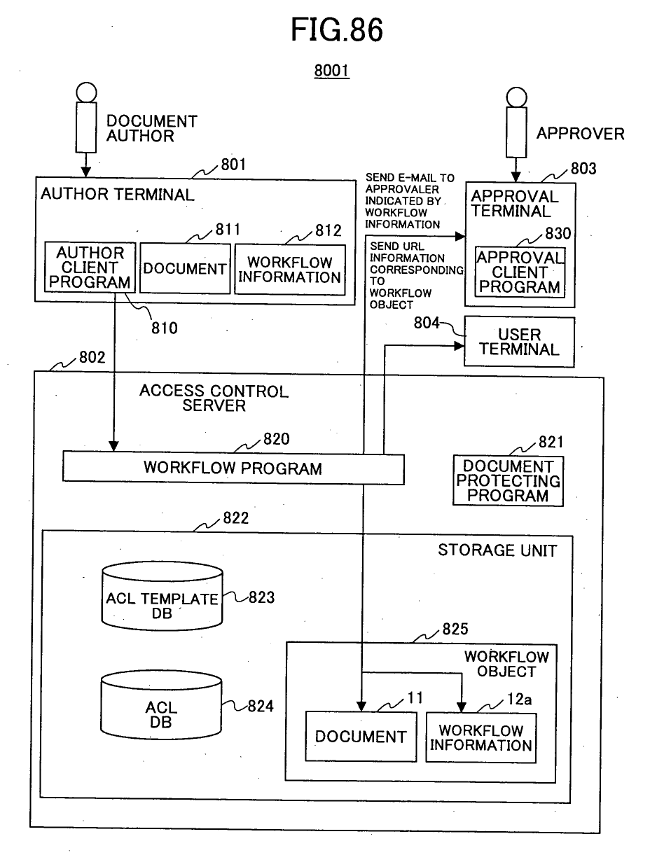

FIG. 86 is a diagram showing the document issuance workflow system according to the eleventh embodiment of the present invention. In the following, a configuration of the document issuance workflow system will be described with reference to FIG. 36.

In FIG. 36, the document issuance workflow system 8001 includes an author terminal 801, an access control server 802, an approver terminal 803, and a user terminal 804. And in the document issuance workflow system 8001, the access control server 802 connects to the author terminal 801, the approver terminal 803, and the user terminal 804 through a network, respectively.

The author terminal 801 is an information processing apparatus operated by a document author, and for example, may be a personal computer. The author terminal 801 includes a display unit (for example, an LCD (Liquid Crystal Display)), an input unit (for example, a keyboard), and a storage unit (for example, an FDD (Floppy® Disk Drive), an HDD (Hard Disk Drive).

The author terminal 801 implements an author client program 810 stored therein. For example, the author client program 810 can be realized by a Web browser, or a client program of Lotus Notes® that is a groupware product of IBM.

The author terminal 801 generates workflow information 812 including document 811 as the electronic data and an attribute of the document 811, and sends to the access control server 802.

The access control server 802 is an information processing apparatus for managing the document 811 and the ACL, for example, may be a Web server. The access control server 802 is operated by the workflow program 820 and the document protecting program 821.

Moreover, for example, the access control server 802 includes an storage unit 822 such as the HDD. The storage unit 822 includes an ACL template DB (ACL template database) 823, an ACL DB (ACL database) 824, and a workflow object 825.

The ACL template DB 823 is a database for managing at least one ACL template corresponding to a type of the document 811 (file type). The ACL template is template information of the ACL used when the ACL showing an access authorization to the document 811 is generated.

The ACL DB 824 is a database for managing the ACL generated by the workflow program 820.

The workflow object 825 is information showing a combination of the document 811 and the workflow information 812a which correspond to each other.

The approver terminal 803 is an information processing apparatus that is operated by an approver who determines whether a document distribution is approved or rejected. For example, the approver terminal 803 may be a personal computer. The approver terminal 803 includes a display unit (for example, an LCD), an input unit (for example, an keyboard), and a storage unit (for example, an FDD or an HDD).

The approver terminal 803 stores an approver client program 830, and the approver client program 830 operates the approver terminal 803 to execute each operation.

The user terminal 804 is an information processing apparatus operated by the user using the document 811 (the secured document 813). For example, the user terminal 804 is a personal computer. And the user terminal 804 includes a display unit (for example, an LCD), an input unit (for example, a keyboard), and a storage unit (for example, an FDD or an HDD).

In the following, operations of the document issuance workflow system according to the eleventh embodiment will be described with reference to FIG. 86.

The author terminal 801 obtains the document 811 desired by the document author to be approved, and the workflow information 812 showing information concerning the document 811. It should be noted that the document 811 and the workflow information 812 may not be always generated by the author terminal 801 and may be received at the author terminal 801 through the network. The document 811 and the workflow information 812 are recorded inn a predetermined portable recording medium and the author terminal 801 may read and obtain the document 811 and the workflow information 812 from the recording medium.

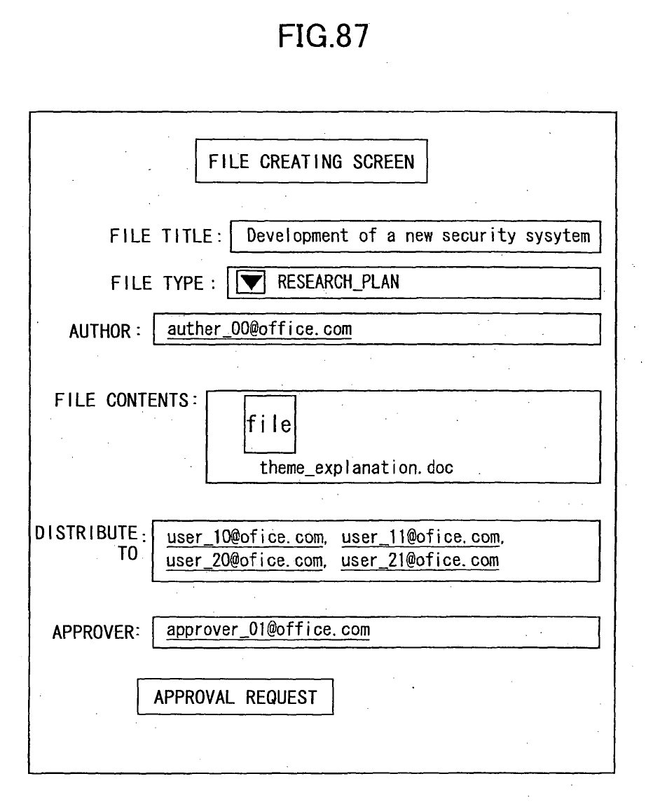

FIG. 87 is a diagram showing a screen displayed when the workflow information 812 is generated at the author terminal 801, according to the eleventh embodiment of the present invention.

As shown in FIG. 87, a screen for generating the workflow information 812 provides input areas of “FILE TITLE”, “FILE TYPE”, “AUTHOR”, and “FILE COTENTS” of the document 811, “DISTRIBUTE TO”, and “APPROVER”. The document author inputs information into each input area by using the input unit provided to the author terminal 1. The author client program 810 generates the workflow information based on the input information.

“FILE TITLE” shows a title of the document 811. “FILE TYPE” is define and set at least one file type, and for example, the author terminal 801 allows the author to select one from at least one file type shown in a pull down menu. As “FILE CONTENTS”, a file name of the document 811 which is requested to be approved is shown, and the document 811 of the file name is attached to the workflow information 812.

User Ids of users are input to input areas for “AUTHOR”,“DISTRIBUT TO”, and “APPROVER”. For example, as shown in FIG. 87, as the user ID, an e-mail address of each user may be input. Types of user are not limited to “AUTHOR”,“DISTRIBUT TO”, and “APPROVER”, and the number of users is not limited to the number shown in FIG. 87.

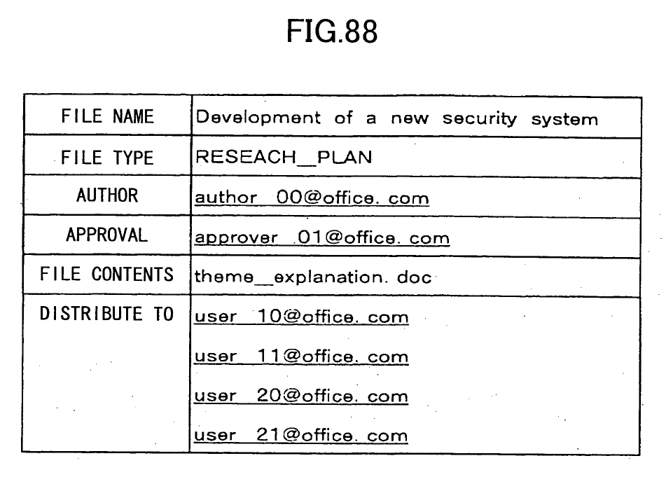

FIG. 88 is a diagram showing an example of the workflow information according to the eleventh embodiment of the present invention. Based on the input information as shown in FIG. 87, the workflow information 812 is generated as shown in FIG. 88. As shown in FIG. 88, the workflow information 812 includes a file title “Development of a new security system” of the document 811, a file type “RESEARCH_PLAN”, an author author_{—}00@office.com, an approver approver_{—}01@iffuce.com, file contents (file name of the document 811) “theme_explanation.doc”, and a distribute-to user_{—}10@office.com, user_{—}11@office.com, user_{—}20@officecom, user_{—}21office.com.

Contents of the workflow information 812 is not limited as shown in FIG. 88 and may be other contents. In FIG. 88, the file name of the document 811 requested to approve is shown at “FILE CONTENTS”. In practice, “FILE CONTENTS” indicates a file itself of the document 811.

Next, the author terminal 801 sends the document 811 and the workflow information 812 and then a workflow is conducted. In detail, the author client program 810 may detect a click when an “APPROVE REQUEST” button provided on the screen of the workflow information 812 in FIG. 12 is clicked, and generate the workflow information 812, and sand the workflow information 812 and the document 811 corresponding the workflow information 812 to the access control server 802.

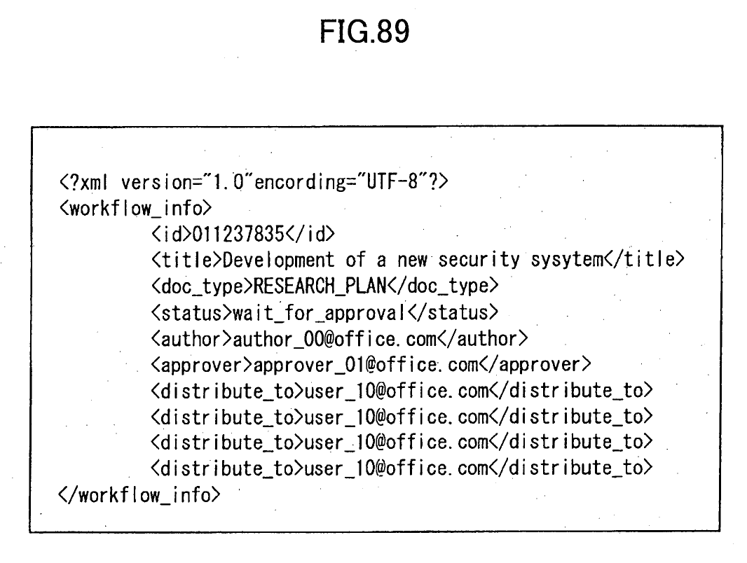

When the access control server 802 receives the document 811 and the workflow information 812 from the author terminal 801, the workflow program 820 provides a document ID (can be a serial number) identical to the workflow information 812, generate a file (workflow information 812a) described in an XML as shown in FIG. 89, and stores the file with the document 811 in the storage unit (HDD) 822. In this case, the workflow object 825 is a combination data associating the document 811 with the workflow information 812a.

FIG. 89 is a diagram showing the workflow information where the document ID is provided, according to the eleventh embodiment of the present invention. As shown in FIG. 89, the document ID “011237835” is identically provided to the workflow information 812a. In addition, “wait_for_approval” is shown in “<status>” showing a current status of the workflow information 812a. That is, the current status shows that the document 811 is in a status of waiting for a result (approval or rejection) of the examination by the approver.

Next, the workflow program 820 sends an e-mail of an approval request to an approval terminal 803 indicated in the workflow information 812a. In the e-mail of the approval request, the document ID identically provided to the workflow information 812a is described. In a case in that the access control server 802 is realized as the Web server and the workflow program 820 is realized by a program executed in the Web server, the workflow program 820 may write a URL (for example, http://server/workflow?wfid=011237835) corresponding to the workflow object 25 in the e-mail and send the e-mail.

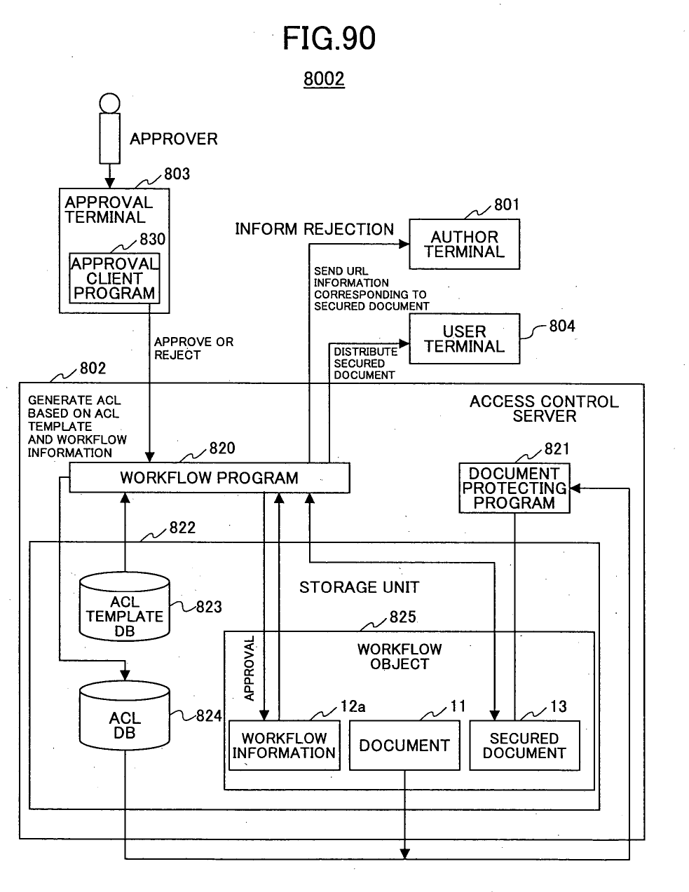

FIG. 90 is a diagram showing a modification of the document issuance workflow system according to the eleventh embodiment of the present invention. In the following, operations of a document issuance workflow system 8002 according to the eleventh embodiment will be described with reference to FIG. 90.

When the approver terminal 803 receives the e-mail showing the workflow object 825 that is requested to approve from the access control server 802, the approver of the approver terminal 803 displays a list of the workflow objects 25 stored in the access control server 802 on a screen at the display unit, and selects one workflow object 25 that is requested to approve from the e-mail, by the approver client program 830.

When the approver terminal 803 detects that for example, the approver clicks an approve button or a reject button, the approver terminal 803 revises the workflow information 812a and recognizes information showing “Approve” or “Reject”.

The approver client program 830 determines whether the workflow object 825 is approved or rejected. When it is determined that the workflow object 825 is rejected (for example, the reject button is clicked), the approver client program 830 sends information showing that the workflow object 825 is rejected. When the access control server 802 receives the information showing that the workflow object 825 is rejected, the access control server 802 sends information showing that the workflow object 825 is rejected, by e-mail. Then, the document issuance workflow system 8002 terminates the operations.

The approver client program 830 recognizes that the workflow object 825 is approved (for example, the approval button is clicked), information showing that the workflow object 825 is approved is sent to the access control server 802.

When the workflow program 820 receives the information showing that the workflow object 825 is approved, the workflow program 820 revises the workflow information 812a about the workflow object 825 object to approve, and changes an item “<status>” showing a status of the workflow to “APPROVED”.

Next, when the workflow program 820 sets the status of the workflow information 812a to “APPROVED”, based on the workflow information 812a being “APPROVED”, the workflow program 820 generates the ACL of the distribution document (document 11). For example, the ACL is generated as follows. It should be noted that contents of the workflow information 812a are as shown in FIG. 89.

In the workflow information 812a shown in FIG. 90, the file type of the document 811 being approved is “RESEARCH_PLAN” and the document 811 is distributed to he user terminals 804 listed by <distribute_to> after the document 811 is approved. In this example, an e-mail address is used as the user ID.

In the eleventh embodiment, the access control server 802 stores the ACL template for each file type such as “RESEARCH_PLAN”, “CONTRACT”, or “TOP_SECRET”. The file type described in the eleventh embodiment is just one example, and another type name and various file types can be used.

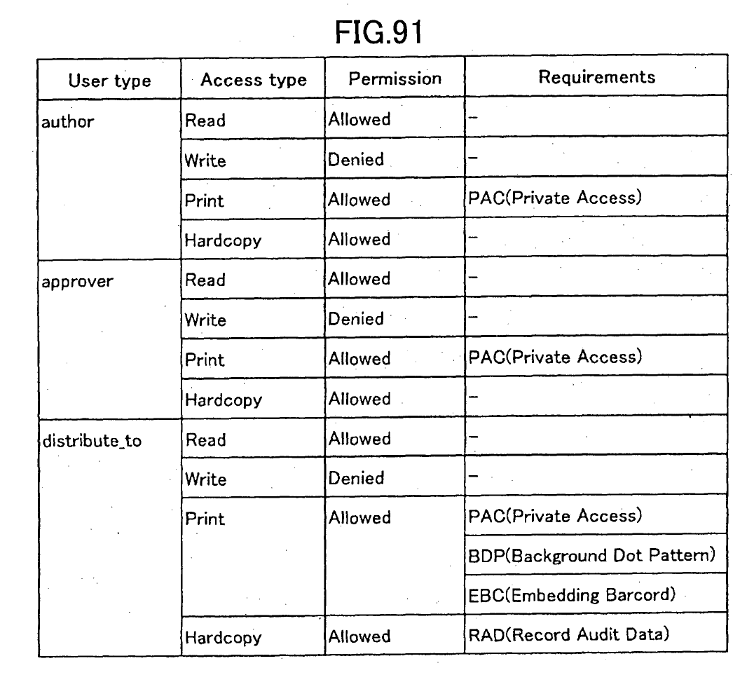

FIG. 91 is a diagram showing the ACL template according to the eleventh embodiment of the present invention. In FIG. 91, the ACL with respect to the document 811 having the file type “RESEARCH_PFAN” is shown.

As shown in FIG. 91, for example, the ACL template includes items of “User type”, “Access type”, “Permission”, and “Requirements”.

“User type” is an item showing a type of the user having the access authorization for the document 811. In the eleventh embodiment, “User type” is classified into “Author (document author)”, “Approver”, and “distribute_to”.

“Access type” is an item showing a type of an access method for the document 811. In the eleventh embodiment, “Access type” is classified into “Read (Read the document)”, “Write (write the document)”, “Print (print out the document)”, and “Hardcopy (hardcopy of document)”.

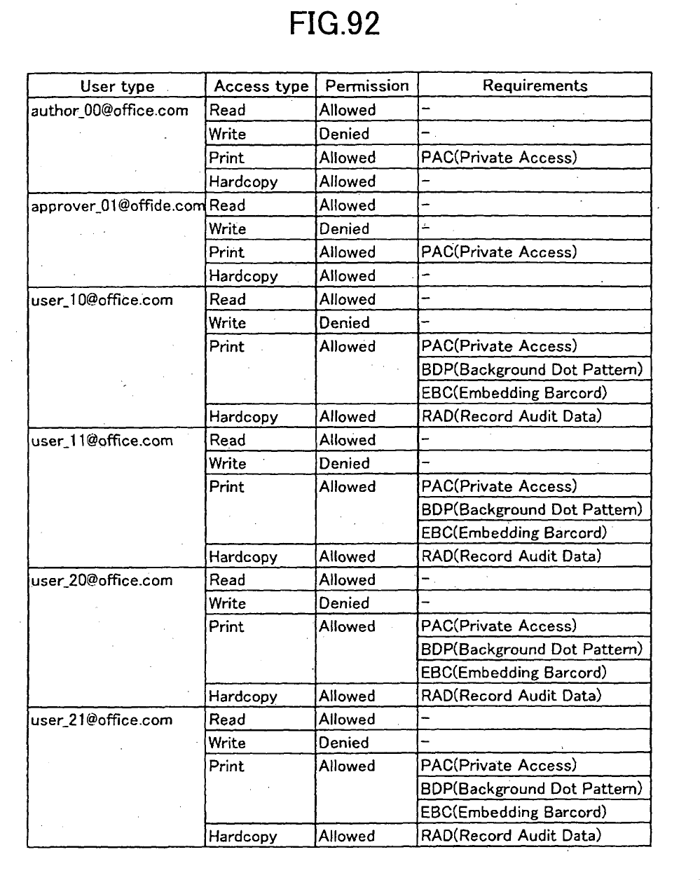

“Permission” shows “Allowed” or “Denied” with respect to an access to the document 811 for each user type. For example, in the ACL template shown in FIG. 92, “author (document author)” is allowed to read, print, and hardcopy as the access, and is denied to write as the access.

“Requirements” shows a process required for each access type when the user of the user terminal 804 uses the secured document 813. For example, in the ACL template in FIG. 91, “BDP (Background Dot Pattern)”, “EBC (Embedding Barcode), and “RAD (Record Audit Data” are shown.

The workflow program 820 retrieves the ACL template corresponding to the file type described in the workflow information 812a from at least one ACL template managed in the ACL template DB23 after “<status>” of the workflow information 12a is set as “Approval”. In the eleventh embodiment, based on the workflow information 812a having the file type “RESEARCH_PLAN”, the workflow program 820 retrieves the ACL template of “RESEARCH_PLAN” shown in FIG. 91.

Next, the workflow program 820 additionally provides information of “Author”, “Approver”, and “Distribute_to” described in the workflow information 812a to the ACL template, and generates the ACL as shown in FIG. 92.

FIG. 92 is a diagram showing an example of the ACL according to the eleventh embodiment of the present invention. In FIG. 92, “Author”, “Approver”, and “Distribute_to” (“author_{—}00@office.com”, “approver_{—}01@office.com”, “user_{—}01@office.com”, “user_{—}11@office.com”, “user_{—}20@office.com”, and “user_{—}21@office.com”) show respective access authorization.

The workflow program 820 associates the ACL with the document ID described the workflow information 812a that is used when the ACL is generated.

The workflow program 820 sends the ACL generated as described above and the document 811 to the document protecting program 821. The document protecting program 821 protects the document 811 and generates the secured document 813 based on the ACL.

The workflow program 820 obtains the secured document 813 and then distributes the secured document 813 to the user terminals 804 of users indicated as “distribute to” by e-mail. In this case, the access control server 802 distributes the secured document 813 itself to the user terminals 804.

A security process for the document 811 using the ACL according to the eleventh embodiment will be described with reference to FIG. 90. It should be noted that the user terminal 804 implements a document access program and connects to a printer.

The document protecting program 821 sets the process requirement in response to a user (distributor) of the access control server 802, to the document 811, and conduct a process to encrypt the document 811 using an encryption algorithm (for example, an RC4, Triple DES, IDEA) and generate the secured document 813.

The document access program is a program to decrypt the secured document 813 in response to the input operation of the user of the user terminal 804, and conduct a printing process corresponding to the process requirement by itself or the printer.

The access control server 802 refers to the ACL in response to a request from the document access program when the user attempts to print out the document 811.

Moreover, the access control server 802 further includes a user database storing information (combination of the user name and the password) for the user authentication for each user.

When the document protecting program 821 obtains the document 811 and the ACL, the document protecting program 821 generates an encryption key (key) to decrypt and registers the encryption key to the storage unit 822 by associating with the document ID corresponding to the encryption key.

Moreover, the document protecting program 821 encrypts the document 811 by using the encryption key, and generates the secured document 813 by adding the document ID to the document 811 being encrypted.

The access control server 2 sends the secured document 813 to the user terminal 804 through the network.

When the user indicates an access to the document 811 to the document access program by using the input unit of the user terminal 804, the document access program receives this request of the access and requires the user to input the user name and the password to conduct the user authentication. For example, the document access program displays a message at the display unit of the user terminal 804 to require the user name and the password.

The document access program sends the user name and the password input by the user sends to the access control server 802, and requires the user authentication.

The access control server 802 conducts the user authentication by using the user name and the password received from the document access program, and specifies the user.

When the access control server 802 specifies the user, the access control server 802 refers to the ACL DB 824, determines whether or not the user as a distribute-to is authorized to access the document 811, and obtains the process requirements defined for the user to access the document 811.

When the user is authorized to access the document 811, the access control server 802 sends authentication information showing a authorization result, the encryption key for decrypt the secured document 811, the process requirement for the user to access the document 811 from the user terminal 804 to the document access program.

When the document access program obtains the authentication information, the encryption key, the process requirement from the access control server 802, the document access program decrypts the secured document 814 by using encryption key to restore the document 811.

When the user requests to print out the document 811, the document access program indicates the printer to conduct the printing process so as to satisfy the process requirement. For example, when the BDP is set to the secured document DB 813 as the process requirement, contents of the document 811 and the background dot pattern are simultaneously printed out.

When the document 811 is printed out, it is possible to enforce the process requirement which the distributor set for each user.

Moreover, the access control server 802 may store the secured document 813 as apart of the workflow object 825 in the storage unit 822, and send a URL to access the secured document 813 to the user terminal 804 by e-mail (for example, http://server/workflow?wfid=011237835)

Furthermore, the access control server 802 may also send the secured document 813 or the URL to the author terminal 801 and the approver terminal 803, similar to the user terminal 804.

As described above, the access control server 802 restricts the access authorization to the document 811 being approved, and distributes the secured document 813 with an access restriction to the user as the distribute-to. Accordingly, the access control server 802 allows only the user having the access authorization to refer to the contents of the document 811. And the access control server 802 confirms the access authorization when the user attempts to print out, conducts the security process, and then allows only the user having the access authorization to print out.

Moreover, if the document 811 is improper data format to create the secured document 813, the workflow program 820 may conduct a conversion process for converting the improper data format of the document 811 to a proper data format beforehand, and sends the document protecting program 821 the document 811 which data format is converted. For example, if the document 811 is a file of Microsoft Word® and the proper data format for the document protecting program 821 is a PDF file, the workflow program 820 activates Microsoft Word®, converts a Word file to a PDF by using a function of Adobe Acrobat®, and then sends to the document protecting program 821. Accordingly, the data format of the document 811 created by the author terminal 801 can be any data file that can be converted into the PDF.

Furthermore, in the eleventh embodiment, the access control server 802 generates the secured document 813 from the document 811 after the document 811 is approved. Alternatively, the access control server 802 may control the approver terminal 803 not to change parts other than “<status>” of the workflow information 812a. That is, the access control server 802 may reject the document 811 if a change is requested. In this case, the access control server 2 may generate the secured document 813 before the approver terminal 803 examines (approve/reject), and may store the secured document 813 as a part of the workflow object 825.

A operation of the document printing program in the case in that the PAC is set as the print requirement in the eleventh embodiment is the same as the operation of the document printing program 221 shown in FIG. 27 and FIG. 28 in the second embodiment, and explanation thereof will be omitted.

Operations of the document printing program in a case in that the EBC is set as the print requirement is also the same as the operations of the document printing program 221 in the second embodiment.

Operations of the document printing program in a case in that the BDP is set as the print requirement is the same as the operations of the document printing program 221 in the second embodiment, and explanation thereof will be omitted.

Operations of the document printing program in a case in that the SLS is set as the print requirement is the same as the operations of the document printing program 221 in the second embodiment, and explanation thereof will be omitted.

As described above, in the eleventh embodiment, the ACL is generated by using the workflow information 812a showing the user ID and the file type related to the document 811, and the ACL template. Accordingly, by inputting simple information such as the user ID and the file type related to the document 811, it is possible to easily generate the ACL for a plurality of users with respect to the document 811.

### Twelfth Embodiment

In the following, a twelfth embodiment will be described according to the present invention.

In the eleventh embodiment, the ACL template is defined for each type of the document 811 (file type). In the twelfth embodiment, the secured document 813 is protected based on a predetermined security policy.

The security policy registered in the access control server shown in FIG. 46 in the fourth embodiment is applied in the twelfth embodiment.

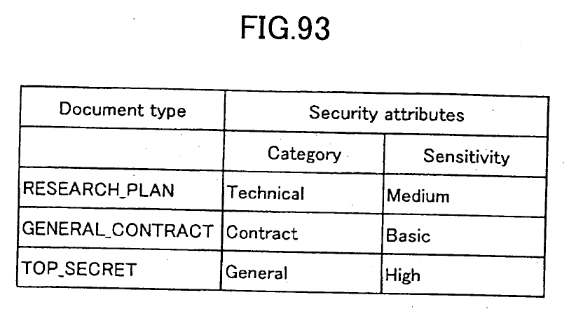

FIG. 93 is a diagram showing a mapping table showing a correspondence between the file type of the document and the security policy according to the twelfth embodiment of the present invention. The mapping table shown in FIG. 93 is stored in the storage unit 822 in the access control server 802.

As shown in FIG. 93, the mapping table associates an item “Document type” with an item “Security attributes”. The item “Security attributes” includes “Category” and “Sensitivity (secret level)”.

In the following, a case of applying a description electronically describing the security policy to a protection of the document 811 will be described with reference to FIG. 91. Moreover, a computer terminal including a display unit (for example, an LCD), an input unit (for example, a keyboard), a storage unit (for example, and an FDD, an HDD) can be applied to the user terminal 804. It should be noted that the document access program is implemented to the user terminal 804 to access the document 811. In addition, a printer is connected to the user terminal 804.

The document access program is a program to decrypt the secured document 813 in response to the input operation of the user of the user terminal 804, and conduct a printing process corresponding to the process requirement by itself or the printer.

The access control server 802 refers to the ACL in response to a request from the document access program when the user attempts to print out the document 811.

When the user of the user terminal 804 attempts to access the document 811 (secured document 813), the access control server 802 refers to the security policy maintained by itself, determines that the user is authorized to access the secured document 813, and obtains the process requirement defined in the security policy. The access control server 802 may maintain the security policy in any data. Data of the security policy may be described by using XML.

The access control server 802 includes a user database storing authentication information (combination of a user name and a password) for each user, a security attribute database registering by associating information showing what security attribute is defined for each secured document 813 with an encryption key for encrypting the secured document 813, a security policy (for example, as shown in FIG. 46), and the mapping table showing the correspondence between the file type and the security attribute.

The user database maintains a category and a level for each user separately as a different attribute. Alternatively, in a case in that the user is managed by using a user management of Windows® Domain, for example, “Techinical_Medium” is generated as a group account, and a user named “Ichiro” may be belonged to that group. By setting a naming rule of the group as described above, the category and the level can be managed as a single attribute.

In the following, operations of the document issuance workflow system in a case the security process is conducted to the document 811 by using the security policy will be described.

After the workflow program 820 generates the workflow information 12, the workflow program 820 refers to the mapping table associating the file type with the security attribute, and sends the security attributes corresponding to the file type indicated in the workflow information 12a and the document 811 to the document protecting program 821. For example, in a case in that the workflow information 12a indicates “RESEARCH_PLAN”, the workflow program 820 sends “Technical” and “Medium” as the security attributes based on the mapping table in FIG. 93 with the document 811 and the document ID.

When the document protecting program 821 obtains the security attributes, the document protecting program 821 generates the encryption key used to decrypt, the security attributes, and associates the encryption key and the security attributes with the document ID to register to the storage unit 822.

Moreover, the document protecting program 21 provides the document ID to the document 811 encrypted by using the encryption key and generates the secured document 813.

The access control server 802 sends the secured document 813 generated by the document protecting program 821 to the user terminal 804 through the network.

When the user indicates to access the secured document 813 to the user terminal 804, the user terminal 804 requires the user to input the user name and the password necessary for the user authentication in response to the access request form the user. For example, the document access program requires the user to input the user name and the password by displaying a message at the display unit of the user terminal 804.

The document access program sends the user name and the password input by the user sand requires the user authentication.

The access control server 802 conducts the user authentication by using the user name and the password received from the user terminal 804, and specifies the user.

When the user is specified, the access control server 802 refers to the security attribute database, and specifies types of the security attributes set to the secured document 813.

The access control server 802 determines whether or not the user has the access authorization with respect to the document 811, and obtains the process requirement required for the user to access the document 811, based on the information showing the level of the user obtained from the user DB and the security attributes set to the document 811 When the user has the access authorization for the document 811, the access control server 802 sends permission information sowing that the access is allowed, the encryption key to decrypt the secured document 813, the process requirement when the user accesses the document 811 to the user terminal 804, and provide to the document access program.

When the document access program obtains the permission information, the encryption key, and the process requirement from the access control server 802, the document access program decrypts the secured document 813 by using the encryption key to restore the document 811.

For example, when the document access program prints out the document 811, the document access program controls the printer connected thereto to conduct the printing process so as to satisfy the print requirement. For example, when the BDP is set to the document 811 as the process requirement to print out, the contents of the document 11 and the background dot pattern are simultaneously printed out.

When the document 811 is printed out, it is possible to enforce the process requirement which the distributor set for each user.

In the eleventh and twelfth embodiments, the workflow program 820 and the document protecting program 821 are stored in the access control server 802, and the access control server 802 is operated. Alternatively, the workflow program 820 and the document protecting program 821 may be stored separately in different information processing apparatuses, and each information processing apparatus may be operated.

As describe above, in the twelfth embodiments, the access control server 802 stores the mapping table associating the file type with the security attribute. Accordingly, only the user ID and the file type related to the document 811 are required to input. Therefore, it is possible to easily conduct the access control with respect to the document 811 for the plurality of users based on the security policy.

Also, the author client program 810 can indicate the computer of the author terminal 801 to execute a process for creating the document 811 and the workflow information 812, a process for displaying the screen for creating the workflow information 812, and a process for sending the document 811 and the workflow information 812.

Moreover, the workflow program 820 can indicates the access control server 802 to execute a process for generating workflow information 12a, a process for sending information showing an examination request of the document 811 to the approver terminal 803, a process for writing the workflow information 12a based on information showing “Approved” or “Rejected”, a process for storing the ACL template, a process for retrieving the ACL template for the type of the document 811 being approved, a process for generating the ACL showing the access authorization of the document 811 by additionally providing information for each user (the author, the approver, the user as the distribute-to) to the ACL template, a process for generating the encryption keys, a process for retrieving the security attributes of the document 811, a process for converting the data format of the document 811, and a process for sending the secured document 813.

Furthermore, the document protecting program 821 indicates the computer of the access control server802 to execute a process for generating the secured document 813 as the document 811 being protected, based on the document 811 and the ACL (or security policy) corresponding to the document 811

Moreover, the approver client program 830 indicates the approver terminal 803 to execute a process for controlling sending and receiving information, a process for controlling displaying information, a process for authenticating an input of information showing that the document 811 is “Approved” or “Rejected”, and a process for controlling sending information showing “Approved” or “Rejected”.

Furthermore, the document access program indicates the user terminal 804 to execute a process for controlling sending and receiving information, a process for restoring the secured document 813, and a process for indicating the printer to print out.

The author client program 810, the workflow program 820, the document protecting program 821, the approver client program 830, and the document access program may be recorded on an optical recording medium, a magneto recording medium and a magneto-optical recording medium, or a recording medium such as a semiconductor, and may be loaded from the recording medium or an external apparatus connected through the network.

The present invention is not limited to the specifically disclosed embodiments, and variations and modifications may be made without departing from the scope of the present invention.

The present application is based on the Japanese priority applications No. 2002-269102 filed on Sep. 13, 2002, No. 2002-299658 filed on Oct. 11, 2002, No. 2002-299712 filed on Oct. 11, 2002, No. 2002-299714 filed on October 11, No. 2002-299721, No. 2003-314466 filed on Sep. 5, 2003, No. 2003-314467 filed on Sep. 5, 2003, No. 2003-314468 filed on Sep. 5, 2003, and No. 2003-318475 filed on September 10, the entire contents of which are hereby incorporated by reference.

What is claimed is:

1. A document printing program comprising the codes of:
obtaining a print requirement associated with a document file; and
compulsory executing the print requirement when the document file is printed out.

2. The document printing program as claimed in claim 1, wherein the print requirement is compulsory enforced by executing a printing process with the print requirement when the document file being encoded is decrypted.

3. The document printing program as claimed in claim 2, further comprising the codes of:
obtaining a decryption key for the document file being encrypted;
decrypting the document file based on the obtained decryption key;
obtaining the print requirement associated with the document file; and
executing a printing process so as to satisfy the obtained print request.

4. The document printing program as claimed in claim 3, wherein the print requirement is obtained from the decrypted document file.

5. The document printing program as claimed in claim 4, wherein a password corresponding to an encryption key used to encrypt the document file is obtained from a user, and an decryption key is generated by the password.

6. The document printing program as claimed in claim 5, wherein a parameter, which is internally maintained or generated, is used to generate the decryption key.

7. The document printing program as claimed in claim 3, wherein the print requirement associated with the document file is obtained from a server through the network.

8. The document printing program as claimed in claim 7, further comprising the codes of:
conducting a user authentication with respect to the server;
obtaining the print requirement of an authenticated user

9. The document printing program as claimed in claim 8, wherein a parameter corresponding to an encryption key used to encrypt the document file is obtained from a server through a network, and an decryption key is obtained from the parameter.

10. The document printing program as claimed in claim 9, wherein a parameter, which is internally maintained or generated, is used to generate the decryption key.

11. The document printing program as claimed in claim 9, wherein a parameter included in the document file is used to generate the decryption key.

12. A document protecting program comprising the codes of:
obtaining an encryption key used to encrypt a document file;
associating print requirement with the document file; and
encrypting the document file by the encryption key.

13. The document protecting program as claimed in claim 12, wherein the document file and the print requirement are associated with each other by providing the print requirement to the document file and then encrypting the document file with the print requirement.

14. The document protecting program as claimed in claim 13, wherein an encryption key is generated based on a password input by a user.

15. The document protecting program as claimed in claim 14, wherein a parameter internally maintained and generated is used to generate the encryption key.

16. The document protecting program as claimed in claim 12, wherein the print requirement associated with the document file is registered to a server through a network.

17. The document protecting program as claimed in claim 16, wherein the print requirement is registered as a part of an ACL associated with the document file.

18. The document protecting program as claimed in claim 17, wherein an encryption key user to encrypt is registered to the server.

19. The document protecting program as claimed in claim 18, wherein a parameter used to generate an encryption key used to encrypt is registered to the server.

20. The document protecting program as claimed in claim 18, wherein a parameter used to generate an encryption key used to encrypt is provided to a part of the document.

21. A document protecting system comprising:
a distributor terminal implementing a document protecting program comprising the codes of:
a part obtaining an encryption key to encrypt a document file;
a part associating a print request to the document file; and
a part encrypting the document file by the encryption key, and
a user terminal implementing a document printing program comprising the codes of:
a part obtaining a decryption key of document file being encrypted;
a part decrypting the document file based on the obtained decryption key;
a part obtaining a print requirement associated with the document file; and
a part executing a printing process so as to satisfy the print requirement.

22. A document protecting system comprising:
a server implementing a document protecting program comprising the codes of:
obtaining an encryption key used to encrypt a document file;
associating a print requirement with the document file; and
encrypting the document file by the encryption key, and
a user terminal comprising the codes of:
obtaining a decryption key of a document being encrypted;
obtaining a print requirement associated with the document; and
executing a printing process so as to satisfy the obtained print requirement.

23. A document printing program comprising the codes of:
obtaining decryption key of a document file being encrypted;
decrypting the document based on the decryption key;
obtaining a print requirement associated with the document file from a server through a network; and
executing a printing process satisfying the print requirement.

24. The document printing program as claimed in claim 23, further comprising the codes of:
conducting a user authentication with respect to the server; and
obtaining print requirement of a user being authenticated from an ACL associated with security attributes of the document file so as to define for each organization unit.

25. The document printing program as claimed in claim 24, wherein a security attribute database, that registers the security attributes of the document file being encrypted by associating with the document file.

26. The document printing program as claimed in claim 25, wherein the security attributes include a document category and a secret level.

27. The document printing program as claimed in claim 23, further comprising the codes of:
conducting a user authentication with respect to the server; and
obtaining a security policy, which is provided by associating the print requirement of a user being authorized with the security attributes and a user type.

28. The document printing program as claimed in claim 27, wherein a security attribute database, which registers the security attributes of the document file being encrypted by associating with the document file, is provided in the server.

29. The document printing program as claimed in claim 28, wherein the security attributes include a document category and a security level, and the user type includes a category and a level.

30. The document printing program as claimed in claim 24, wherein a parameter corresponding to an encryption key used to encrypt the document file is obtained from a server through a network, and the decryption key is generated from the parameter.

31. The document printing program as claimed in claim 30, wherein the parameter internally maintained and generated is used to generate the decryption key.

32. The document printing program as claimed in claim 30, wherein the parameter included in the document file is used to generate the decryption key.

33. A document protecting program comprising the codes of:
obtaining an encryption key user to encrypt a document file;
registering information indicating a print requirement of the document file to a server by associating with the document file through the network; and
encrypting the document file by the encryption key.

34. The document protecting program as claimed in claim 33, wherein security attributes indicating the print requirement is registered to a server by associating with the document file.

35. The document protecting program as claimed in claim 34, wherein a security attribute database, which register the security attributes by associating with the document file, is provided in the server.

36. The document protecting program as claimed in claim 35, wherein the security attributes include a document category and a secret level.

37. The document protecting program as claimed in claim 33, herein an encryption key used to encrypt is registered to the server.

38. The document protecting program as claimed in claim 33, wherein a parameter used to generate the encryption key used to encrypt is registered to the server.

39. The document protecting program as claimed in claim 37, wherein a parameter used to generate the encryption key used to encrypt is provided to a part of the document file.

40. A document protecting system comprising:
a distributor terminal implementing a document protecting program comprising the codes of:
a part obtaining an encryption key to encrypt a document file;
registering information indicating a print requirement of the document file to a server by associating with the document file through a network; and
a part encrypting the document file by the encryption key, and
a user terminal implementing a document printing program comprising the codes of:
a part obtaining a decryption key of the document file being encrypted;
a part decrypting the document file based on the decryption key;
a part obtaining a print requirement associated with the document file from a server through the network; and
a part executing a printing process satisfying the print requirement.

41. A document protecting system comprising:
a server implementing a document protecting program comprising the codes of:
a part obtaining an encryption key used to encrypt a document file;
a part registering information indicating a print requirement of the document file; and
a part encrypting the document file by the encryption key, and
a user terminal implementing a document printing program comprising the codes of:
a part obtaining a decryption key of the document file being encrypted;
a part decrypting the document file based on the decryption key;
a part obtaining a print requirement associated with the document file from a server through a network; and
a part executing a printing process satisfying the print requirement.

42. A document printing apparatus comprising:
a part obtaining a user attribute of a user who prints out a document file;
a part obtaining a document attribute of the document file;
a part obtaining a print requirement by searching for a security policy ruling a print allowed/denied and a print requirement based on the user attribute and the document attribute; and
a part enforcing the print requirement when the document file is printed out.

43. The document printing apparatus as claimed in claim 42, wherein the security policy is internally provided.

44. The document printing apparatus as claimed in claim 42, wherein the security policy arranged in a server is referred.

45. The document printing apparatus as claimed in claim 44, wherein the security policy is referred, and a printing process is executed for the document file.

46. The document printing apparatus as claimed in claim 45, wherein a document printing program comprises the codes of:
obtaining a decryption key of the document file being encrypted;
decrypting the document file based on the decryption key;
obtaining the print requirement from the server through the network; and
executing the printing process satisfying the print requirement.

47. The document printing apparatus claimed in claim 46, wherein a security attribute database, which registers the document attribute by associating with the document file, is provided in the server.

48. The document printing apparatus claimed in claim 47, wherein the document attribute includes a document category and a security level, and the user attribute includes a category and a level.

49. The document printing apparatus claimed in claim 46, wherein a parameter corresponding to an encryption key used to encrypting the document file is obtained from the server through the network, and the decryption key is generated from the parameter.

50. The document printing apparatus claimed in claim 49, wherein the parameter internally maintained or generated is used to generate the decryption key.

51. The document printing apparatus claimed in claim 49, wherein the parameter included in the document file is used to generate the decryption key.

52. An electronic file management apparatus comprising:
an electronic file storage area storing an electronic file;
an electronic file managing part additionally providing access authorization information to the electronic file and storing the electronic file in the electronic file storage area; and
a secured electronic file outputting part outputting a secured electronic file in that the electronic file is encrypted and secured, in response to an access request of the electronic file.

53. The electronic file management apparatus as claim in claim 52, wherein when the electronic file managing part receives a storing request of the electronic file, the electronic file managing part obtains the secured electronic file secured by encrypting the electronic file, and associates the electronic file with the secured electronic file to store in the electronic file storing area.

54. The electronic file management apparatus as claimed in claim 52, wherein the electronic file receives a storing request, the electronic file obtains the secured electronic file secured by encrypting the electronic file, and stores the secured electronic file in the electronic file storing file, instead of storing the electronic file.

55. The electronic file management apparatus as claimed in claim 52, wherein when the secured electronic file outputting part receives an access request of the electronic file, the secured electronic file outputting part obtains the secured electronic file secured by encrypting the electronic file, and outputs the secured electronic file.

56. The electronic file management apparatus as claimed in claim 52, wherein when the electronic file managing part receives a storing request of the electronic file, the electronic file managing part accepts the electronic file and the secured electronic file, and associates the electronic file with the secured electronic file to store in the electronic file storing area.

57. The electronic file management apparatus as claimed in claim 52, further comprising a secured electronic file obtaining part obtaining the secured electronic file by sending the electronic file and the access authorization to an external part for encrypting the electronic file, and providing the secured electronic file to the electronic file managing part.

58. The electronic file management apparatus as claimed in claim 52, wherein the secured electronic file is encrypted based on the access authorization information.

59. The electronic file management apparatus as claimed in claim 52, wherein when the secured electronic file outputting part receives an access request to the electronic file before the electronic file is secured, the secured electronic file outputting part determines whether or not the access authorization is allowed to the electronic file before being secured, and denying the access request.

60. A program for causing a computer to manage an electronic file, program comprising the codes of:
additionally providing access authorization information to the electronic file and storing the electronic file in an electronic file storage area; and
outputting a secured electronic file in that the electronic file is encrypted and secured, in response to an access request of the electronic file.

61. A file access controlling method comprising:
managing an electronic so as to provide a secured electronic file in that an electronic file is secured by encrypting based on access authorization information, in response to an access request;
obtaining the secured electronic file in response to a process request for the electronic file; and
controlling a process with respect to the secured electronic file that is decrypted in accordance with the access authorization information when the secured electronic file is decrypted.

62. The file access controlling method as claimed in claim 61, further comprising:
managing electronic file identification information identifying the electronic file, a key for decrypting the secured electronic file, and the access control information;
obtaining user authentication information for authenticating a user who conducted the process request, the electronic file identification information, and the process type when receiving the process request;
determining whether or not to allow or deny the process based on the access authorization information when the user authentication is succeeded;
obtaining a process requirement indicated when allowing the process and the key based on a determination result;
decrypting the secured electronic file by using the key; and
controlling the process in accordance with the process requirement.

63. An access control server connectable to a network, comprising:
an electronic data receiving part receiving electronic data from an author terminal of an author of the electronic data through the network;
a workflow information receiving part receiving workflow information including information showing a data type of the electronic data;
a template storing part storing at least one access authorization template showing an access authorization for each user type with respect to the electronic data for each data type of the electronic data;
a template retrieving part retrieving an access authorization template corresponding to data type information of the electronic data included in the workflow information, from at least one access authorization template being stored in the template storing part; and
an access authorization information generating part generating the access authorization information showing the access authorization of each user with respect to electronic data by inserting the user ID of each user to an access authorization template.

64. The access control server as claimed in claim 63, further comprising:
an approval information receiving part receiving approval information showing that an issuance of the electronic data is approved by an approver;
an access restriction data generating part generating access restriction data by applying an access restriction to the electronic data based on the access restriction information; and
a data sending part sending the access restriction data through the network.

65. The access control server as claimed in claim 64, wherein the template storing part stores the access authorization template setting the author of the electronic data, an approver of the electronic data, and a user whom the access restriction data is sent to, as the user type.

66. The access control server as claimed in claim 64, wherein the access control data generating part applies the access restriction to the electronic data and generates the access restriction data based on a security policy stored in said access control server itself.

67. The access control server as claimed in claim 64, wherein the access restriction data generating part applies the access restriction to the electronic data, converts a data format, and generates the access restriction data.

68. An electronic data issuance workflow processing method in an access control server for conducting an access control to an electronic data, said access control server connectable to a network, said method comprising the steps for:
an electronic data step receiving step for the access control server to receive electronic data from an author terminal of an author of the electronic data through the network;
a workflow information receiving step for the access control server to receive workflow information including information showing a data type of the electronic data;
a template storing step for the access control server to store at least one access authorization template showing an access authorization for each user type with respect to the electronic data for each data type of the electronic data;
a template retrieving step for the access control server to retrieve an access authorization template corresponding to data type information of the electronic data included in the workflow information, from at least one access authorization template being stored in the template storing part; and
an access authorization information generating step for the access control server to generate the access authorization information showing the access authorization of each user with respect to electronic data by inserting the user ID of each user to an access authorization template.

69. The electronic data issuance workflow processing method as claimed in claim 68, further comprising the steps for:
an approval information receiving step for the access control server to receive approval information showing that an issuance of the electronic data is approved by an approver;
an access restriction data generating step for the access control server to generate access restriction data by applying an access restriction to the electronic data based on the access restriction information after the approval information is received; and
a data sending step for the access control server to send the access restriction data through the network.

70. The electronic data issuance workflow processing method as claimed in claim 68, further comprising the steps for:
an access restriction data generating step for the access control server to generate access restriction data by applying an access restriction to the electronic data based on the access restriction information;
an approval information receiving step for the access control server to receive approval information showing that an issuance of the electronic data is approved by an approver;
a data sending step for the access control server to send the access restriction data through the network.

71. The electronic data issuance workflow processing method as claimed in claim 69, wherein the template storing step stores the access authorization template setting the author of the electronic data, an approver of the electronic data, and a user whom the access restriction data is sent to, as the user type.

72. The electronic data issuance workflow processing method as claimed in claim 69, wherein the access control data generating step applies the access restriction to the electronic data and generates the access restriction data based on a security policy stored in said access control server itself.

73. The electronic data issuance workflow processing method as claimed in claim 69, wherein the access restriction data generating step applies the access restriction to the electronic data, converts a data format, and generates the access restriction data.

74. A program for causing an access control server to conduct an access control to an electronic data, said access control server connectable to a network, program comprising the codes of:
an electronic data code receiving code for the access control server to receive electronic data from an author terminal of an author of the electronic data through the network;
a workflow information receiving code for the access control server to receive workflow information including information showing a data type of the electronic data;
a template storing code for the access control server to store at least one access authorization template showing an access authorization for each user type with respect to the electronic data for each data type of the electronic data;
a template retrieving code for the access control server to retrieve an access authorization template corresponding to data type information of the electronic data included in the workflow information, from at least one access authorization template being stored in the template storing part; and
an access authorization information generating code for the access control server to generate the access authorization information showing the access authorization of each user with respect to electronic data by inserting the user ID of each user to an access authorization template.

75. The program claimed in claim 74, further comprising the codes of:
an approval information receiving code for the access control server to receive approval information showing that an issuance of the electronic data is approved by an approver;
an access restriction data generating code for the access control server to generate access restriction data by applying an access restriction to the electronic data based on the access restriction information after the approval information is received; and
a data sending code for the access control server to send the access restriction data through the network.

76. The program claimed in claim 74, further comprising the codes for:
an access restriction data generating code for the access control server to generate access restriction data by applying an access restriction to the electronic data based on the access restriction information;
an approval information receiving code for the access control server to receive approval information showing that an issuance of the electronic data is approved by an approver;
a data sending code for the access control server to send the access restriction data through the network.

77. The program as claimed in claim 75, wherein the template storing code stores the access authorization template setting the author of the electronic data, an approver of the electronic data, and a user whom the access restriction data is sent to, as the user type.

78. The program as claimed in claim 75, wherein the access control data generating code applies the access restriction to the electronic data and generates the access restriction data based on a security policy stored in said access control server itself.

79. The program as claimed in claim 75, wherein the access restriction data generating code applies the access restriction to the electronic data, converts a data format, and generates the access restriction data.
